(19) United States
(12) Patent Application Publication
(10) Pub. No.: US 2025/0133353 A1
(43) Pub. Date: Apr. 24, 2025

(54) Acoustic Component

(71) Applicant: SILICON & SYSTEM CO., LIMITED, Hong Kong (CN)

(72) Inventors: Yoshitaka TADAKI, Tokyo (JP); Shin-ichiro Umemura, Miyagi (JP)

(21) Appl. No.: 19/001,891

(22) Filed: Dec. 26, 2024

Related U.S. Application Data
(63) Continuation of application No. PCT/JP2023/023809, filed on Jun. 27, 2023.

(30) Foreign Application Priority Data
Jun. 28, 2022 (JP) 2022-103281

(51) Int. Cl. H04R 17/02

(52) U.S. Cl. CPC H04R 17/02

(57) ABSTRACT

The present disclosure includes: a voltage generation unit that has a vibration body 22a1 and a fixed electric potential electrode 24 in contact with a reception surface of the vibration body 22a1, and that generates voltage on the output surface of the vibration body 22a1; and an impedance conversion element that sets a local section, of the output surface, located at a stress concentration site of the vibration body 22a1 as an electric potential generation site, and sets the electric potential in the electric potential generation site as a control voltage. The impedance conversion element has a substrate region 14 of a first conductivity type, and first and second main electrode regions 15a, 15b of a second conductivity type.

### CROSS-REFERENCE TO RELATED APPLICATION

This application is a bypass continuation application of PCT application no.: PCT/JP2023/023809. This application claims priorities from PCT Application PCT/JP2023/023809, filed Jun. 27, 2023, and from Japanese patent application 2022-103281, filed Jun. 28, 2022, the contents of which are incorporated herein in the entirety by reference.

### TECHNICAL FIELD

The present disclosure relates to an acoustic element utilizing the piezoelectric effect, and more particularly, to an acoustic element suitable for receiving purposes.

### BACKGROUND ART

As disclosed in Non-patent Document 1 (D. Jiao et al., “High Fill Factor Array of Piezoelectric Micromachined Ultrasonic Transducers with Large Quality Factor”, Sensors and Materials, Vol. 32, No. 5, 2020, pp. 1785-1795.) and Patent Document 1 (Specification of U.S. patent Ser. No. 10/562,069) the technology of forming a piezoelectric micromechanical ultrasonic transducer (PMUT) array within a single chip is known. However, Non-patent Document 1 only discloses the PMUT array. Additionally, in Patent Document 1, the first chip where the PMUT array is formed and the second chip where the integrated circuit is formed are bonded together through a bonding member called a bonding layer. Therefore, when using the PMUT as a receiving element, the distance between the PMUT and the amplifier inevitably becomes longer, which can deteriorate the signal-to-noise ratio (S/N ratio) due to the parasitic impedance of the wiring connecting them.

Non-patent Document 2 (Hiroki Makino et al., “Development of high-sensitive and wideband FET-based ultrasound receiver directly driven by piezoelectric effect”, International Ultrasonics Symposium Proceedings, 2015.) indicates that by connecting the PMUT to the gate of a Field Effect Transistor (FET) via wires, it is possible to achieve high sensitivity and broadband performance by improving the Signal-to-Noise Ratio (S/N ratio). However, the conclusion section (Conclusion) of Non-patent Document 2 points out that since the bandwidth has not been improved, further enhancing sensitivity and broadband performance remains an unresolved issue. To achieve a high-sensitivity and broadband ultrasonic receiver, what is important is not the macrostructure but the detailed layout inside acoustic components, such as which part of the PMUT and how to extract voltage. The disclosure described in Non-patent Document 2 only studies the separate structure where the PMUT and FET are connected as individual components through external wiring. Therefore, in the disclosure described in Non-patent Document 2, the microscopic stress distribution in the internal structure of the PMUT and the output voltage distribution in the internal structure related to the stress distribution are not considered. Furthermore, the disclosure described in Non-patent Document 2 does not study the structure that makes the PMUT itself broadband, the structure that makes the most effective use of the PMUT output, or the integrated structure required for broadband performance, including reducing the braking impedance. Patent Document 2 (Japanese Patent Application Publication No. 2019-503095.) and Patent Document 3 (Japanese Patent Application Publication No. 2020-535776.) show a structure in which an FET serving as a preamplifier is formed on a substrate, and a PMUT directly connected to the gate of the FET is arranged directly above the gate of the FET. However, in both structures, there is a void or cavity between the PMUT and the FET gate, and the two are connected through long wiring (via). This is because in Patent Document 2 and Patent Document 3, both the PMUT and the FET are different components, and ultimately the PMUT must be integrated directly above the FET. In this case, especially due to the large braking impedance caused by the via, it is impossible to fully achieve high sensitivity and broadband performance of the ultrasonic receiver. In any case, when using these PMUT-based systems for ultrasonic reception, meeting high sensitivity, broadband, low output impedance, and other characteristics becomes a practical challenge. In addition, receiving sensors that utilize the piezoelectric effect, such as PMUTs, have very high impedance, which poses a matching problem with amplification circuits such as preamplifiers.

### SUMMARY

The present disclosure is conceived in view of the aforementioned issues, with the objective of providing an acoustic element that can achieve high sensitivity and broadband performance, reduce output impedance, and is suitable for use in receiving sensors.

To achieve the aforementioned objective, the acoustic element according to the first embodiment of the present disclosure comprises: (a) a voltage generating section that includes a vibrator and a fixed potential electrode in contact with the receiving surface of the vibrator. This voltage generating section generates a voltage through the piezoelectric effect on the output surface of the vibrator, which is opposite to the receiving surface (i.e., the surface on the other side of the receiving surface). (b) an impedance transformation element that operates using the potential of a specific localized area on the output surface of the stress concentration portion of the vibrator as a control voltage, with this localized area serving as a potential transfer region. The vibrator can be entirely composed of piezoelectric layers (piezoelectric bodies), or only a portion of the stress concentration portion can be composed of piezoelectric layers (piezoelectric bodies). That is, as long as the voltage generating section is configured with at least a piezoelectric layer (piezoelectric body) in the stress concentration portion of the vibrator, which has a continuous structure as a stress field, it can be implemented. Furthermore, even if the entire vibrator is composed of piezoelectric layers, it is possible to have a vibrator structure with a non-uniform piezoelectric effect that enhances the piezoelectric effect in the stress concentration portion by distributing the piezoelectric constant of the piezoelectric layers. Therefore, the impedance transformation element operates using the potential of a specific localized area of the piezoelectric layer located in the stress concentration portion as a potential transfer region, with the potential of this potential transfer region serving as the control voltage. In the acoustic element according to the first embodiment, the ultrasonic pressure applied to the vibrator is used as the output signal of the impedance transformation element.

According to the present disclosure, an acoustic element that achieves high sensitivity and broadband performance, reduces output impedance, and is suitable for reception can be provided.

### BRIEF DESCRIPTION OF DRAWINGS

FIG. 1A is a schematic plan view illustrating the overall structure of an acoustic element according to a first embodiment of the present disclosure, which can constitute a unit (unit cell) of an acoustic element integrated circuit.

FIG. 1B is an enlarged plan view of a portion of the acoustic element in FIG. 1, showing the planar layout of an impedance conversion element through a voltage generation section.

FIG. 2 is a schematic cross-sectional view illustrating the structure viewed from the direction of II-II in FIG. 1B.

FIG. 3A is an equivalent circuit diagram illustrating a model in which the gate terminal of a MIS transistor is connected to the output of a piezoelectric element.

FIG. 3B is an equivalent circuit diagram of the acoustic element according to the first embodiment.

FIG. 4A is a schematic cross-sectional view illustrating a parallel ring-type stress distribution enhancement structure of a simulation object.

FIG. 4B is a cross-sectional view illustrating five potential transfer regions provided on the output surface of the vibrator of the stress distribution enhancement structure in FIG. 4A.

FIG. 4C is a diagram illustrating transient response characteristics in five potential transfer regions when aluminum nitride (AlN) is used in the stress distribution enhancement structure in FIG. 4A, as a simulation result.

FIG. 4D illustrates the transient response characteristics in five potential transfer regions when the diameter and thickness of the protrusions in the piezoelectric layer composed of AlN differ from those in FIG. 4C.

FIG. 4E depicts the frequency dependence of voltage sensitivity when using lead zirconate titanate (PZT) in the piezoelectric layer, with the aspect ratio of the central protrusion as a parameter.

FIG. 4F shows the frequency dependence of voltage sensitivity when using PZT in the piezoelectric layer, with the aspect ratio of the central protrusion fixed at 1 and the diameter of the central protrusion as a parameter.

FIG. 5A is a schematic cross-sectional view showing another type of parallel ring-shaped stress distribution enhancement structure.

FIG. 5B is a cross-sectional view illustrating five potential transfer regions provided on the output surface of the vibrator of the stress distribution enhancement structure in FIG. 5A.

FIG. 5C presents simulation results when using PZT in the piezoelectric layer of the stress distribution enhancement structure in FIG. 5A.

FIG. 5D illustrates the frequency dependence of voltage sensitivity when using PZT, with the diameter of the protrusions in the piezoelectric layer of the stress distribution enhancement structure shown in FIG. 5A as a parameter.

FIG. 5E is a model cross-sectional view illustrating asymmetric vibrations when the piezoelectric layer of the single piezoelectric crystal structure bends upward and downward.

FIG. 5F shows the stress in the XX direction (FIG. 5F(a)), YY direction (FIG. 5F(b)), and XY direction (FIG. 5F(c)) when using PZT in the piezoelectric layer of the stress distribution enhancement structure in FIG. 5A.

FIG. 6A is a schematic cross-sectional view illustrating the arrangement of ideal electrodes for detecting minute potentials as a simulation object to verify the voltage distribution of a detailed stress distribution enhancement structure.

FIG. 6B presents the simulated transient response when using PZT in the piezoelectric layer of the stress distribution enhancement structure with the ideal electrodes for detecting minute potentials shown in FIG. 6A.

FIG. 6C is an explanatory diagram of the voltage distribution obtained from simulations with the diameter of the protrusions in the central part of the vibration cavity as a parameter when using PZT in the piezoelectric layer of the stress distribution enhancement structure with the ideal electrodes for detecting minute potentials shown in FIG. 6A.

FIG. 7A is a schematic cross-sectional view illustrating a V-shaped stress distribution enhancement structure.

FIG. 7B illustrates the simulated transient response when using PZT in the piezoelectric layer of the stress distribution enhancement structure shown in FIG. 7A.

FIG. 7C is a diagram illustrating the simulation results of transient response when using PZT in the piezoelectric layer of the stress distribution enhancement structure with different thicknesses compared to FIG. 7B.

FIG. 8A is a schematic cross-sectional view illustrating the A-shaped stress distribution enhancement structure.

FIG. 8B is a diagram illustrating the simulation results of transient response when using PZT in the piezoelectric layer of the stress distribution enhancement structure shown in FIG. 8A.

FIG. 9A is a schematic cross-sectional view illustrating the M-shaped stress distribution enhancement structure.

FIG. 9B is a diagram illustrating the simulation results of transient response when using PZT in the piezoelectric layer of the stress distribution enhancement structure shown in FIG. 9A.

FIG. 10A is a schematic cross-sectional view illustrating the W-shaped stress distribution enhancement structure.

FIG. 10B is a diagram illustrating the simulation results of transient response when using PZT in the piezoelectric layer of the stress distribution enhancement structure shown in FIG. 10A.

FIG. 11A is a schematic cross-sectional view illustrating a flat disc-shaped common structure without enhanced stress distribution.

FIG. 11B is a diagram illustrating the simulation results of transient response when using PZT in the piezoelectric layer of the flat disc-shaped common structure shown in FIG. 11A.

FIG. 11C is a diagram illustrating the simulation results of transient response when using AlN in the piezoelectric layer of the flat disc-shaped common structure shown in FIG. 11A.

FIG. 11D is an explanatory diagram illustrating the transient response when using AlN in the piezoelectric layer of the flat disc-shaped common structure shown in FIG. 11A, with different film thicknesses compared to FIG. 11C.

FIG. 12 is a diagram illustrating the frequency dependence of voltage sensitivity when using PZT in the piezoelectric layer with different shapes of stress distribution enhancement structures as parameters (Part 1).

FIG. 13 is a diagram illustrating the frequency dependence of voltage sensitivity when using PZT in the piezoelectric layer with different shapes of stress distribution enhancement structures as parameters (Part 2).

FIG. 14 is a schematic cross-sectional view illustrating the main part of an acoustic element according to a first variation of the first embodiment of the present disclosure, corresponding to the structure viewed from the II-II direction of FIG. 2A.

FIG. 15 is a schematic cross-sectional view illustrating the main part of an acoustic element according to a second variation of the first embodiment of the present disclosure, corresponding to the structure viewed from the II-II direction of FIG. 2A.

FIG. 16A is a process cross-sectional view illustrating the manufacturing method of the acoustic element according to the second variation of the first embodiment shown in FIG. 15.

FIG. 16B is a process cross-sectional view illustrating the manufacturing method of the acoustic element according to the second variation of the first embodiment, following the process of FIG. 16A.

FIG. 16C is a process cross-sectional view illustrating the manufacturing method of the acoustic element according to the second variation of the first embodiment, following the process of FIG. 16B.

FIG. 16D is a process cross-sectional view illustrating the manufacturing method of the acoustic element according to the second variation of the first embodiment, following the process of FIG. 16C.

FIG. 16E is a process cross-sectional view illustrating the manufacturing method of the acoustic element according to the second variation of the first embodiment, following the process of FIG. 16D.

FIG. 16F is a process cross-sectional view illustrating the manufacturing method of the acoustic element according to the second variation of the first embodiment, following the process of FIG. 16E.

FIG. 16G is a process cross-sectional view illustrating the manufacturing method of the acoustic element according to the second variation of the first embodiment, following the process of FIG. 16F.

FIG. 16H is a process cross-sectional view illustrating the manufacturing method of the acoustic element according to the second variation of the first embodiment, following the process of FIG. 16G.

FIG. 16I is a process cross-sectional view illustrating the manufacturing method of the acoustic element according to the second variation of the first embodiment, following the process of FIG. 16H.

FIG. 16J is a process cross-sectional view illustrating the manufacturing method of the acoustic element according to the second variation of the first embodiment, following the process of FIG. 16I.

FIG. 16K is a process cross-sectional view illustrating the manufacturing method of the acoustic element according to the second variation of the first embodiment, following the process of FIG. 16J.

FIG. 16L is a process cross-sectional view illustrating the manufacturing method of the acoustic element according to the second variation of the first embodiment, following the process of FIG. 16K.

FIG. 17 is an equivalent circuit diagram illustrating the technical idea of the acoustic element according to the second embodiment of the present disclosure in a model manner.

FIG. 18A is a plan view focusing on the impedance conversion element, showing a part of the acoustic element according to the second embodiment through the voltage generation section.

FIG. 18B is a cross-sectional view illustrating the structural outline viewed from the direction of XVIIIB-XVIIIB in FIG. 18A.

FIG. 18C is a cross-sectional view depicting the structural outline of an acoustic element according to a modified example of the second embodiment of the present disclosure (corresponding to the cross-sectional structure viewed from the direction of XVIIIB-XVIIIB in FIG. 18A).

FIG. 18D is a graph showing the frequency dependence of voltage sensitivity of the acoustic element according to the modified example of the second embodiment shown in FIG. 18C, with the material used for the center column as a parameter.

FIG. 19A is a process cross-sectional view illustrating the process of manufacturing the impedance conversion element side chip as a manufacturing method of the acoustic element according to the second embodiment.

FIG. 19B is a process cross-sectional view of the manufacturing method of the acoustic element according to the second embodiment, illustrating the manufacturing process of the impedance conversion element side chip following FIG. 19A.

FIG. 19C is a process cross-sectional view of the manufacturing method of the acoustic element according to the second embodiment, illustrating the manufacturing process of the impedance conversion element side chip following FIG. 19B.

FIG. 19D is a process cross-sectional view of the acoustic element manufacturing method according to the second embodiment, illustrating the manufacturing process of the impedance conversion element side chip following FIG. 19C.

FIG. 19E is a process cross-sectional view of the acoustic element manufacturing method according to the second embodiment, illustrating the manufacturing process of the impedance conversion element side chip following FIG. 19D.

FIG. 19F is a process cross-sectional view of the acoustic element manufacturing method according to the second embodiment, illustrating the process flow for starting the manufacturing of a new voltage generation section side chip, which is different from the process for manufacturing the impedance conversion element side chip up to FIG. 19E.

FIG. 19G is a process cross-sectional view of the acoustic element manufacturing method according to the second embodiment, illustrating the manufacturing process of the voltage generation unit side chip after FIG. 19F.

FIG. 19H is a process cross-sectional view of the acoustic element manufacturing method according to the second embodiment, illustrating the manufacturing process of the voltage generation unit side chip after FIG. 19G.

FIG. 19I is a process cross-sectional view of the acoustic element manufacturing method according to the second embodiment, illustrating the manufacturing process of the voltage generation unit side chip after FIG. 19H.

FIG. 19J is a process cross-sectional view of the acoustic element manufacturing method according to the second embodiment, illustrating the manufacturing process of the voltage generation unit side chip after FIG. 19I.

FIG. 19K is a process cross-sectional view of the acoustic element manufacturing method according to the second embodiment, illustrating the direct bonding of the impedance conversion element side chip manufactured in the processes of FIGS. 19A to 19E and the voltage generation unit side chip manufactured in the processes of FIGS. 19F to 19J.

FIG. 20 is an equivalent circuit diagram illustrating the technical idea of the acoustic element according to the third embodiment of the present disclosure in a model manner.

FIG. 21A is a plan view focusing on the impedance conversion element and showing a part of the acoustic element according to the third embodiment enlarged by the voltage generation unit.

FIG. 21B is a schematic cross-sectional view of the structure viewed from the direction of XXIB-XXIB in FIG. 21A.

FIG. 22 is an equivalent circuit diagram illustrating the technical idea of the acoustic element according to a modified example of the third embodiment of the present disclosure in a model manner.

FIG. 23 is a schematic cross-sectional view of the structure of the acoustic element according to the modified example of the third embodiment.

FIG. 24 is an equivalent circuit diagram illustrating the technical idea of the acoustic element according to the fourth embodiment of the present disclosure in a model manner.

FIG. 25 is an equivalent circuit diagram illustrating the technical idea of the acoustic element according to the fifth embodiment of the present disclosure in a model manner.

FIG. 26 is a schematic cross-sectional view of the structure of the acoustic element according to the fifth embodiment shown in FIG. 25.

FIG. 27 is a plan view illustrating an example of the planar layout of the impedance conversion element constituting the acoustic element according to another embodiment (illustrating the structure of the main part of the orthogonal complementary element circuit constituting the impedance conversion element by taking an example of the voltage generation unit located above it).

FIG. 28B illustrates the operation of the positive complementary element circuit shown in FIG. 28A, specifically describing the changes in the potential barrier of electrons in one main current as the saddle point of the potential distribution.

FIG. 28C illustrates the changes in the potential barrier of holes in the other main current in the positive complementary element circuit shown in FIG. 28A.

FIG. 28D is an equivalent circuit diagram used to illustrate, in a model manner, an example of circuit configuration when the positive cross-component circuit shown in FIG. 28A is used as an impedance transformation component.

FIG. 29 is a plan layout diagram showing a modified example of the acoustic component shown in FIG. 28A.

FIG. 30 is a graph comparing the frequency dependence of voltage sensitivity when using AlN and PZT for the central protrusion, with the material of the residual plate-shaped portion being different from or the same as that of the central protrusion.

FIGS. 31A-31B are model diagrams used to illustrate the stress asymmetry generated when a unimorph structure with a disc-shaped vibration cavity is bent up and down to form a convex surface.

### DETAILED DESCRIPTION OF THE DISCLOSURE

Hereinafter, with reference to the accompanying drawings, the acoustic elements of the first to fifth embodiments will be described as specific examples of the present disclosure. In the following description and drawings of the acoustic elements of the first to fifth embodiments, the same or similar parts are denoted by the same or similar reference numerals and are collectively explained. However, it should be noted that the drawings are schematic, and the relationship between thickness and planar dimensions, as well as the size ratios of various components, may differ from the actual situation. Therefore, specific thicknesses, dimensions, sizes, etc. should be judged more diversely based on the technical ideas comprehended in the following description. In addition, there are naturally parts with different dimensional relationships and proportions between the drawings.

Furthermore, the acoustic elements of the first to fifth embodiments shown below are examples illustrating the device structure, manufacturing method, and other aspects of the technical idea used in this disclosure. The technical idea of this disclosure does not limit the materials, shapes, structures, or configurations of the constituent elements, as well as the steps of the manufacturing method, to those shown in the first to fifth embodiments. That is, the technical idea of this disclosure is not limited to the descriptions of the acoustic elements of the first to fifth embodiments below, and various modifications can be made within the technical scope specified by the claims recorded in the patent claims.

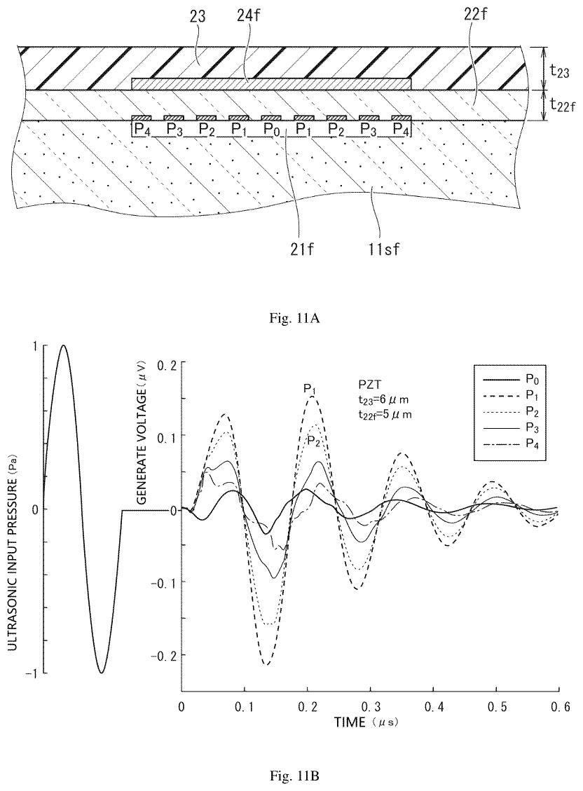

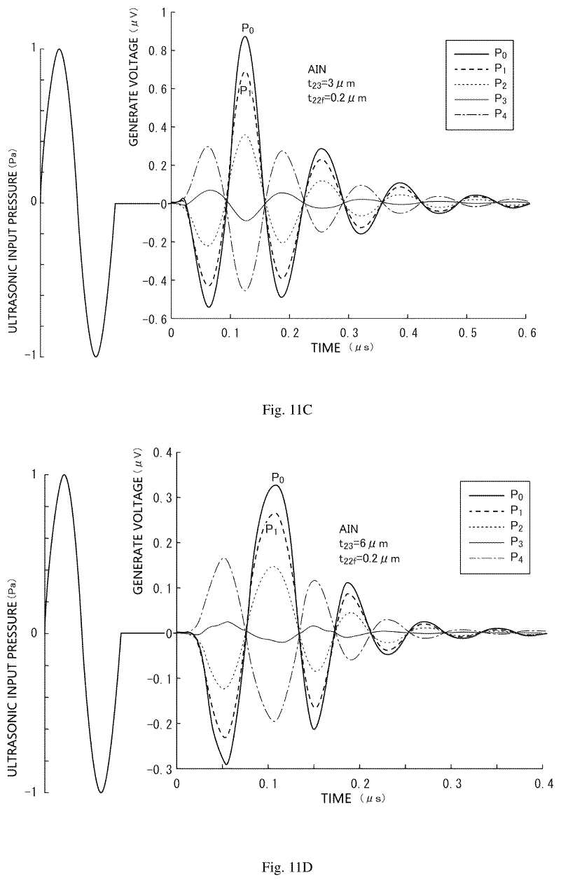

In traditional PMUTs, a bimorph-type structure is commonly employed, which involves forming piezoelectric layers on both sides of a fixed-potential electrode. In addition to the structure with two piezoelectric layers, a bimorph-type structure is also known, in which a piezoelectric layer is formed on one side of the fixed-potential electrode, and an elastic layer composed of a material with a different rigidity from the piezoelectric layer is formed on the other side. However, in the acoustic elements of the first to fifth embodiments shown below, for example, as shown in FIG. 11A, the description is based on a voltage generation section with a unimorph-type (single-crystal type) structure composed of a vibrator 22f consisting of a single piezoelectric layer and a fixed-potential electrode 24a in contact with the receiving surface of the vibrator 22f. That is, in the description of the acoustic elements of the first to fifth embodiments, the main focus is on the voltage generation section of the unimorph-type structure and the receiving element composed of an impedance transformation element that operates using the potential of a specific part (local) of the voltage generation section as a control voltage. However, the description of the unimorph-type structure is for convenience only, and is not intended to limit the scope of application of the present disclosure to the unimorph-type structure. A bimorph-type structure is also possible.

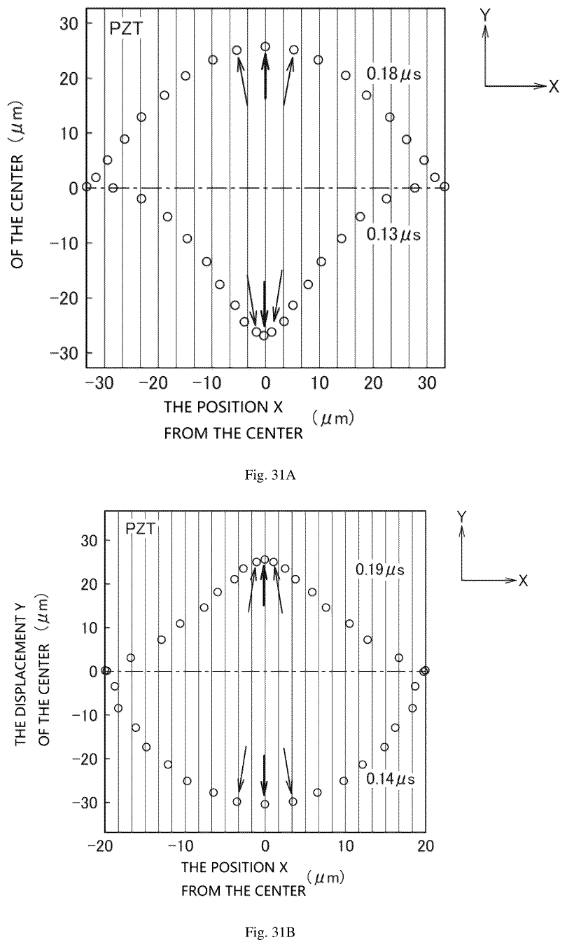

The structure of the flat disc-type vibrating cavity shown in FIG. 11A is a conventionally known structure from the perspective of focusing on the vibrating cavity. However, to the inventor's knowledge, examples of constructing a flat disc-type vibrating cavity like FIG. 11A for a unimorph structure are not common. For the thin flat disc-type vibrating cavity 21f shown in FIG. 11A, as shown in FIGS. 31A-31B, consider the vibration of the vibrator 22f composed of a flat piezoelectric layer bending on the upper and lower sides along the normal direction of the disc (Y direction in FIGS. 31A-31B). As shown in FIGS. 31A-31B, when the flat vibrator 22f bends on the upper side to form an upward convex surface and bends on the lower side to form a downward convex surface, mutually asymmetric vibrations with different intervals will occur. FIGS. 31A-31B are model diagrams assuming that the vibrator 22f is flat in the horizontal direction (X direction in FIGS. 31A-31B) in a no-load state.

FIG. 31A depicts the displacement diagram of the vibrator 22f composed of PZT when a disc-shaped vibrating cavity 21f with a diameter of 66 μm is formed in the X direction. In FIG. 31A, 19 circles, arranged at equal intervals of approximately 3.7 μm in the X direction under a no-load condition, represent the displacement levels of the circles in the Y direction at positions varying from the center along the X direction. In the scenario depicted in FIG. 31A, when the vibrator 22f bends upward, the spacing between the circles at the center of the vibrator 22f tends to expand in the X direction. Conversely, when the vibrator 22f bends downward, the spacing between the circles at the center tends to contract in the X direction, indicating uneven strain in the vibrator 22f, and consequently, uneven stress within it. The shape of the circles arrangement in FIG. 31A when the vibrator 22f bends downward represents the displacement positions of each oval after 0.13 μs has elapsed since the arrival of the ultrasonic pulse, while the shape when the vibrator 22f bends upward represents the displacement positions of each oval after 0.18 μs has elapsed.

FIG. 31B illustrates a case where a disc-shaped vibrating cavity 21f with a diameter of 40 μm is formed in the X direction. The unloaded state of the vibrator 22f, which is composed of lead zirconate titanate (PbZrₓTi₁₋ₓO_{3:} PZT), is modeled as 19 circles arranged at equal intervals of approximately 2.2 μm in the X direction. In the model depicted in FIG. 31B, when the plate-shaped vibrator 22f bends upward to form a curved surface, the spacing between the circles in the center of the vibrator 22f narrows in the X direction. Conversely, when the plate-shaped vibrator 22f bends downward to form a curved surface, the spacing between the circles in the center of the vibrator 22f widens in the X direction. The shape of the circles arrangement in FIG. 31B when the vibrator 22f bends downward represents the displacement positions of each oval after 0.14 μs has elapsed since the arrival of the ultrasonic pulse, while the shape of the circles arrangement when the vibrator 22f bends upward represents the displacement positions of each oval after 0.19 μs has elapsed since the arrival of the ultrasonic pulse. In the case of FIG. 31B, it is also evident that the strain of the vibrator 22f is uneven, resulting in uneven stress within the vibrator 22f.

In the unimorph structure, due to the uneven strain and stress of the vibrator 22f, which constitutes the voltage generation part, a higher voltage is generated at a specific location on the output surface (the lower main surface in FIG. 11A) opposite to the receiving surface of the vibrator 22f (the surface on the other side of the receiving surface). This feature is characterized by the in-plane non-uniformity of the generated voltage. The “specific location” on the output surface of the vibrator 22f corresponds to the region where the stress of the vibrator 22f is concentrated. This specific location within the surface defines the potential transfer area of the acoustic element according to the first to fifth embodiments. The impedance conversion element operates with the potential of the potential transfer area as the control voltage, and the ultrasonic pressure applied to the piezoelectric layer is used as the output signal of the impedance conversion element. This output signal is used as the output signal of the acoustic element according to the first to fifth embodiments.

When the impedance transforming element is composed of a single active element, the “first main electrode region” of the active element refers to the semiconductor region that becomes either the source region or the drain region in an electric field effect transistor (FET), static induction transistor (SIT), high electron mobility transistor (HEMT), or a new transistor structure equivalent to these. In a bipolar junction transistor (BJT), insulated gate bipolar transistor (IGBT), or a semiconductor element of a new structure equivalent to these, it refers to the semiconductor region that becomes either the emitter region or the collector region. Additionally, in a thyristor such as a MIS-controlled static induction thyristor (SI thyristor) or a semiconductor element of a new structure equivalent to these, it refers to the semiconductor region that becomes either the anode region or the cathode region. The “second main electrode region” in FETs, SITs, HEMTs, etc., refers to the semiconductor region that becomes either the source region or the drain region outside the first main electrode region. In BJTs, IGBTs, etc., it refers to the region that becomes either the emitter region or the collector region outside the first main electrode region. In SI thyristors, etc., it refers to the semiconductor region that becomes either the anode region or the cathode region outside the first main electrode region.

In this way, when the impedance transforming element is composed of a single active element, if the “first main electrode region” is the source region, the “second main electrode region” is the drain region, and the “main current” flows between the first main electrode region 15a and the second main electrode region 15b. If the “first main electrode region” is the emitter region, the “second main electrode region” is the collector region. If the “first main electrode region” is the anode region, the “second main electrode region” is the cathode region. In cases such as MISFETs, if the bias relationship is exchanged, the functions of the “first main electrode region” and the “second main electrode region” may be interchangeable. When the impedance transforming element is composed of multiple active elements, such as in a CMOS-type circuit configuration or differential amplifier, for each of the multiple active elements, a pair of first main electrode region 15a and second main electrode region 15b, a pair of third main electrode region 15d and fourth main electrode region 15c, and so on are sequentially defined. For example, in the CMOS-type circuit configuration described in the third embodiment, the “third main electrode region” refers to the semiconductor region that becomes either the source region or drain region in FETs, SITs, HEMTs, etc., and the “fourth main electrode region” refers to the semiconductor region that becomes either the drain region or source region paired with the third main electrode region in FETs, SITs, HEMTs, etc.

In addition, the terms “upper”, “lower”, “up”, “down”, and the directional definitions using “up” and “down” in the following description are solely for the convenience of explanation and do not limit the technical idea of the present disclosure. For instance, if the object is rotated by 90°, the up and down will be converted to left and right reading, and if rotated by 180°, the up and down will be reversed. Furthermore, in the following description, the case where the first conductivity type is p-type and the second conductivity type is n-type is taken as an example for explanation. However, the opposite conductivity type relationship can also be chosen, that is, setting the first conductivity type as n-type and the second conductivity type as p-type. The first conductivity type and the second conductivity type do not necessarily have to be commonly defined in the following first to fifth embodiments. For example, in the descriptions of the first to fourth embodiments regarding MIS-type transistors (hereinafter referred to as “MIS transistors”), the first conductivity type is defined as p-type and the second conductivity type is defined as n-type, but in the description of the fifth embodiment regarding junction transistors, the first conductivity type is set as n-type and the second conductivity type is set as p-type. Within the descriptions of each embodiment, as long as the definitions of the first conductivity type and the second conductivity type are common, it is sufficient. Additionally, within the descriptions of each embodiment, the opposite conductivity type relationship can also be chosen.

Similarly, in the descriptions of the first to fourth embodiments, the first main electrode region is described as the drain region and the second main electrode region is described as the source region. However, in the descriptions of the second to fifth embodiments, the definition of the first main electrode region as the source region and the second main electrode region as the drain region is easier to understand. Within the descriptions of each embodiment, as long as the definitions of the first main electrode region and the second main electrode region are common, it is sufficient. Additionally, within the descriptions of each embodiment, the definition relationship of the first main electrode region and the second main electrode region can also be selected inversely. Furthermore, the “+” and “−” appended after “n” and “p” respectively indicate semiconductor regions with relatively higher or lower impurity density compared to semiconductor regions without appending “+” and Additionally, the “−−” appended after “n” and “p” indicates a high-resistivity semiconductor region very close to the intrinsic semiconductor (i-layer). However, even if semiconductor regions with the same “+” or “−” appendage, or semiconductor regions without appending “+” and “−”, do not necessarily mean that their respective impurity densities are strictly the same.

### First Embodiment

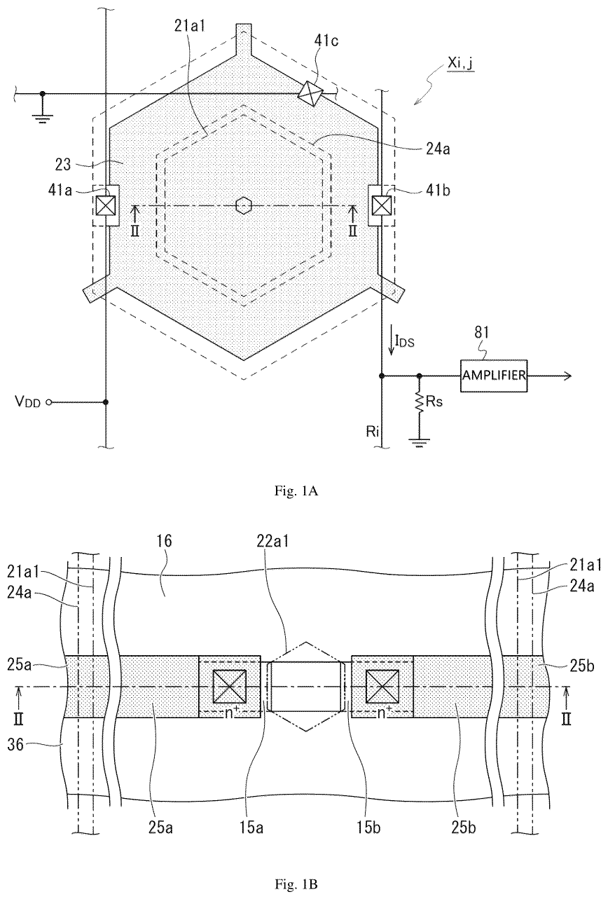

The regular hexagonal unit cell X_{i,j} (although not shown in the FIG.) shown in FIG. 1A, together with adjacent regular hexagonal unit cells X_{(i-1, j+2)}, . . . , X_{(i-1, j+1)}, X_{i, j+1}, X_{(i+1, j+1)}, . . . , X_{(i-1), j}, X_{(i+1), j}, . . . , X_{i, (j-1)}, X_{(i+1, j-1)}, . . . , is arranged in a two-dimensional matrix and serves as a unit element capable of forming an acoustic element integrated circuit pattern.

That is, as shown in FIG. 1A, FIG. 1B, and FIG. 2, the acoustic element of the first embodiment of the present disclosure includes voltage generating sections (22a1, 24a) that generate non-uniform voltages through piezoelectric effect, and impedance transforming elements (14, 15a, 15b) that operate with the potential of specific parts (local) of the voltage generating sections (22a1, 24a) as a control voltage. As can be seen from the following description, the acoustic element of the first embodiment can improve reception sensitivity and is therefore suitable for receiving elements. The unit cells X_{i,j} shown in FIG. 1A can be arranged on the same plane (the same curved surface) to form a two-dimensional matrix.

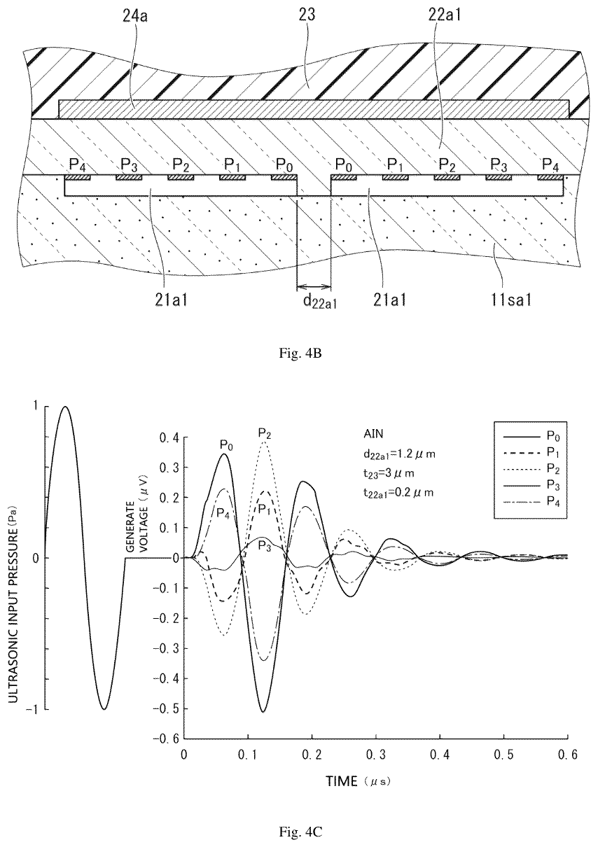

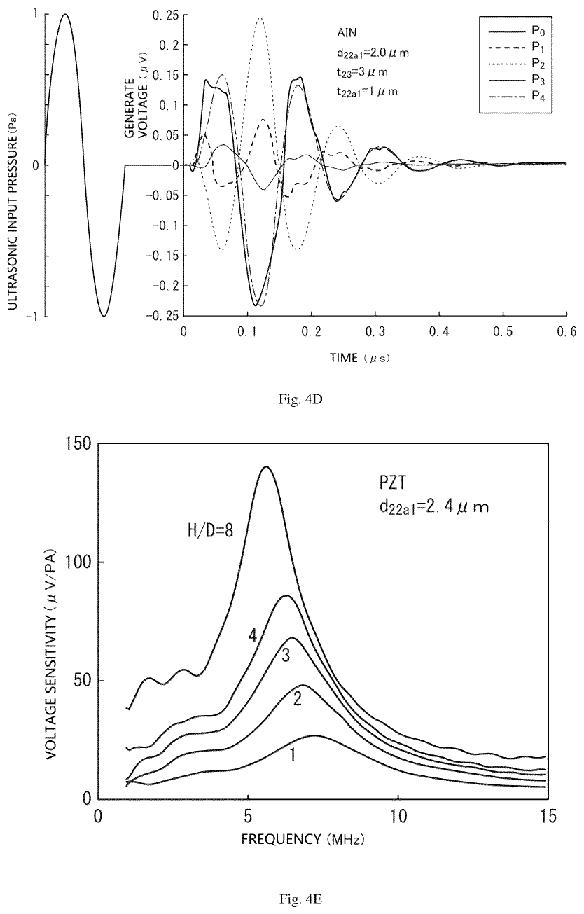

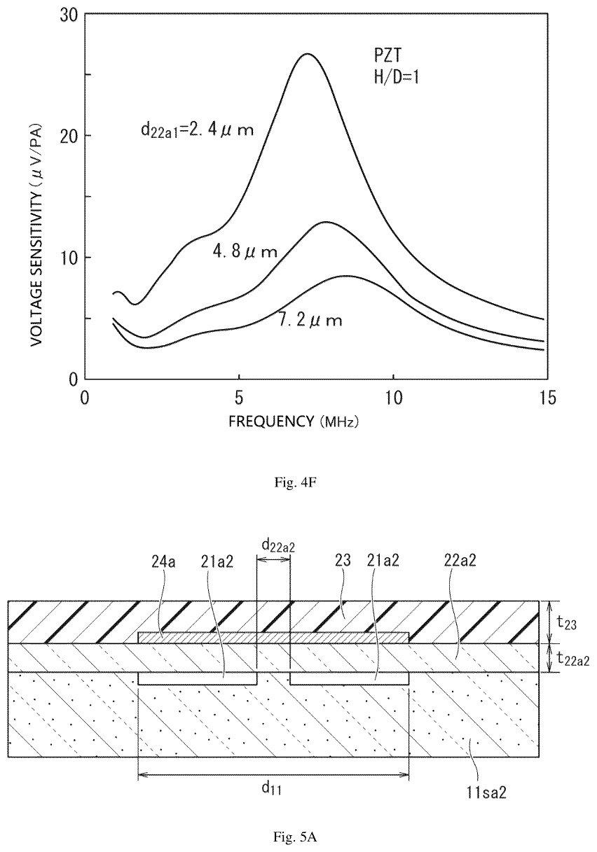

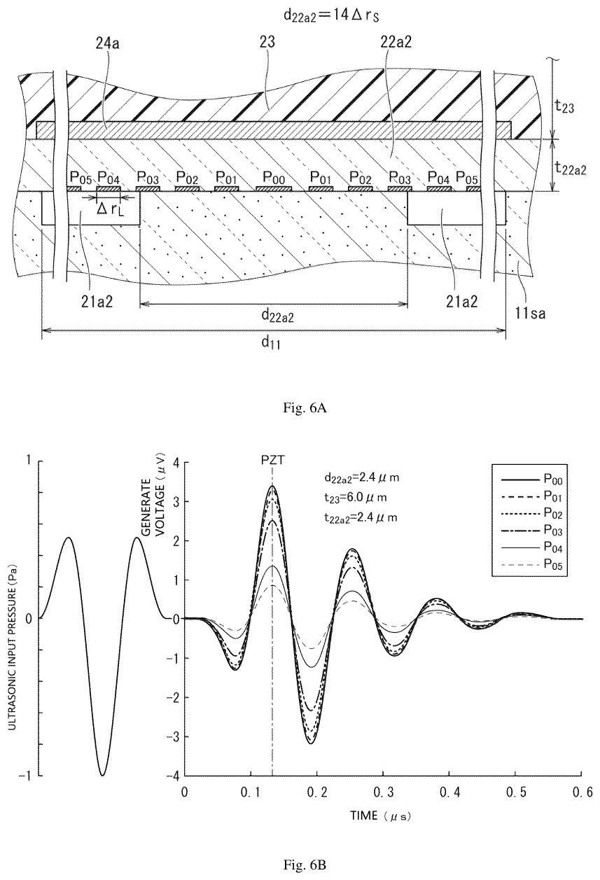

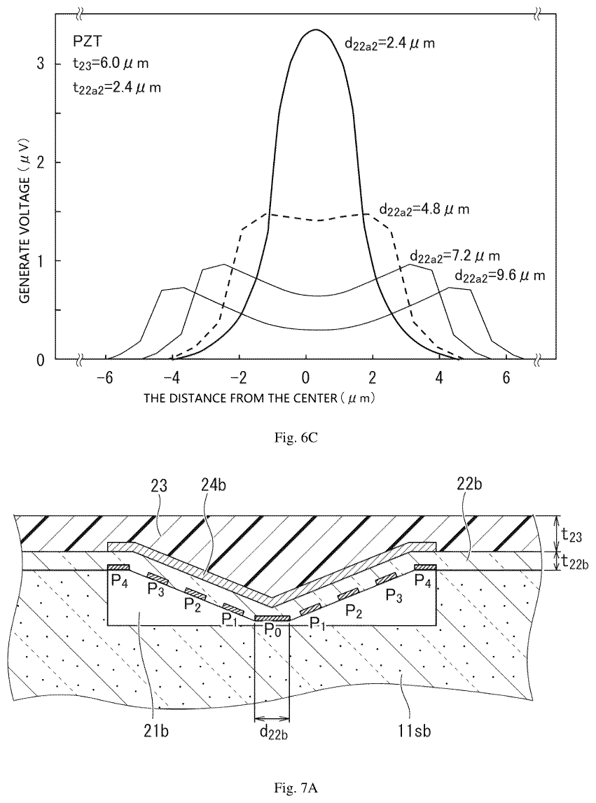

In FIG. 1A, the case where the planar pattern is a regular hexagon is illustrated. However, the planar pattern of the voltage generating sections (22a1, 24a) is not limited to a regular hexagon. Various planar patterns such as a regular octagon, regular dodecagon, and regular icosahedron can also be adopted. Considering the corner rounding in the lithography process during manufacturing, the regular icosahedron on the mask level will have a shape closer to the actual shape after the manufacturing process. However, from the perspective of suppressing harmonics generated during the drum-like vibration of the voltage generating sections (22a1, 24a), regular hexagons and higher-order regular polygons are preferred. Additionally, as the vibrating body 22a1, wurtzite compound semiconductors such as aluminum nitride (AlN), gallium nitride (GaN), zinc oxide (ZnO), and cadmium sulfide (CdS) belong to the hexagonal crystal system and have good compatibility with the shape of a regular hexagon (perovskite structures such as PZT belong to the cubic crystal system). As can be seen from the cross-sectional view in FIG. 2, the voltage generating section (22a1, 24a) features a unimorph structure, comprising a vibrator 22a1 and a fixed potential electrode 24a in contact with the receiving surface (the upper main surface in FIG. 2) of the vibrator 22a1. This unimorph voltage generating section (22a1, 24a) generates a higher voltage at a specific part of the output surface (the lower main surface in FIG. 2) opposite to the receiving surface of the vibrator 22a1 (the surface on the other side of the receiving surface) due to the piezoelectric effect, exhibiting a voltage distribution with unevenly generated voltage as shown in FIG. 6C. In FIG. 6C, the horizontal axis represents the distance from the center, but the “specific part” of the output surface of the vibrator 22a1 refers to, for example, the potential transfer area corresponding to the stress concentration area of the vibrator 22a1, which is located inside the area marked as P₀ in FIG. 4B. As shown in FIG. 2, the vibrator 22a1 can be entirely composed of piezoelectric layers, or only a portion corresponding to the stress concentration area can be composed of piezoelectric layers, with the remaining part being non-piezoelectric layers. For instance, only the columnar portion constituting the central protrusion can be composed of piezoelectric layers, while the remaining plate-like portion and peripheral areas can be non-piezoelectric layers. That is, as long as the voltage generating section is configured with at least a piezoelectric layer at the stress concentration area of the vibrator 22a1, it is sufficient. Therefore, the impedance transforming elements (14, 15a, 15b) operate by using a specific local part of the piezoelectric layer located at least at the stress concentration area as a potential transfer area, and operate with the potential of this potential transfer area as the control voltage.

The impedance transformation elements (14, 15a, 15b) operate with the potential of the potential transfer area located in the downward protrusion on the output surface side of the vibrator 22a1 in the central part of FIG. 2 as the control voltage. That is, the output voltage of the voltage generation section (22a1, 24a) generated by the ultrasonic pressure applied to the vibrator 22a1 is used as the input signal for the impedance transformation elements (14, 15a, 15b). Then, the output signal converted by the impedance transformation elements (14, 15a, 15b) becomes the output signal of the receiving element X_{i,j}; The downward protruding convex part on the output surface side of the vibrator 22a1 is indicated by a dashed line in FIG. 1A, and the regular hexagonal shape is indicated by a double-dot dashed line in FIG. 1B, representing a regular hexagonal prism-shaped convex part. As shown in FIG. 2, the convex part arranged in a stepped structure at the central part of the output surface side of the vibrator 22a1 is surrounded by a parallel ring-shaped vibration cavity 21a1 in a centrally symmetric manner. As can be understood from the plan view of FIG. 1A, the ring-shaped surface constituting the vibration cavity 21a1 has a topological structure with a regular hexagonal planar pattern. In the cross-sectional view of FIG. 2, the vibration cavity 21a1 is located on both sides of the central downward protrusion. However, in reality, the two vibration cavities 21a1 located on both sides of the central protrusion are continuous and integrated structures on the front and rear sides of the paper surface.

As shown in FIG. 1A, on the outer side of the outer wall (indicated by dashed lines) of the hexagonal vibration cavity 21a1, the dashed lines defining the outline of the hexagonal fixed potential electrode 24a pattern are set to surround the planar pattern of the vibration cavity 21a1. Corresponding to FIG. 1A, on the left and right sides of FIG. 1B, the positions of the outer inner wall of the vibration cavity 21a1 and the outer circumferential position of the fixed potential electrode 24a are indicated by double-dot dashed lines. The planar patterns of the ring surface constituting the vibration cavity 21a1 and the planar pattern of the convex portion located at the center of the ring surface are hexagonal, which is due to the geometric similarity requirement caused by the shape of the unit cell X_{i,j} shown in FIG. 1A being hexagonal. For example, if the shape of the unit cell X_{i,j} is octagonal, dodecagonal, icosahedral, circular, etc., it is ideal to adopt similar shapes such as octagonal, dodecagonal, icosahedral, circular, etc. for the planar patterns of the outermost circumference of the ring surface and the convex portion located at the center of the ring surface.

The impedance conversion element (14, 15a, 15b) of the acoustic element according to the first embodiment, as shown in FIGS. 1B and 2, is an active element comprising a base region 14 formed by a first conductive type (p-type) semiconductor region, and a first main electrode region 15a and a second main electrode region 15b, which are formed by a second conductive type (n⁺-type) semiconductor region and are arranged separately on top of the base region 14. As shown in FIG. 2, the upper surface of the base region 14 between the first main electrode region 15a and the second main electrode region 15b is bonded (heterojunction) to the potential transfer region (located at a central position in FIG. 2) of the vibrator 22a1. For example, by using GaN with a bandgap width of 3.4-3.5 eV as the base region 14 and AlN with a bandgap width of 5-6.2 eV as the vibrator 22a1, an AlN/GaN heterojunction is formed, thereby constituting a heterojunction field-effect transistor (heterojunction FET). Both GaN and AlN have a wurtzite crystal structure, with the lattice constant of GaN in the a-axis direction being 0.318 nm and that of AlN being 0.311 nm, resulting in a lattice mismatch of approximately 2.4%, indicating good compatibility as a heterojunction.

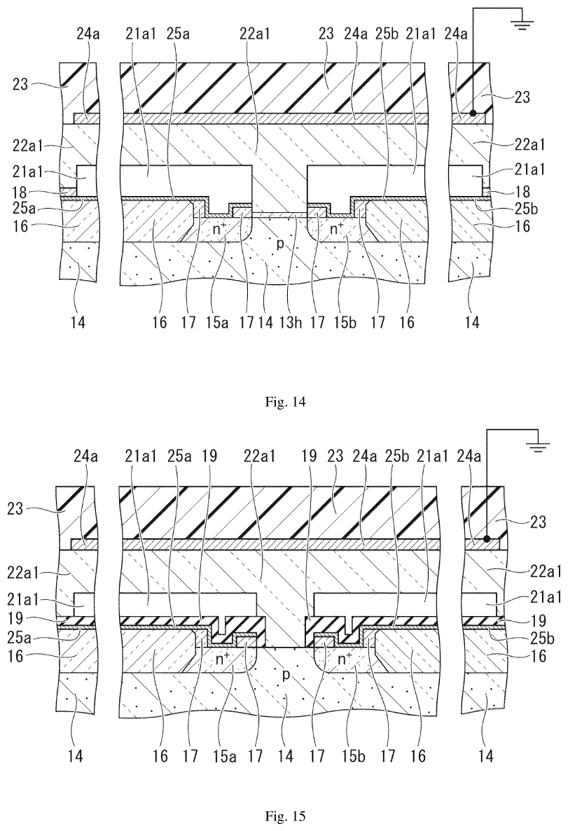

When epitaxially growing AlN (with a longer bond length) on the GaN surface with a c-axis oriented facet, due to the difference in lattice constants between the two, AlN will undergo tensile strain, and internal piezoelectric polarization will be applied to AlN. GaN is also a polar crystal, thus exhibiting piezoelectric polarization. Due to the effects of these two types of piezoelectric polarization, positive fixed charges will be generated at the AlN/GaN interface, and a two-dimensional electron gas will form at the interface. In the case where the substrate region 14 is composed of a GaN substrate, the first main electrode region 15a and the second main electrode region 15b of the impedance transformation element (14, 15a, 15b) can also be composed of GaN. Even in the case where the substrate region 14 is composed of a Si substrate, as shown in FIG. 14, AlN can be epitaxially grown on the buffer layer 13h by using the buffer layer 13h. Additionally, if defects at the heterojunction interface are not considered, AlN can also be directly epitaxially grown on a Si substrate.

Around the periphery of the body region 14, the element isolation insulating film 16 is arranged in a frame shape to define the range of the active region. In the cross-sectional view of FIG. 2, the element isolation insulating film 16 is located on both sides of the active region, but the element isolation insulating film 16 on both sides of the active region is a continuous integrated structure on both the front and back sides of the paper. Inside the active region pattern surrounded by the element isolation insulating film 16, the range (region) of the upper surface of the body region 14 is defined. Above the upper surface (surface) of the active region surrounded by the element isolation insulating film 16, the first main electrode region 15a and the second main electrode region 15b are arranged. Inside the rectangular body region 14 sandwiched between the first main electrode region 15a and the second main electrode region 15b, a channel for carrier flow is formed near the heterojunction interface of the body region 14. In the center of FIG. 1B, the range of the regular hexagonal potential transfer region is indicated by a two-dot chain line. The regular hexagonal potential transfer region, defined as the convex portion on the output surface side of the vibrating body 22a1, is arranged above the channel near the heterojunction interface to enable selective electrostatic induction effects to be locally imparted to the channel. The channel is formed near the heterojunction interface due to changes in surface potential distribution in the depth direction caused by differences in work functions of the materials constituting the heterojunction, resulting in bending of the energy band for carrier accumulation. In the case of an AlN/GaN heterojunction, when it is desired to accumulate two-dimensional electron clouds at the energy band bending point, it is desirable to set GaN as an i-type and AlN as an n-type, bending the energy band at the conduction band edge of GaN below the Fermi level.

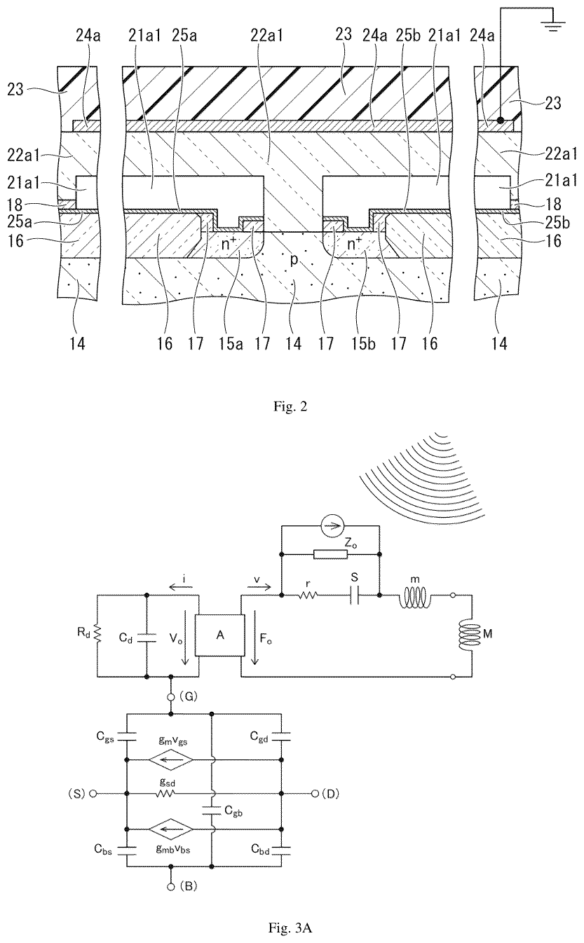

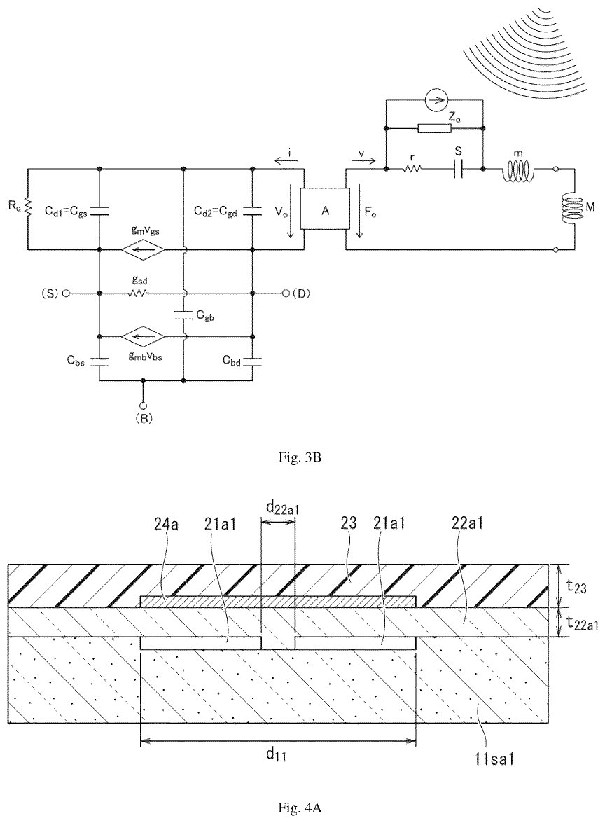

Then, through the n-p-n structure between the first main electrode region 15a and the second main electrode region 15b, a potential barrier that controls carrier movement is formed in the channel. Within the hexagonal region indicated by the double-dotted line, a selective electrostatic induction effect occurs within a depth ranging from the heterojunction to the Debye length. As a result, the height of the potential barrier generated between the first main electrode region 15a and the second main electrode region 15b is controlled by the potential of the potential transfer region of the vibrating body 22a1. The potential of the base region 14 can be set to a fixed potential such as ground potential. This operation is similar to that of a conventional heterojunction FET, but differs from it in that there is no gate electrode. In the structure shown in FIG. 2, if the fixed potential electrode 24a is grounded, the Fermi level in the band diagram becomes 0V at the position of the fixed potential electrode 24a. When an ultrasonic wave is input, the Fermi level inside the vibrating body 22a1, especially near the heterojunction interface, vibrates. When the Fermi level at the heterojunction interface vibrates, the height of the potential barrier of the n-p-n structure changes. In the case of the impedance conversion element (14, 15a, 15b) of the acoustic element according to the first embodiment, as shown in the equivalent circuit of FIG. 3B, the vibrating body 22a1 itself functions as a gate dielectric layer of a conventional MIS transistor. Moreover, although there is no gate electrode structure, the voltage across the first braking capacitor _{Cd1} (=_{Cgs}) and the second braking capacitor _{Cd2} (=C_{gd}) shown in FIG. 3B, etc., specifies the gate voltage for the local region, namely, the channel.

Since the acoustic element according to the first embodiment does not have a gate electrode, there is no need to connect the PMUT as a single element and the FET as a single element through external wiring, as described in Non-Patent Document 2. Therefore, the acoustic element according to the first embodiment essentially does not have a floating impedance problem. Moreover, since the voltage generation sections (22a1, 24a) adopt a stress enhancement structure as shown in FIGS. 4A to 6C, achieving high sensitivity and broadband performance, the acoustic element according to the first embodiment can achieve high sensitivity and broadband performance. In particular, by selecting a specific position where the voltage generated on the output surface of the vibrator 22a1 is the highest as the potential transfer region and driving the active elements of the impedance conversion elements (14, 15a, 15b), it is easy to achieve high sensitivity.

As shown in FIG. 2, an interlayer insulating film 17 is provided on the first main electrode region 15a and the second main electrode region 15b. Through contact holes opened in the interlayer insulating film 17, the first main electrode region 15a is connected to a first main electrode wiring 25a, and the second main electrode region 15b is connected to a second main electrode wiring 25b. In FIG. 1B, the rectangular area indicated by dashed lines below the first main electrode wiring 25a and the second main electrode wiring 25b is hidden, and the first main electrode region 15a and the second main electrode region 15b of the active element are arranged opposite each other with their short sides separated.

On the upper right diagonal side of the hexagon forming the outer perimeter of the fixed potential electrode 24a, a third contact plug 41c connected to a first power source is arranged. The third contact plug 41c is connected to the fixed potential electrode 24a. In FIG. 1A, the first power source is exemplified as being at ground potential (GND), but it is not limited to ground potential (GND); any fixed potential will do. Additionally, two rectangular grooves (cuts) are provided as planar patterns on the outer perimeter of the hexagon forming the fixed potential electrode 24a. In these two grooves, a first contact plug 41a connected to a second power source V_{DD} and a second contact plug 41b connected to a signal wiring Rᵢ are arranged, respectively. Specifically, the first contact plug 41a is arranged inside the groove provided on the left vertical side of the hexagonal planar pattern forming the outer perimeter of the fixed potential electrode 24a, and the second contact plug 41b is arranged inside the groove provided on the right vertical side. The first contact plug 41a is connected to a first main electrode wiring 25a, and the second contact plug 41b is connected to a second main electrode wiring 25b. The signal wiring Rᵢ is connected to an amplifier 81 through an output resistor Rₛ. If the first main electrode region 15a is regarded as the drain region and the second main electrode region 15b is regarded as the source region, the circuit shown in FIG. 1A is an example of a source-grounded circuit form.

The upper section of FIG. 3A illustrates the equivalent circuit of the piezoelectric element functioning as the voltage generating sections (22a1, 24a) depicted in FIG. 2. The “A” enclosed in a square at the left center of the upper section, representing an ideal transformer, is referred to as the “force coefficient”, corresponding to the amplification ratio of the transformer. The force coefficient A represents the conversion coefficient between the force Fₒ of the mechanical system and the voltage Vₒ of the electrical system,

$${F}_{o} = {AV}_{o} \qquad ( 1 )$$

Connect the mechanical system circuit on the right side of the previous paragraph with the electrical system circuit on the left side of the previous paragraph. The magnitude of the force coefficient A depends on the d-constant and e-constant of the piezoelectric material. That is, the force coefficient A depends on the structure, the electromechanical coupling coefficient of the piezoelectric material, etc., but it only serves as a conversion ratio. As shown in equation (1), the larger the force coefficient A, the higher the conversion efficiency of electrical and mechanical energy.

The equivalent circuit of the mechanical system shown on the right side of the upper section of FIG. 3A is composed of an ideal transformer connected in series to the force coefficient A, with the mechanical loss resistance (equivalent mechanical resistance) r, equivalent mass (m+M), and equivalent compliance s connected in series. The equivalent compliance s is the reciprocal of the equivalent stiffness c (s=1/c). The equivalent mass M corresponds to the part that generates the force of the mechanical system and is the mass component that contributes to the input of ultrasonic waves. The equivalent mass m is the inherent mass component in the piezoelectric element, excluding the equivalent mass M. Moreover, at the mechanical loss resistance r and equivalent compliance s that constitute the series circuit, a current source with an internal resistance Z₀ that is almost infinite and a vibration source that vibrates due to the input of ultrasonic waves are connected. The equivalent circuit of the electrical system shown on the left side of the upper section is represented by a braking capacitor C_{d} and a braking resistor (dielectric loss resistance) R_{d} connected in parallel to the ideal transformer of the force coefficient A.

The lower segment of FIG. 3A illustrates the small-signal equivalent circuit of a MIS transistor (insulated gate transistor) featuring a gate insulating film (gate oxide film) structure. Heterojunction FETs and HEMTs are also types of MIS transistors. The connection node where the upper and lower circuits of FIG. 3A are connected is denoted as the gate terminal G of the MIS transistor. The gate terminal G corresponds to the gate electrode situated on the gate insulating film. On the left side of the lower segment, the terminal corresponding to the first main electrode region 15a, serving as an impedance transformation element (14, 15a, 15b), is labeled as the drain terminal D of the MIS transistor. On the right side of the lower segment, the terminal corresponding to the second main electrode region 15b is labeled as the source terminal S of the MIS transistor. The bottom segment of FIG. 3A depicts the substrate terminal B of the MIS transistor. A gate-source capacitance C_{gs} is indicated between the gate terminal G and the source terminal S, a gate-drain capacitance C_{gd} is depicted between the gate terminal G and the drain terminal D, and a gate-substrate capacitance C_{gb} is shown between the gate terminal G and the substrate terminal B.

Between the substrate terminal B and the source terminal S, a substrate-source capacitance C_{bs} is shown. Between the substrate terminal B and the drain terminal D, a substrate-drain capacitance C_{bd} is shown. Between the source terminal S and the drain terminal D, a source-drain conductance g_{sd}=1/r_{sd} (=ΔI_{DS}/ΔV_{DS}) is shown. Additionally, between the source terminal S and the drain terminal D, a current source gₘv_{gs} and a current source g_{mb}v_{bs} are connected in parallel. gₘ represents the gate mutual conductance ΔI_{DS}/ΔV_{BS}, while g_{mb} represents the substrate mutual conductance ΔI_{DS}/ΔV_{BS}. The gate-source capacitance C_{gs} and gate-drain capacitance C_{gd} of the MIS transistor small-signal equivalent circuit shown in the lower part of FIG. 3A correspond to the gate insulating film capacitance of the MIS transistor. A portion of the gate-substrate capacitance C_{gb} also corresponds to a portion of the gate insulating film capacitance.

However, the impedance conversion elements (14, 15a, 15b) shown in FIG. 2 do not have a structure where a gate insulating film exists directly below the voltage generation sections (22a1, 24a). Therefore, FIG. 3A does not represent the equivalent circuit of the acoustic element according to the first embodiment. In the acoustic element according to the first embodiment, the vibrator 22a1 serves as the gate insulating film of the MIS transistor. Corresponding to the structure of the impedance conversion elements (14, 15a, 15b) connected to the voltage generation sections (22a1, 24a) in FIG. 2, the equivalent circuit of the acoustic element according to the first embodiment, where the vibrator 22a1 itself functions as the gate insulating film, is shown in FIG. 3B.

On the left side of FIG. 3B, the gate-source capacitance C_{gs} and the gate-drain capacitance C_{gd} form a trapezoidal circuit in the electrical system equivalent circuit of the voltage generation section (22a1, 24a), which is connected in parallel with the ideal transformer of the force coefficient A and the braking resistor R_{d}. Specifically, the gate-source capacitance C_{gs} functions as the first braking capacitor C_{d1} (C_{gs}=C_{d1}), while the gate-drain capacitance C_{gd} functions as the second braking capacitor C_{d2} (C_{gd}=C_{d2}). A portion of the gate-substrate capacitance C_{gb} also functions as a braking capacitor for the voltage generation section (22a1, 24a). Additionally, the potential barrier height generated in the channel defined between the first main electrode region 15a and the second main electrode region 15b, which controls the movement of carriers, is controlled by the potential of the vibrating body 22a1 through the first braking capacitor C_{d1} (=C_{gs}), the second braking capacitor C_{d2} (=C_{gd}), and a portion of the gate-substrate capacitance C_{gb}.

Piezoelectric constants exist in d-form (strain charge form), e-form (stress charge form), g-form (strain electric field form), and h-form (stress electric field form). For each form, the basic linear piezoelectric equation is given, and they are used differently according to their applications. The basic linear piezoelectric equation expressed in d-form is:

$${D}_{i} = {d}_{i α} {T}_{α} + {ε}_{ij}^{T} {E}_{j} \qquad ( 2 a )$$

$${S}_{α} = {s}_{α β}^{E} {T}_{β} + {d}_{i α} {E}_{i} \qquad ( 2 b )$$

$$α , β = xx , yy , zz , …… , xy \qquad ( 2 c )$$

$$i , j = x , y , z \qquad ( 2 d )$$

Among them, Dᵢ represents the electric flux density (C/m²), T_{α} denotes the stress (N/m²), S_{α} signifies the strain (unit-free), and Eᵢ stands for the electric field (V/m). Furthermore, d_{iα} indicates the piezoelectrie d constant (C/N), s_{αβ}^{E} represents the elastic compliance under a constant electric field (m²/N), and εᵢⱼ^{T} signifies the dielectric constant under a constant stress (pF/m). The subscripts defined in equations (2c) and (2d) represent directions. It should be noted that the Y direction (longitudinal direction) in FIGS. 31A-31B, which has already been explained, corresponds to the z direction used in equations (2a) and (2d), while the X direction (horizontal direction) in FIGS. 31A-31B corresponds to the x or y direction used in equations (2a) and (2d). The superscripts on the second term on the right side of equation (2a) and the first term on the right side of equation (2b) represent conditions. The coefficient with the superscript E represents the value measured under a constant electric field condition, while the coefficient with the superscript T represents the value measured under a constant stress condition.

On the other hand, the piezoelectric fundamental equation can be expressed in the form of e:

$${D}_{i} = {e}_{i α} {S}_{α} + {ε}_{ij}^{S} {E}_{j} \qquad ( 3 a )$$

$${T}_{α} = {c}_{α β}^{E} {S}_{β} - {e}_{i α} {E}_{i} \qquad ( 3 b )$$

Where, e_{iα} is the piezoelectric e-constant (C/m²), c_{αβ}^{E} is the elastic stiffness under constant electric field (N/m²), and εᵢⱼ^{S} is the dielectric constant under constant strain (pF/m). The subscripts indicate the directions defined in equations (2c) and (2d). The superscripts of the second term on the right side of equation (3a) and the first term on the right side of equation (3b) indicate the conditions. The coefficient with the superscript E represents the value measured under constant electric field conditions, while the coefficient with the superscript S represents the value measured under constant strain conditions. Equations (2a) and (3a) represent the direct piezoelectric effect, while equations (2b) and (3b) represent the inverse piezoelectric effect. In an ideal single-crystal piezoelectric material with polarization direction aligned with the z-direction, due to the isotropy of the material, the number of independent components in the elastic compliance tensor and other tensors can be reduced.

For example, the e-form linear piezoelectric basic equation (3a) of AlN can be expressed as:

$$\begin{matrix}Equation 1 & \\ & ( 4 a )\end{matrix}$$

$$[ \begin{matrix}Dx \\ Dy \\ Dz\end{matrix} ] = [ \begin{matrix}0 & 0 & 0 & 0 & - 0.45 & 0 \\ 0 & 0 & 0 & - 0.45 & 0 & 0 \\ - 0.58 & - 0.58 & 1.55 & 0 & 0 & 0\end{matrix} ] [ \begin{matrix}Sxx \\ Syy \\ Szz \\ Syz \\ Szx \\ Sxy\end{matrix} ] + 8.85 [ \begin{matrix}9.04 & 0 & 0 \\ 0 & 9.04 & 0 \\ 0 & 0 & 10.7\end{matrix} ] [ \begin{matrix}Ex \\ Ey \\ Ez\end{matrix} ]$$

Assuming that the piezoelectric e-constant e_{iα} is small, the second term on the right side of the basic linear piezoelectric equation (3b) is omitted. Under the condition of electric flux density Dₓ=D_{y}=D_{z}=0 (open circuit) at the end faces of the piezoelectric film, the basic linear piezoelectric equation (3b) for AlN as the piezoelectric film can be simplified to:

$$( 4 a )$$

$$[ \begin{matrix}Dx \\ Dy \\ Dz\end{matrix} ] = [ \begin{matrix}0 & 0 & 0 & 0 & - 0.45 & 0 \\ 0 & 0 & 0 & - 0.45 & 0 & 0 \\ - 0.58 & - 0.58 & 1.55 & 0 & 0 & 0\end{matrix} ] [ \begin{matrix}Sxx \\ Syy \\ Szz \\ Syz \\ Szx \\ Sxy\end{matrix} ] + 8.85 [ \begin{matrix}9.04 & 0 & 0 \\ 0 & 9.04 & 0 \\ 0 & 0 & 10.7\end{matrix} ] [ \begin{matrix}Ex \\ Ey \\ Ez\end{matrix} ]$$

When AlN serves as the piezoelectric film, and when the electric flux density Dᵢ is set to 0 in equations (4a) and (4b), the electric fields Eₓ, E_{y}, E_{z} corresponding to the stress T response are as follows:

$$\begin{matrix}Equation 3 & \\ & ( 4 c )\end{matrix}$$

$$[ \begin{matrix}Ex \\ Ey \\ Ez\end{matrix} ] = 1 \text{?} [ \begin{matrix}0 & 0 & 0 & 0 & 0.56 & 0 \\ 0 & 0 & 0 & 0.56 & 0 & 0 \\ 0.61 & 0.61 & - 1.64 & 0 & 0 & 0\end{matrix} ] [ \text{} \begin{matrix}Sxx \\ Syy \\ Szz \\ Syz \\ Szx \\ Sxy\end{matrix} ] = [ \begin{matrix}0 & 0 & 0 & 0 & 0.047 & 0 \\ 0 & 0 & 0 & 0.047 & 0 & 0 \\ 0.025 & 0.025 & - 0.052 & 0 & 0 & 0\end{matrix} ] [ \begin{matrix}Txx \\ Tyy \\ Tzz \\ Tyz \\ Tzx \\ Txy\end{matrix} ]$$

$$\text{?} \text{indicates text missing or illegible when filed}$$

The piezoelectric electromotive force can be calculated from the electric fields Eₓ, E_{y}, and E_{z}. PZT is categorized into various commercialized materials based on its composition, such as PZT-4, PZT-5, PZT-5A, PZT-5H, PZT-8, etc. Among them, as a soft PZT with a large piezoelectric constant, we focus on PZT-5H, which is commonly used in receiving probes, etc. The e-form linear piezoelectric basic equation (3a) of PZT-5H can be expressed as:

$$\begin{matrix}Equation 4 & \\ & ( 5 a )\end{matrix}$$

$$[ \begin{matrix}Dx \\ Dy \\ Dz\end{matrix} ] = [ \begin{matrix}0 & 0 & 0 & 0 & 17. & 0 \\ 0 & 0 & 0 & 17. & 0 & 0 \\ - 6.5 & - 6.5 & 23.3 & 0 & 0 & 0\end{matrix} ] [ \text{} \begin{matrix}Sxx \\ Syy \\ Szz \\ Syz \\ Szx \\ Sxy\end{matrix} ] + 8.85 [ \begin{matrix}1700 & 0 & 0 \\ 0 & 1700 & 0 \\ 0 & 0 & 1470\end{matrix} ] [ \begin{matrix}Ex \\ Ey \\ Ez\end{matrix} ]$$

The second term on the right side of equation (3b) is omitted. Furthermore, under the condition of electric flux density Dₓ=D_{y}=D_{z}=0 (open circuit) at the end face of the piezoelectric film, the linear piezoelectric basic equation (3b) for PZT-5H as a piezoelectric film can be simplified to:

$$\begin{matrix}Equation 5 & \\ & ( 5 b )\end{matrix}$$

$$[ \begin{matrix}Txx \\ Tyy \\ Tzz \\ Tyz \\ Tzx \\ Txy\end{matrix} ] = 1 \text{?} [ \begin{matrix}13.05 & 8.35 & 7.31 & 0 & 0 & 0 \\ 8.35 & 13.05 & 7.31 & 0 & 0 & 0 \\ 7.31 & 7.31 & 15.91 & 0 & 0 & 0 \\ 0 & 0 & 0 & 4.22 & 0 & 0 \\ 0 & 0 & 0 & 0 & 4.22 & 0 \\ 0 & 0 & 0 & 0 & 0 & 2.35\end{matrix} ] [ \text{} \begin{matrix}Sxx \\ Syy \\ Szz \\ Syz \\ Szx \\ Sxy\end{matrix} ]$$

$$\text{?} \text{indicates text missing or illegible when filed}$$

When PZT-5H is used as the piezoelectric film, and the electric flux density Dᵢ is set to 0 in equations (4a) and (4b), the electric fields Eₓ, E_{y}, E_{z} corresponding to the stress T_{α} response are as follows:

$$\begin{matrix}Equation 6 & \\ & ( 5 c )\end{matrix}$$

$$[ \begin{matrix}Ex \\ Ey \\ Ez\end{matrix} ] = 1 \text{?} [ \begin{matrix}0 & 0 & 0 & 0 & - 1.13 & 0 \\ 0 & 0 & 0 & - \text{?} 3 & 0 & 0 \\ 0.5 & 0 \text{?} 50 & - 1.79 & 0 & 0 & 0\end{matrix} ] [ \text{} \begin{matrix}Sxx \\ Syy \\ Szz \\ Syz \\ Szx \\ Sxy\end{matrix} ] = [ \begin{matrix}0 & 0 & 0 & 0 & - 0 \text{?} 027 & 0 \\ 0 & 0 & 0 & - 0.027 & 0 & 0 \\ 0.009 & 0 \text{?} 009 & - 0 \text{?} 020 & 0 & 0 & 0\end{matrix} ] [ \begin{matrix}Txx \\ Tyy \\ Tzz \\ Tyz \\ Tzx \\ Txy\end{matrix} ]$$

$$\text{?} \text{indicates text missing or illegible when filed}$$

The piezoelectric electromotive force can be calculated from the electric fields Eₓ, E_{y}, E_{z} in equation (5c). However, by comparing equations (4c) and (5c), it can be determined that when the electric flux density Dᵢ is equal to zero, there is almost no significant difference in the piezoelectric electromotive force corresponding to the stress response between the pyroelectric material AlN and the ferroelectric material PZT-5H.

As shown in Equation (6) below, dielectrics include piezoelectric materials, piezoelectric materials include pyroelectric materials (polar crystals), and pyroelectric materials include ferroelectric materials. For the vibrator 22a1 of the voltage generating section (22a1, 24a) of the acoustic element according to the first embodiment, as long as it has a continuous structure as a stress field, the material constituting at least a part of the stress concentration region of the vibrator 22a1 is a piezoelectric material, and the remaining part can be a non-piezoelectric material.

$$Dielectric ∋ Piezoelectric ∋ Pyroelectric ( polar crystal ) ∋ Ferroelectric \qquad ( 6 )$$

Crystals are categorized into 32 crystal groups based on the symmetry of their crystal structures, among which 21 lack symmetry. One of these crystal point groups (cubic point group 0-432) lacks piezoelectricity due to another type of symmetry, but the remaining 20 crystal point groups exhibit piezoelectricity. Among piezoelectric materials as a subset of dielectrics, notable piezoelectric materials include quartz (SiO₂), lanthanum gallium silicate (La₃Ga₅SiO₁₄), and gallium phosphate (GaPO₄). Additionally, although also dependent on crystallinity, materials such as alumina (Al₂O₃) in the corundum-type oxide, titanium dioxide (TiO₂) in the rutile-type oxide, magnesium oxide (MgO) in the rock salt-type oxide, hafnium oxide (HfO₂) in the fluorite-type oxide, and zirconium oxide (ZrO₂) can be used as materials constituting at least a portion of the vibrating body 22a1, specifically as materials for stress concentration areas of the vibrating body 22a1.

That is, as shown in FIG. 2, the entire structure of the vibrating body 22a1 can be composed entirely of piezoelectric materials belonging to 20 crystal point groups, or only the downward protrusion (stress concentration site) in the center can be composed of piezoelectric materials belonging to 20 crystal point groups, while the remaining plate-like portions can be composed of non-piezoelectric layers belonging to the remaining 12 crystal point groups among the 32 types. That is, as long as it has a continuous structure as a stress field, the voltage generating part (22a1, 24a) can be configured such that at least the piezoelectric layer is provided in the stress concentration site of the stress field formed by the vibrating body 22a1. Therefore, the impedance conversion elements (14, 15a, 15b) of the acoustic element according to the first embodiment can at least use a specific part of the piezoelectric layer provided in the downward protrusion (stress concentration site) as a potential transfer region, and operate with the potential of this potential transfer region as a control voltage.

Ternary compounds such as hafnium aluminate (HfAlOₓ) and hafnium silicate (HfSiₓO_{y}) can also be used as materials for at least the stress concentration site of the vibrating body 22a1. That is, oxides containing any of strontium (Sr), aluminum (Al), magnesium (Mg), yttrium (Y), hafnium (Hf), zirconium (Zr), tantalum (Ta), and bismuth (Bi), or silicon nitrides containing these elements, can be used as materials for at least the stress concentration site of the vibrating body 22a1. Semiconductors with a zincblende structure, such as gallium arsenide (GaAs), gallium phosphide (GaP), zinc sulfide (ZnS), zinc telluride (ZnTe), zinc selenide (ZnSe), and cadmium telluride (CdTe), as well as wurtzite-type semiconductors such as AlN, GaN, CdS, ZnO, and cadmium selenide (CdSe), also exhibit piezoelectricity and can therefore be used as materials for at least the stress concentration site of the vibrating body 22a1. On the other hand, single-element semiconductors with a diamond structure (point symmetry group Oₕ=m3m), such as silicon (Si), germanium (Ge), and diamond (C), cannot exhibit piezoelectricity and therefore cannot be used as materials for the stress concentration site of the vibrating body 22a1, but can be used as materials for the remaining plate-like portions outside the stress concentration site.

Pyroelectric materials, as shown in formula (6), are a subset of piezoelectric materials. In piezoelectric materials, pyroelectricity often occurs when the material is polarized and the temperature changes. Among the 20 crystal groups with piezoelectricity, 10 crystal point groups exhibit pyroelectricity, also known as “polar crystals”. Specifically, according to the Scherzky notation, the crystal point groups of triclinic C₁, monoclinic C_{S}, C₂, orthorhombic C₂V, tetragonal C₄, C₄V, trigonal C₃, C₃V, hexagonal C₆, and C₆V exhibit pyroelectricity. The crystal point group of wurtzite structure is hexagonal C₆V. Pyroelectric semiconductors such as AlN, GaN, ZnO, and CdS are wurtzite-type compounds. Hexagonal silicon carbide (SiC) is also a pyroelectric material. AlN and GaN exhibit piezoelectricity in specific directions of the crystal, but the crystal structure slightly changes when Sc is added, making ions easier to move in that direction, thus improving piezoelectricity. For example, the piezoelectricity of ScₓAl₁₋ₓN increases with the increase of Sc concentration x, and when x is around 43%, it exhibits very large piezoelectricity comparable to that of LiTaO₃. Tourmaline ((Ca,Na)X₃Al₆(BO₃)₃Si₆O₁₈(OH,F)4; X=Mg, Fe, Mn, Li, Al) also exhibits pyroelectricity.

Ferroelectrics, as shown in formula (6), are a subset of pyroelectric materials, and those pyroelectric materials whose spontaneous polarization direction changes when an external electric field is applied are ferroelectrics. Piezoelectric and pyroelectric materials are supported by the symmetry of their crystal structures, but the definition of the symmetry of the crystal structure of ferroelectrics is ambiguous. In addition to PZT, ferroelectrics also include perovskite-type oxides such as HfO₂, hafnium zirconium oxide (Hf₁₋ₓZrₓO₂), barium titanate (BaTiO₃), strontium titanate (SrTiO₃), magnesium titanate (MgTiO₃), calcium titanate (CaTiO₃), bismuth titanate (Bi₃Ti₃O₁₂), lead titanate (PbTiO₃), lead zirconate (PbZrO₃), barium strontium titanate (BaSrTiO₃), strontium ruthenate (SrRuO₃), strontium bismuth tantalum titanate (SrBi₂Ta₂O₉), bismuth layered structure ferroelectrics (BLSF), polyvinylidene fluoride (PVDF), and rochelle salt (NaKC₄H₃O₆·4H₂O).

### Research on Stress Distribution and Structural Reinforcement

In existing PMUT technologies such as the disclosure described in Non-patent Document 2, no research has been conducted on new internal structures and geometries for achieving high sensitivity and broadband performance of PMUTs themselves. The acoustic element according to the first embodiment is designed by considering the structure of the voltage generating sections (22a1, 24a) that exhibit a non-uniform potential distribution with different potentials at positions on the output surface side of the vibrating body 22a1, thereby achieving high sensitivity and broadband performance. For example, considering the non-uniform potential distribution, it is possible to adopt a composite structure in which a piezoelectric layer is only arranged at stress concentration sites to achieve high sensitivity and broadband performance. As shown in equations (2a) to (5c), in order to generate a position-dependent potential distribution, it is preferable to adopt a “stress distribution reinforcement structure” that generates a non-uniform potential distribution inside the vibrating body 22a1.

Although it has been explained using FIGS. 31A-31B, even in the case of using a previously known flat disk-type vibrating cavity, when the vibrating body 22f bends upward to form an upward convex surface, and bends downward to form a downward convex surface, the spacing between circles is different, resulting in asymmetric vibrations. As for which piezoelectric layer and shape of vibrating cavity are more ideal for generating a stress distribution reinforcement structure that relies on position-dependent potential distribution, simulations were conducted using the “Piezoelectric Wave Analysis Software PZFlex” originally developed by Weidlinger Associates in the United States. By simulating the transient response of voltage generation in various stress distribution reinforcement structures, we explored which structure can serve as a new structure that achieves high sensitivity and broadband through piezoelectric effect. Then, specific candidate locations were selected as potential transfer areas, and specific locations with higher voltage generation were explored microscopically in various stress distribution reinforcement structures, so that at least in this potential transfer area, a piezoelectric layer can be configured.

### Parallel Truss Type

Firstly, we simulated the voltage generation at various positions in the stress distribution reinforcement structure with a parallel truss-type vibration cavity 21a1 around the central protrusion as shown in FIG. 4A, and studied the voltage distribution on the output surface, serving as the basis for high sensitivity and broadband performance. “Parallel truss-type” refers to a three-dimensional structure where the main surfaces (upper and lower) corresponding to the space constituting the truss are parallel to each other. The parallel truss-type vibration cavity 21a1 is based on a structure where a vibration body 22a1 with a cylindrical downward protrusion at the central part of the output surface (lower surface) is inserted into a silicon substrate 11ₛₐ₁ with a cylindrical recess of approximately d₁₁ (=2r₁₁) in diameter. On the cross-section, the rectangular space surrounding the downward protrusion constitutes a continuous parallel truss in the depth direction of the paper. As shown in the plan views of FIG. 1A and FIG. 1B, the acoustic element according to the first embodiment is a parallel truss-type vibration cavity 21a1 with a hexagonal planar pattern. The structure shown in FIG. 1A and other FIGS. is a structure where a vibration body 22a1 with a regular hexagonal prism protrusion is inserted into the central part of the vibration cavity 21a1, which is different from the axisymmetric three-dimensional shape used for simplification in the simulation in terms of geometric planar pattern. However, whether the planar pattern is circular or hexagonal does not have a significant impact on the simulation results of voltage distribution generated by piezoelectric effect in principle.

Let t₂₂ₐ₁ be the thickness of the flat plate-shaped portion of the vibrating body 22a1 excluding the central protrusion, and d₂₂ₐ₁ be the diameter of the central protrusion. A fixed potential electrode 24a at ground potential is arranged on the top surface of the vibrating body 22a1. A fixed potential electrode protective film 23 made of epoxy resin, which functions as a matching layer, is arranged with a thickness t₂₃ on the fixed potential electrode 24a and on the vibrating body 22a1 where the fixed potential electrode 24a is not present. In the simulation, to verify the voltage distribution generated below the vibrating body 22a1 due to the piezoelectric effect, as shown in FIG. 4B, five ideal electrodes for potential detection (represented by diagonal rectangles in FIG. 4B, but with a thickness of zero) are arranged. Then, according to the arrangement of the five ideal electrodes for potential detection shown in Table 1, the individual names of the potential transfer areas are defined as the central area P₀, the first peripheral area P₁, . . . , and the fourth peripheral area P₄, numbered sequentially from the inside along the direction of the division reference radius r₁₁=(d₁₁−d₂₂ₐ₁)/2 (outward).

TABLE 1
Table 1 (Definition of The Case of FIG. 4B)

| The Individual | The Position in The Radial | | |
|---|---|---|---|
| Names of Potential | Direction Inside The Cavity | The Individual Names of | The Types of Lines |
| Transfer Zones | (d₁₁ − d₂₂ₐ₁ = 2r₁₁) | The Generated Voltages | on The Drawing |
| The Central Region P₀ | d₂₂ₐ₁/2~(1/9)r₁₁ + d₂₂ₐ₁/2 | The Central Voltage V_{P0} | Thick Solid Line |
| The First Peripheral | (2/9)r₁₁ + d₂₂ₐ₁/2~(3/9)r₁₁ + d₂₂ₐ₁/2 | The First Peripheral | Thick Dashed Line |
| Region P₁ | | Voltage V_{P1} | |
| The Second Peripheral | (4/9)r₁₁ + d₂₂ₐ₁/2~(5/9)r₁₁ + d₂₂ₐ₁/2 | The Second Peripheral | Thin Dashed Line |
| Region P₂ | | Voltage V_{P2} | |
| The Third Peripheral | (6/9)r₁₁ + d₂₂ₐ₁/2~(7/9)r₁₁ + d₂₂ₐ₁/2 | The Third Peripheral | Thin Solid Line |
| Region P₃ | | Voltage V_{P3} | |
| The Fourth Peripheral | (8/9)r₁₁ + d₂₂ₐ₁/2~r₁₁ | The Fourth Peripheral | Dashed-Dotted Line |
| Region P₄ | | Voltage V_{P4} | |

The line width and spacing along the radial direction outside the central region P₀ are the same, and the four concentric circular zones (regions) surrounded by the same spacing are the first peripheral region P₁, the second peripheral region P₂, the third peripheral region P₃, and the fourth peripheral region P₄. Due to the same line width and spacing, the division reference radius r₁₁ of the vibration cavity 21a1 is defined as (d₁₁−d₂₂ₐ₁)/2, which is divided into nine equal parts, thus defining the positions of the central region P₀, the first peripheral region P₁, . . . , and the fourth peripheral region P₄ along the radial direction. That is, as shown in FIG. 4B, the ideal electrode for potential detection in the central region P₀ is a circular region surrounding the central downward protrusion. Therefore, with the radius of the central downward protrusion being d₂₂ₐ₁/2, the central region P₀ is defined as a circular region (region) with a certain line width from the radial position d₂₂ₐ₁/2 to the radial position (1/9)r₁₁+d₂₂ₐ₁/2.

Similarly, as defined in Table 1, the first peripheral region P₁ is defined as a ring-shaped region with a certain line width extending from the radius position (2/9)r₁₁+d₂₂ₐ₁/2 to the radius position (3/9)r₁₁+d₂₂ₐ₁/2. The second peripheral region P₂ is defined as a ring-shaped region with a certain line width extending from the radius position (4/9)r₁₁+d₂₂ₐ₁/2 to the radius position (5/9)r₁₁+d₂₂ₐ₁/2. The third peripheral region P₃ is defined as a ring-shaped region with a certain line width extending from the radius position (6/9)r₁₁+d₂₂ₐ₁/2 to the radius position (7/9)r₁₁+d₂₂ₐ₁/2. The fourth peripheral region P₄ is defined as the region extending from the radius position (8/9)r₁₁+d₂₂ₐ₁/2 to the outermost circumference (radius position r₁₁).

In the simulation, the five ideal electrodes for potential detection, respectively configured in the central region P₀, the first peripheral region P₁, . . . , and the fourth peripheral region P₄, are all virtual electrodes that are electrically open-circuited (open), have a thickness of zero, and have a contact resistance of zero with the vibrating body 22a1. In the central region P₀, the first peripheral region P₁, . . . , and the fourth peripheral region P₄, which serve as open-state potential transmission areas, the transient response of the generated voltage due to the piezoelectric effect is verified, and the voltage distribution on the output surface of the vibrating body 22a1 is studied. On the output surface of the vibrating body 22a1, the radial electric field inside the ideal electrodes for potential detection in each of the central region P₀, the first peripheral region P₁, . . . , and the fourth peripheral region P₄ is short-circuited. Additionally, in FIG. 4B, the outer circumference of the ideal electrode for potential detection in the fourth peripheral region P₄ is in contact with the silicon substrate ₁₁ₛₐ₁, but the silicon substrate ₁₁ₛₐ₁ is semi-insulating (high resistivity). In the simulation, it is assumed that the ideal electrode for potential detection in the fourth peripheral region P₄ is in an electrically floating state.

FIG. 4C illustrates the transient response of voltage generation during ultrasonic wave reception, using parameters such as the central region P₀, the first peripheral region P₁, . . . , and the fourth peripheral region P₄. This simulation is conducted under the conditions where AlN is used throughout the entire vibrator 22a1, and the diameter d₂₂ₐ₁ of the central protrusion in the parallel truss-type vibrational cavity 21a1 of the voltage generating section (22a1, 24a) is set to 1.2 μm. Additionally, the thickness t₂₂ₐ₁ of the vibrator 22a1 outside the central protrusion is set to 1.2 μm, and the thickness t₂₃ of the fixed potential electrode protective film 23 is set to 3 μm. As shown in the legend of the line types in the upper right corner of FIG. 4C, the thick solid line represents the transient response of the central voltage V_{P0} generated in the central region P₀. In FIG. 4C, the thick dashed line represents the first peripheral voltage V_{P1} generated in the first peripheral region P₁, the thin dashed line represents the second peripheral voltage V_{P2} generated in the second peripheral region P₂, the thin solid line represents the third peripheral voltage V_{P3} generated in the third peripheral region P₃, and the dashed-dotted line represents the fourth peripheral voltage V_{4P} generated in the fourth peripheral region P₄. When a single-emission sine wave ultrasonic wave with a maximum vibration amplitude of ±1 Pa is input to the voltage generating section (22a1, 24a), the pulse response voltage signals generated by the piezoelectric effect in the central region P₀, the first peripheral region P₁, . . . , and the fourth peripheral region P₄ exhibit a transient response where the second vibration amplitude is the largest near approximately 0.13 μs, and subsequent vibrations are attenuated.

Specifically, in the case where the fixed potential electrode 24a shown in FIGS. 4A and 4B is connected to the ground potential (GND), as shown in FIG. 4C, a transient response exhibiting positive and negative directional vibrations centered around the ground potential (GND=0V) is observed. The central voltage V_{P0} indicated by the thick solid line in FIG. 4C reaches a peak amplitude of approximately +0.34 μV for the first vibration near a time point of approximately 0.06 μs after the input of the ultrasonic pulse, while the peak amplitude for the second vibration near a time point of approximately 0.13 μs reaches approximately −0.52 μV, reaching the maximum amplitude value. Subsequently, the peak amplitude for the third vibration near a time point of approximately 0.19 μs reaches approximately +0.25 μV, and the peak amplitude for the fourth vibration near a time point of approximately 0.26 μs decays to approximately −0.13 μV Unlike FIG. 4B, if the ideal electrode for detecting the potential of the central region P₀ is arranged in an island shape at the lower end of the central downward protrusion (only regarding the position definition, corresponding to the case where the diameter of the central protrusion remains unchanged in Table 1 and d₂₂ₐ₁/2=0), the central voltage V_{P0} increases to approximately twice the value shown in FIG. 4C (the illustration is omitted). This can be considered as a result of the mutual enhancement of the piezoelectric electromotive force generated by the lateral compression and stretching of the film near the central downward protrusion of the vibrating body 22a1 and the piezoelectric electromotive force generated by the longitudinal compression and stretching along the central downward protrusion.

The second peripheral voltage V_{P2}, represented by the thin dashed line in FIG. 4C, reaches its peak amplitude of approximately −0.26 μV during the first vibration near the time point after approximately 0.06 μs of ultrasonic pulse input, while the peak amplitude of the second vibration near the time point after approximately 0.13 μs is approximately +0.38 μV, reaching the maximum amplitude value. However, the absolute value of the amplitude of the second peripheral voltage V_{P2}, |V_{P2}|, is less than the absolute value of the amplitude of the central voltage V_{P0}, |V_{P0}|, and the central voltage V_{P0} and the second peripheral voltage V_{P2} exhibit an inverse correlation. Subsequently, the third vibration amplitude of the second peripheral voltage V_{P2}, which generates voltage in the second peripheral region _{P2} and reaches its peak near the time point after approximately 0.19 μs, is approximately −0.18 μV, and the fourth vibration amplitude, which reaches its peak near the time point after approximately 0.26 μs, decays to approximately +0.09 μV Due to the decreasing peak amplitude of vibrations after the fifth time, further explanations are omitted.

In FIG. 4C, the fourth peripheral voltage V_{P4}, represented by a dashed-dotted line, reaches its peak amplitude of approximately +0.25 μV during its first oscillation near a time of approximately 0.06 μs. Meanwhile, the amplitude of its second oscillation, which peaks near a time of approximately 0.13 μs, is approximately −0.32 μV, reaching its maximum amplitude. The absolute value of the amplitude of the fourth peripheral voltage V_{P4}, denoted as |V_{P4}|, is smaller than the absolute values of the central voltage V_{P0} and the second peripheral voltage V_{P2}, denoted as |V_{P0}| and |V_{P2}|, respectively, making it the third largest value. The fourth peripheral voltage V_{P4} exhibits an inverse correlation with the second peripheral voltage V_{P2} and a positive correlation with the central voltage V_{P0}. Subsequently, the third oscillation of the fourth peripheral voltage V_{P4}, which peaks near a time of approximately 0.19 μs, has an amplitude of approximately +0.17 μV. The fourth oscillation, which peaks near a time of approximately 0.26 μs, attenuates to an amplitude of approximately −0.08 μV.

In FIG. 4C, the absolute value |V_{P1}| of the amplitude exhibited by the transient response vibration of the first peripheral voltage V_{P1}, represented by the thick dashed line, is smaller than the absolute value |V_{P4}| of the fourth peripheral voltage V_{P4}, ranking as the fourth largest value. The first peripheral voltage V_{P1} vibrates in phase with the second peripheral voltage V_{P2}, and in anti-phase with the central voltage V_{P0} and the fourth peripheral voltage V_{P4}. The absolute value |V_{P3}| of the amplitude exhibited by the transient response vibration of the third peripheral voltage V_{P3}, represented by the thin solid line in FIG. 4C, is smaller than the absolute value |V_{P1}| of the first peripheral voltage V_{P1}, ranking as the fifth largest value and also the smallest value. The third peripheral voltage V_{P3} vibrates in phase with the first peripheral voltage V_{P1} and the second peripheral voltage V_{P2}, and in anti-phase with the central voltage V_{P0} and the fourth peripheral voltage V_{P4}.

That is, on the output surface of the vibrator 22a1 in the voltage generation section (22a1, 24a) shown in FIGS. 4A and 4B, the potential relationship generated by the piezoelectric effect is:

$$\vert {V}_{P 0} \vert > \vert {V}_{P 2} \vert > \vert {V}_{P 4} \vert > \vert {V}_{P 1} \vert > \vert {V}_{P 3} \vert , \qquad ( 7 )$$

exhibiting a non-uniform potential distribution that varies with position. FIG. 4C illustrates the relationship between the generated voltages when the first power source shown in FIG. 1A is connected to the ground potential (GND), namely, the central voltage V_{P0}, the first peripheral voltage V_{P1}, the second peripheral voltage V_{P2}, the third peripheral voltage V_{P3}, and the fourth peripheral voltage V_{P4}. Unlike the circuit connection shown in FIG. 1A, if the first power source is connected to a bias voltage V_{bias}>0, the central voltage V_{P0}, the first peripheral voltage V_{P1}, . . . , and the fourth peripheral voltage V_{P4} generated by the voltage generation section (22a1, 24a) will form a vibration waveform that oscillates around the bias Voltage Vbias, which is different from 0V. That is, by selecting V_{bias} with the highest amplification factor of the impedance conversion elements (14, 15a, 15b) and connecting the first power source to V_{bias}, the sensitivity of the acoustic element according to the first embodiment can be improved.

FIG. 4D, similar to FIG. 4C, depicts the transient response of voltage generated during ultrasonic reception when using AlN for the vibrator 22a1 in the voltage generation sections (22a1, 24a) of FIGS. 4A and 4B. In this case, the diameter d₂₂ₐ₁ of the central protrusion in the parallel truss-type vibrational cavity 21a1 of the voltage generation sections (22a1, 24a) is set to 2.0 μm, which is larger than that in FIG. 4C. The positions of the central region P₀, the first peripheral region P₁, . . . , and the fourth peripheral region P₄, which are defined in FIG. 4B, are used as parameters for the simulation. The positions of the central region P₀, the first peripheral region P₁, . . . , and the fourth peripheral region P₄ in the potential transfer area are shown in Table 1. The thickness t₂₂ₐ₁ of the vibrator 22a1 excluding the central protrusion is set to 1 μm, which is thicker than that in FIG. 4C. The thickness t₂₃ of the fixed potential electrode protective film 23 is set to 3 μm, which is the same as in FIG. 4C.

The central voltage V_{P0} of the vibrator 22a1, represented by the thick solid line in FIG. 4D, reaches its peak near the time point after approximately 0.03 μs following the input of the ultrasonic pulse, with a first vibration amplitude of approximately +0.14 μV Subsequently, it reaches its peak near the time point after approximately 0.13 μs, with a second vibration amplitude of approximately −0.24 μV, reaching its maximum amplitude value. In the case of FIG. 4C, the first vibration amplitude of the central voltage V_{P0} near the time point after approximately 0.06 μs following the input of the ultrasonic pulse is approximately +0.34 μV, and the second vibration amplitude near the time point after approximately 0.13 μs is approximately 0.52 μV Therefore, the vibration amplitude of the central voltage V_{P0} shown in FIG. 4D is smaller than that in FIG. 4C. Moreover, the first vibration, which reaches its peak near the time point after approximately 0.03 μs following the pulse input, exhibits a gradually decaying waveform distortion around 0.06 μs, rather than a single sine wave waveform, which is different from the sine wave vibration with a peak at 0.06 μs in FIG. 4C. The third vibration amplitude of the central voltage V_{P0}, which reaches its peak near the time point after approximately 0.19 μs, is approximately +0.15 μV, and the fourth vibration amplitude, which reaches its peak near the time point after approximately 0.26 μs, decays to approximately −0.06 μV Waveform distortion was also observed in the third and fourth vibrations.

Additionally, although not shown in the diagram, if the ideal electrode for detecting the potential of the central region P₀ is arranged in an island shape at the lower end of the central downward protrusion (focusing only on the position definition, corresponding to the case where the protrusion diameter remains unchanged in Table 1 and d₂₂ₐ₁/2=0), the central voltage V_{P0} increases to about twice the value shown in FIG. 4D, which is the same as the case in FIG. 4C. This can be attributed to the mutual enhancement of piezoelectric electromotive force generated by lateral compression and stretching of the film near the central downward protrusion of the vibrating body 22a1, and piezoelectric electromotive force generated by longitudinal compression and stretching along the central downward protrusion (the increase in longitudinal piezoelectric effect of the central protrusion will be explained later using FIG. 4E and FIG. 4F).

The second peripheral voltage V_{P2}, represented by the thin dashed line in FIG. 4D, reaches its peak amplitude of approximately −0.14 μV during the first vibration near the time point after approximately 0.06 μs of ultrasonic pulse input, while the peak amplitude of the second vibration near the time point after approximately 0.13 μs is approximately +0.24 μV, reaching the maximum amplitude value. As shown in FIG. 4D, the central voltage V_{P0} and the second peripheral voltage V_{P2} exhibit an inverse correlation, but the absolute value |V_{P2}| of the second peripheral voltage V_{P2} is roughly the same as the absolute value |V_{P0}| of the central voltage V_{P0}. Subsequently, the third vibration amplitude of the second peripheral voltage V_{P2}, which reaches its peak near the time point after approximately 0.19 μs, is approximately −0.14 μV, and the fourth vibration amplitude, which reaches its peak near the time point after approximately 0.26 μs, decays to approximately +0.06 μV.

In FIG. 4D, the fourth peripheral voltage V_{P4}, represented by a dashed-dotted line near the outer wall (side wall) of the vibrating cavity 21a1 and located furthest from the central protrusion, reaches its peak near the first vibration amplitude of approximately +0.15 μV after approximately 0.06 μs. This amplitude is slightly larger than the first vibration amplitude of the central voltage V_{P0}, which is +0.14 μV Relative to the first vibration amplitude, the second vibration amplitude, which peaks near the time of approximately 0.13 μs, is approximately −0.24 μV, reaching its maximum amplitude, which is roughly the same as the second vibration amplitude of the central voltage V_{P0}. Therefore, the absolute value of the amplitude of the fourth peripheral voltage V_{P4}, |V_{P4}|, is roughly the same as the absolute value of the central voltage V_{P0}, |V_{P0}|, and the absolute value of the second peripheral voltage V_{P2}, |V_{P2}|. The fourth peripheral voltage V_{P4} and the second peripheral voltage V_{P2} exhibit an inverse correlation, while they exhibit a positive correlation with the central voltage V_{P0}. Subsequently, the third vibration amplitude of the fourth peripheral voltage V_{P4}, which peaks near the time of approximately 0.19 μs, is approximately +0.13 μV, slightly smaller than that of the central voltage V_{P0}. The fourth vibration amplitude, which peaks near the time of approximately 0.26 μs, decays to approximately −0.06 μV.

The transient response of the first peripheral voltage V_{P1}, represented by the thick dashed line in FIG. 4D, vibrates positively to approximately +0.05 μV near the time point after approximately 0.03 μs following the input of the ultrasonic pulse, serving as the first vibration peak. Subsequently, it vibrates negatively to approximately −0.03 μV near the time point after approximately 0.06 μs, serving as the second vibration peak. The first peripheral voltage V_{P1} exhibits a unique vibration waveform that is different from the central voltage V_{P0}, the second peripheral voltage V_{P2}, and the fourth peripheral voltage V_{P4}. Moreover, the transient response behavior of the first peripheral voltage V_{P1} is also different from that shown in FIG. 4C. The transient response behavior of the first peripheral voltage V_{P1} in FIG. 4D is similar to that shown in FIG. 4C in that it increases to approximately +0.07 μV near the time point of approximately 0.06 μs, but differs in that it is the third vibration peak in FIG. 4D, whereas it is the second vibration peak in FIG. 4C. The absolute value of the amplitude |V_{P1}| exhibited by the transient response vibration of the first peripheral voltage V_{P1} is the fourth smallest value among the absolute values |V_{P0}|, |V_{P2}|, and |V_{P4}| of the central voltage V_{P0}, the second peripheral voltage V_{P2}, and the fourth peripheral voltage V_{P4}. Except for the first vibration peak near the time point of approximately 0.03 μs, the first peripheral voltage V_{P1} vibrates in phase with the second peripheral voltage V_{P2}. Except for the first vibration peak, the first peripheral voltage V_{P1} vibrates in antiphase with the central voltage V_{P0} and the fourth peripheral voltage V_{P4}. Additionally, in FIG. 4D, the absolute value of the amplitude exhibited by the transient response vibration of the third peripheral voltage V_{P3}, represented by the thin solid line, is smaller than that of the first peripheral voltage V_{P1}, ranking fifth and being the smallest value. The third peripheral voltage V_{P3} vibrates in anti-phase with the first peripheral region P₁, the first peripheral voltage V_{P1}, and the second peripheral voltage V_{P2}, which is different from the transient response shown in FIG. 4C. Similarly, the third peripheral voltage V_{P3} vibrates in phase with the central voltage V_{P0} and the fourth peripheral voltage V_{P4}, which is also different from the transient response shown in FIG. 4C. That is, when the diameter

d₂₂ₐ₁ of the protrusion in the central part of the vibration cavity 21a1 is larger than that in FIG. 4C, and the thickness t₂₂ₐ₁ of the vibrating body 22a1 is thicker than that in FIG. 4C, the potential relationship generated by the
piezoelectric effect on the output surface of the vibrating body 22a1 is:

$$\vert {V}_{P 0} \vert \approx \vert {V}_{P 2} \vert \approx \vert {V}_{P 4} \vert \qquad ( 8 a )$$

$$\vert {V}_{P 0} \vert , \vert {V}_{P 2} \vert , \vert {V}_{P 4} \vert > \vert {V}_{P 1} \vert > \vert {V}_{P 3} \vert \qquad ( 8 b )$$

exhibiting a non-uniform potential distribution with position dependence.

FIG. 4E illustrates the sensitivity frequency dependence of the central voltage V_{P0} in the central region P₀, detected by an ideal electrode for potential detection positioned directly beneath the central protrusion, when the entire vibrating body 22a1 is made of PZT. The thickness t₂₂ₐ₁ of the flat plate-shaped portion of the vibrating body 22a1, excluding the central protrusion, is set to 2.4 μm. The diameter d₂₂ₐ₁ of the central protrusion shown in FIG. 4B is redefined as diameter D, and set to D=2.4 μm=t₂₂ₐ₁, indicating the frequency dependence of voltage sensitivity when varying the aspect ratio (=H/D) corresponding to the height H of the central protrusion. As shown in FIG. 4E, when the aspect ratio H/D=1, a sensitivity curve with a peak frequency of 7.3 MHz is exhibited within the 5-10 MHz frequency band range where ultrasonic waves are received. When the aspect ratio H/D=1, the maximum voltage sensitivity of the central voltage V_{P0} is approximately 26.4 μV/Pa. Compared to when the aspect ratio H/D=1, when the aspect ratio H/D=2, that is, the height increases, the peak frequency of the sensitivity curve shifts slightly towards the low-frequency side, and the relative bandwidth narrows. The maximum voltage sensitivity of the central voltage V_{P0} is approximately 47.7 μV/Pa, and the maximum voltage sensitivity increases by approximately 1.8 times, indicating an enhancement in longitudinal piezoelectric effect with an increase in aspect ratio H/D.

When the aspect ratio H/D is 3 and the height is further increased, the peak frequency of the sensitivity curve is 6.5 MHz, slightly shifted towards the lower frequency side compared to the aspect ratio H/D=2, with the bandwidth further slightly narrowed. The maximum voltage sensitivity of the central voltage V_{P0} is approximately 68.2 μV/Pa. At the aspect ratio H/D=3, the maximum voltage sensitivity increases to approximately 2.6 times that of the aspect ratio H/D=1, indicating an enhancement in longitudinal piezoelectric effect with an increase in aspect ratio H/D. Furthermore, when the aspect ratio H/D is 4 and the height is further increased, the peak frequency of the sensitivity curve is 6.3 MHz, slightly shifted towards the lower frequency side compared to the aspect ratio H/D=3, with the bandwidth further slightly narrowed. The maximum voltage sensitivity of the central voltage V_{P0} is approximately 85.5 μV/Pa. At the aspect ratio H/D=4, the maximum voltage sensitivity increases to approximately 3.2 times that of the aspect ratio H/D=1, indicating an enhancement in longitudinal piezoelectric effect with an increase in aspect ratio H/D. Furthermore, when the aspect ratio H/D is 8 and the height is further increased, the sensitivity curve shifts towards the lower frequency side compared to the aspect ratio H/D=4, with the bandwidth further slightly narrowed. The maximum voltage sensitivity of the central voltage V_{P0} is approximately 139.5 μV/Pa. At the aspect ratio H/D=8, the maximum voltage sensitivity increases to approximately 5.3 times that of the aspect ratio H/D=1, indicating an enhancement in longitudinal piezoelectric effect with an increase in aspect ratio H/D.

FIG. 4F, similar to FIG. 4E, illustrates the sensitivity frequency dependency of the central voltage V_{P0} detected directly beneath the central protrusion when the entire vibrating body 22a1 is made of PZT. In FIG. 4E, the frequency dependency of voltage sensitivity is shown when varying the aspect ratio (=H/D) of the central protrusion height H corresponding to a constant diameter D=2.4 μm. Conversely, FIG. 4F demonstrates the frequency dependency of voltage sensitivity when changing the diameter D=d₂₂ₐ₁ with a constant aspect ratio H/D=1. In FIG. 4F, the thickness t₂₂ₐ₁ of the flat plate-shaped portion of the vibrating body 22a1 outside the central protrusion is also maintained at 2.4 μm (constant). The sensitivity curve for a diameter d₂₂ₐ₁=2.4 μm in FIG. 4F is identical to the sensitivity curve for an aspect ratio H/D=1 in FIG. 4E, with a maximum voltage sensitivity of approximately 26.4 μV/Pa at the peak frequency of 7.3 MHz for the central voltage V_{P0}.

Compared to when the diameter d₂₂ₐ₁ is 2.4 μm, when the diameter d₂₂ₐ₁ is increased to 4.8 μm, resulting in a thicker central protrusion, the sensitivity curve shifts slightly towards the high-frequency side to a peak frequency of 7.8 MHz, and the bandwidth widens. At a diameter d₂₂ₐ₁ of 4.8 μm, the maximum voltage sensitivity of the central voltage V_{P0} is approximately 12.8 μV/Pa, which is reduced to about 0.48 times that at a diameter d₂₂ₐ₁ of 2.4 μm. It can be observed that the longitudinal piezoelectric effect decreases relatively with the increase in diameter d₂₂ₐ₁. Furthermore, when the diameter d₂₂ₐ₁ is increased to 7.2 μm, resulting in a thicker central protrusion, the peak frequency shifts to 8.6 MHz, and the sensitivity curve further shifts towards the higher-frequency side compared to when the diameter d₂₂ₐ₁ is 4.8 μm, with the bandwidth also slightly widening further. At a diameter d₂₂ₐ₁ of 7.2 μm, the maximum voltage sensitivity of the central voltage V_{P0} decreases to approximately 8.3 μV/Pa. Therefore, at a diameter d₂₂ₐ₁ of 7.2 μm, the maximum voltage sensitivity is about 0.31 times that at a diameter d₂₂ₐ₁ of 2.4 μm, indicating a relative decrease in the longitudinal piezoelectric effect with the increase in diameter d₂₂ₐ₁ of the central protrusion.

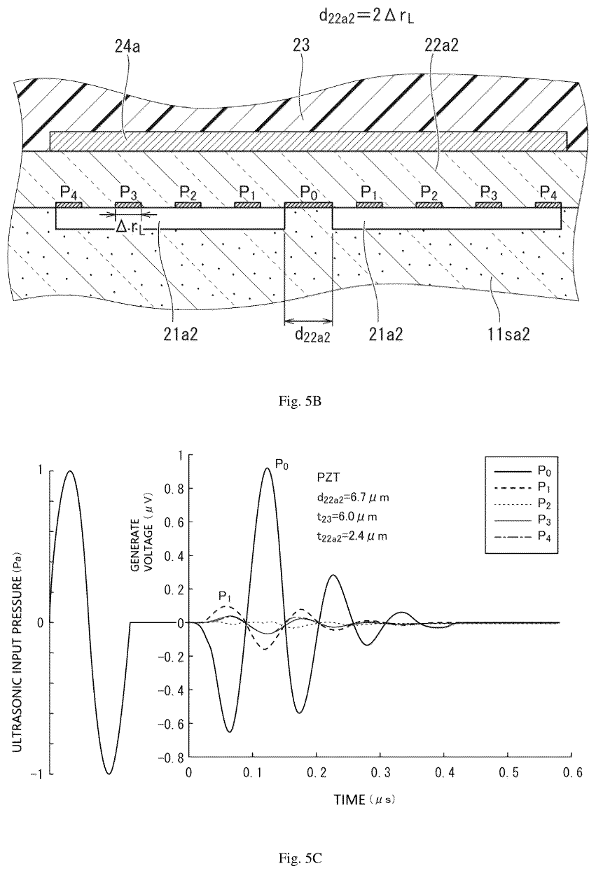

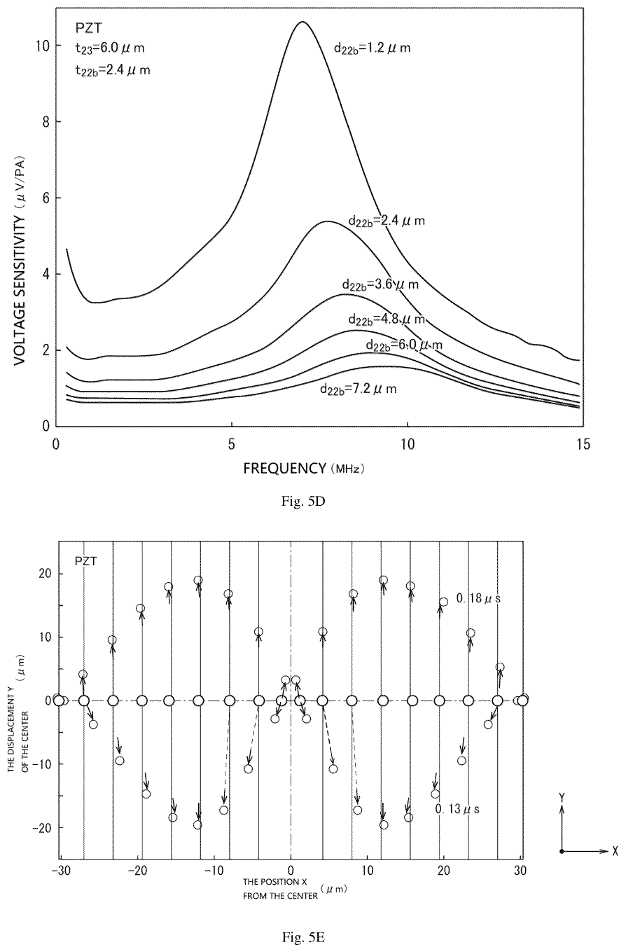

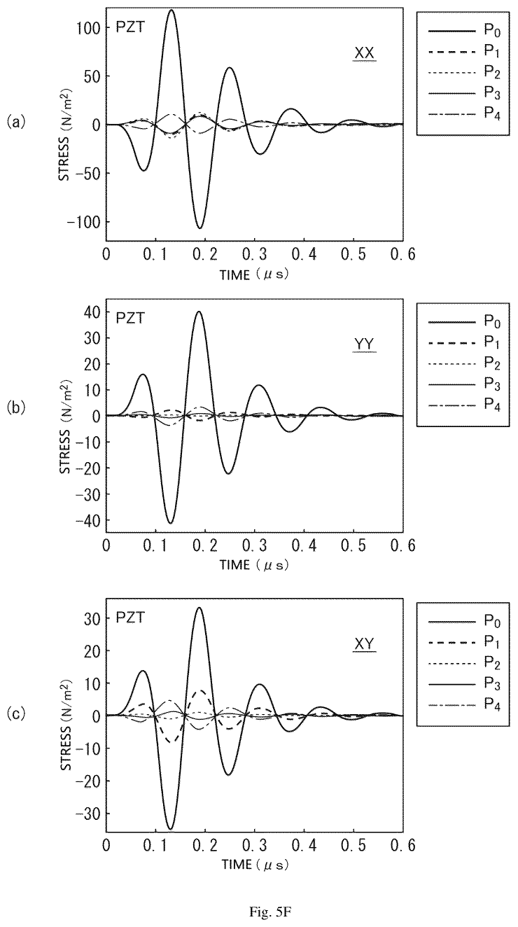

The stress distribution reinforcement structure of the parallel annular type can be constructed either with the downward protrusion on the output surface side of the vibrator as the center, or with the upward protrusion on the silicon substrate side as the center. Unlike FIG. 4A, as shown in FIG. 5A, the protrusion in the central part of the vibration cavity is the upward protrusion of a portion of the silicon substrate 11ₛₐ₂. The numerical simulation results are shown in FIGS. 5C and 5D. Due to the upward protrusion as a stepped structure in the central part of the silicon substrate 11ₛₐ₂ with a cylindrical recess, the vibrator 22a2 is inserted onto the silicon substrate 11ₛₐ₂, thereby forming a parallel annular type vibration cavity 21a2 around the upward protrusion in the central part made of silicon. A fixed potential electrode 24a connected to a ground potential is arranged on the upper surface of the vibrator 22a2. On the fixed potential electrode 24a and on the vibrator 22a2 without the fixed potential electrode 24a, a fixed potential electrode protective film 23 made of epoxy resin is arranged.

In the case of FIG. 5B, as shown in Table 2, for the positions P₀, P₁, . . . , P₄ numbered sequentially from the center along the radius r₁₁ (=d₁₁/2) direction (outward) according to the arrangement of five potential detection ideal electrodes, the individual names of the potential transfer areas are defined as the central area P₀, the first peripheral area P₁, . . . , the fourth peripheral area P₄. Unlike the definition in the case of FIG. 4B shown in Table 1, the potential detection ideal electrode in the central potential transfer area (central area) P₀ is a circular island-shaped area.

TABLE 2
Table 2 (General Definition)

| The Individual | The Position in The Radial | | |
|---|---|---|---|
| Names of Potential | Direction Inside The Cavity | The Individual Names of | The Types of Lines |
| Transfer Zones | (d₁₁ = 2r₁₁) | The Generated Voltages | on The Drawing |
| The Central Region P₀ | 0~(1/9)r₁₁ | The Central Voltage V_{P0} | Thick Solid Line |
| The First Peripheral | (2/9)r₁₁~(3/9)r₁₁ | The First Peripheral | Thick Dashed Line |
| Region P₁ | | Voltage V_{P1} | |
| The Second Peripheral | (4/9)r₁₁~(5/9)r₁₁ | The Second Peripheral | Thin Dashed Line |
| Region P₂ | | Voltage V_{P2} | |
| The Third Peripheral | (6/9)r₁₁~(7/9)r₁₁ | The Third Peripheral | Thin Solid Line |
| Region P₃ | | Voltage V_{P3} | |
| The Fourth Peripheral | (8/9)r₁₁~r₁₁ | The Fourth Peripheral | Dashed-Dotted Line |
| Region P₄ | | Voltage V_{P4} | |

The outer side of the central region P₀ has the same line width and spacing width along the radial direction, and the four first peripheral regions P₁, second peripheral region P₂, third peripheral region P₃, and fourth peripheral region P₄ enclosed by the same spacing are concentric circular rings (regions). Due to the same line width and spacing width, the radius r₁₁ (=d₁₁/2) of the vibration cavity 21a1 is divided into 9 parts, defining the positions of the central region P₀, first peripheral region P₁, . . . , and fourth peripheral region P₄ along the radius. That is, as defined in Table 2, the radius r₁₁=d₁₁/2 of the vibration cavity 21a1, the central region P₀ is defined as a circular region (region) with a certain line width from the center to the radius position (1/9)r₁₁. Similarly, as defined in Table 2, the first peripheral region P₁ is defined as a circular region with a certain line width from the radius position (2/9)r₁₁ to the radius position (3/9)r₁₁. The second peripheral region P₂ is defined as a circular region with a certain line width from the radius position (4/9)r₁₁ to the radius position (5/9)r₁₁, and the third peripheral region P₃ is defined as a circular region with a certain line width from the radius position (6/9)r₁₁ to the radius position (7/9)r₁₁. Furthermore, the fourth peripheral region P₄ is defined as the region from the radius position (8/9)r₁₁ to the outermost circumference (radius position r₁₁).

For convenience, in FIG. 5B, the structure is illustrated as five potential detection ideal electrodes embedded in the lower surface of the vibrating body 22a2. However, in the simulation, the thickness of the potential detection ideal electrodes is zero. Therefore, as shown in FIG. 5B, the surface embedded in the vibrating body 22a2 is still a plate-like structure protruding from the surface of the vibrating body 22a1 as shown in FIG. 4B, which does not bring any essential difference. The line width and spacing width along the radial direction outside the central region P₀ are the same, and the four first peripheral regions P₁, second peripheral region P₂, third peripheral region P₄, and fourth peripheral region P₄ surrounded by the same spacing are concentric circular rings. Additionally, as mentioned in the case of FIG. 4B, in FIG. 5B, the outer circumference of the potential detection ideal electrode in the fourth peripheral region P₄ is in contact with the silicon substrate 11ₛₐ₂. In the simulation, it is assumed that the silicon substrate 11ₛₐ₂ is semi-insulating, and the potential detection ideal electrode in the fourth peripheral region P₄ is in an electrically floating state. Similarly, the entire lower surface of the potential detection ideal electrode in the central region P₀ is in contact with the upward protruding upper end of the silicon substrate 11ₛₐ₂, but assuming that the silicon substrate 11ₛₐ₂ is semi-insulating, the potential detection ideal electrode in the central region P₀ is in an electrically floating state.

Due to the same line width and spacing width, in the arrangement shown in FIG. 5B, the radius r₁₁ (=d₁₁/2) of the vibrating cavity 21a1 is divided into 9 parts by the first peripheral region P₁, . . . , the fourth peripheral region P₄, etc. Therefore, the line width Δr_{L}=r₁₁/9 of each of the first peripheral region P₁, . . . , the fourth peripheral region P₄ is constant. The diameter d₂₂ₐ₁ of the upward protrusion in the central part of the vibrating cavity 21a2 is 2Δr_{L}. That is, the positions of the central region P₀, the first peripheral region P₁, . . . , the fourth peripheral region P₄ are determined, as defined in Table 2. The transient response of the central voltage V_{P0}, the first peripheral voltage V_{P1}, . . . , the fourth peripheral voltage V_{4P} generated by the central region P₀, the first peripheral region P₁, . . . , the fourth peripheral region P₄, respectively, is shown in FIG. 5C.

FIG. 5C presents the simulation results when PZT is used throughout the entire vibrating body 22a2. It illustrates the transient responses of the central voltage V_{P0}, the first peripheral voltage V_{P1}, . . . , and the fourth peripheral voltage V_{4P}, which are generated during ultrasonic reception when the protrusion diameter d₂₂ₐ₂ in the central part of the parallel ring-shaped vibrational cavity 21a2 in the voltage generating section (22a2, 24a) is set to d₂₂ₐ₂=2Δr_{L}=6.7 μm. This simulation considers a vibrating body 22a2 with a thickness t₂₂ₐ₂=2.4 μm and a fixed potential electrode protective film 23 with a thickness t₂₃−6 μm. As indicated in the legend at the top right corner of FIG. 5C, the thick solid line represents the transient response of the central voltage V_{P0}. In FIG. 5C, the thick dashed line represents the first peripheral voltage V_{P1}, the thin dashed line represents the second peripheral voltage V_{P2}, the thin solid line represents the third peripheral voltage V_{P3}, and the dashed-dotted line represents the fourth peripheral voltage V_{P4}. When an ultrasonic wave consisting of a single pulse sine wave with a maximum pressure amplitude of ±1 Pa is input to the voltage generating section (22a2, 24a), pulse response voltage signals generated by the piezoelectric effect in the central region P₀, the second peripheral region P₁, . . . , and the fourth peripheral region P₄ exhibit transient responses. The second vibration amplitude is the largest near approximately 0.13 μs, and the third and subsequent vibrations are decaying vibrations.

Specifically, the central voltage V_{P0} shown in FIG. 5C reaches its peak near the time point after approximately 0.06 μs of ultrasonic pulse input, with a first vibration amplitude of approximately −0.62 μV In contrast, the second vibration reaches its peak near the time point after approximately 0.13 μs, with an amplitude of approximately +0.92 μV, reaching its maximum amplitude value. Subsequently, the third vibration reaches its peak near the time point after approximately 0.19 μs, with an amplitude of approximately −0.55 μV, and the fourth vibration reaches its peak near the time point after approximately 0.26 μs, with an amplitude decaying to approximately +0.33 μV The first peripheral voltage V_{P1} shown in FIG. 5C reaches its peak near the time point after approximately 0.06 μs of ultrasonic pulse input, with a first vibration amplitude of approximately +0.13 μV In contrast, the second vibration reaches its peak near the time point after approximately 0.13 μs, with an amplitude of approximately−0.18 μV, reaching its maximum amplitude value. However, the absolute value of the amplitude |V_{P1}| of the first peripheral voltage V_{P1} is less than the absolute value of the amplitude |V_{P1}| of the central voltage V_{P0}, and the central voltage V_{P0} and the first peripheral voltage V_{P1} exhibit an anti-phase relationship. Subsequently, the third vibration of the first peripheral voltage V_{P1} reaches its peak near the time point after approximately 0.19 μs, with an amplitude of approximately +0.12 μV, and the fourth vibration reaches its peak near the time point after approximately 0.26 μs, with an amplitude decaying to approximately −0.03 μV Due to the decrease in peak vibration amplitude, explanations for the fifth and subsequent times are omitted.

In FIG. 5C, the fourth peripheral voltage V_{P4}, represented by a dashed-dotted line, reaches its peak near a time of approximately 0.06 μs, with a first vibration amplitude of approximately +0.06 μV In contrast, the second vibration, which peaks near a time of approximately 0.13 μs, has an amplitude of approximately −0.09 μV, reaching its maximum amplitude value. The absolute amplitude of the fourth peripheral voltage V_{P4}, |V_{P4}|, is smaller than the absolute amplitude of the central voltage V_{P0}, |V_{P0}|, and the absolute amplitude of the first peripheral voltage V_{P1}, |V_{P1}|, making it the third smallest value. The first peripheral voltage V_{P1}, the third peripheral voltage V_{P3}, and the fourth peripheral voltage V_{P4} have an anti-phase relationship with the central voltage V_{P0} and the second peripheral voltage V_{P2}, while the central voltage V_{P0} and the second peripheral voltage V_{P2} have a phase relationship. Subsequently, the third vibration amplitude of the fourth peripheral voltage V_{P4}, which peaks near a time of approximately 0.19 μs, is approximately +0.03 μV, and the fourth vibration amplitude, which peaks near a time of approximately 0.26 μs, decays to approximately −0.01 μV.

In FIG. 5C, the transient response vibration of the third peripheral voltage V_{P3}, represented by the thin solid line, exhibits an amplitude absolute value |V_{P3}| that is roughly the same as the absolute value |V_{P4}| of the fourth peripheral voltage V_{P4}, but slightly smaller overall, making it the fourth smallest value. The third peripheral voltage V_{P3} vibrates in phase with the first peripheral voltage V_{P1} and the fourth peripheral voltage V_{P4}. The third peripheral voltage V_{P3} vibrates out of phase with the central voltage V_{P0} and the second peripheral voltage V_{P2}. Additionally, the transient response vibration of the second peripheral voltage V_{P2}, represented by the thin dashed line in FIG. 5C, exhibits an amplitude absolute value |V_{P2}| that is smaller than the absolute value |V_{P3}| of the third peripheral voltage V_{P3} and the absolute value |V_{P4}| of the fourth peripheral voltage V_{P4}, making it the smallest fifth value. The second peripheral voltage V_{P2} vibrates in phase with the central voltage V_{P0}, and vibrates out of phase with the first peripheral voltage V_{P1}, the third peripheral voltage V_{P3}, and the fourth peripheral voltage V_{P4}. That is, the potential relationship generated by the piezoelectric effect on the output surface of the vibrator 22a2 of the voltage generating section (22a2, 24a) in FIGS. 5A and 5B exhibits position-dependent potential distribution with a magnitude relationship as follows:

$$\vert {V}_{P 0} \vert > \vert {V}_{P 1} \vert > \vert {V}_{P 4} \vert > \vert {V}_{P 3} \vert > \vert {V}_{P 2} \vert \qquad ( 9 )$$

FIG. 5D, similar to FIG. 5C, presents the simulation results of the frequency dependence of voltage sensitivity (μV/Pa) when using PZT for the vibrator 22a2 in the voltage generation section (22a2, 24a) depicted in FIGS. 5A and 5B. In the simulation, the thickness t_{22b} of the vibrator 22a2 is set to 2.4 μm, the thickness t₂₃ of the fixed potential electrode protective film 23 on the vibrator 22a2 is set to 6 μm, and the diameter d_{22b} of the protrusion in the central part of the parallel annular vibration cavity of the voltage generation section is used as a parameter. As shown in FIG. 5D, within the receiving frequency range of 5 MHz to 10 MHz, when the protrusion diameter d_{22b} is set to 1.2 μm (reference value), the maximum voltage sensitivity is approximately 10.6 μV/Pa, which is the maximum value among the parameters used in the simulation. Within the same frequency range, when the protrusion diameter d_{22b} is doubled to 2.4 μm, the maximum voltage sensitivity decreases to approximately 5.4 μV/Pa, which is roughly half of the original value. When the protrusion diameter d_{22b} is tripled to 3.6 μm, the maximum voltage sensitivity drops to approximately 3.3 μV/Pa, which is about one-third of the original value. When the protrusion diameter d_{22b} is quadrupled to 4.8 μm, the maximum voltage sensitivity decreases to approximately 2.5 μV/Pa, which is roughly one-fourth of the original value. When the protrusion diameter d_{22b} is quintupled to 6.0 μm, the maximum voltage sensitivity is approximately 2.0 μV/Pa, which is about one-fifth of the original value. Finally, when the protrusion diameter d_{22b} is sextupled to 7.2 μm, the maximum voltage sensitivity is approximately 1.7 μV/Pa, which is roughly one-sixth of the original value. In other words, as can be seen from FIG. 5D, the larger the protrusion diameter d_{22b} in the central part of the parallel annular vibration cavity 21a2 of the voltage generating section (22a2, 24a), the lower the maximum voltage sensitivity.

The voltage generating sections (22a2, 24a) shown in FIGS. 5A and 5B are located at the protrusion in the central part. The vibration of the vibrating body 22a2 in the up-down direction (Y direction in FIG. 5E) is fixed relative to the silicon substrate 11ₛₐ₂. With this central part fixed, the vibrating body 22a2 located above the toroidal vibration cavity 21a2 appears wing-like as shown in FIG. 5E, vibrating as an upwardly convex curved surface and a downwardly convex curved surface on both sides of the central protrusion. FIG. 5E illustrates the displacement inside the upwardly convex curved surface and the displacement inside the downwardly convex curved surface, which are asymmetric to each other. FIG. 5E is a model diagram used to explain the displacement and stress inside the vibrating body 22a2. In a no-deflection, no-load state, it is assumed that the vibrating body 22a2 constitutes a flat plane in the horizontal direction (X direction in FIG. 5E). The FIG. represents a model where, in the no-load state with a flat arrangement, 18 circles are arranged at equal intervals of approximately 3.7 μm in the X direction, and these circles are connected and arranged laterally through an elastic body (spring).

It should be noted that the Y direction used in FIG. 5E corresponds to the z direction in equations (2a) to (5c), and the X direction in FIG. 5E corresponds to the x or y direction in equations (2a) to (5c). In the stress model shown in FIG. 5E, the structure of the voltage generating section (22a2, 24a) shown in FIG. 5A and FIG. 5B, where the vibrating body 22a2 is fixed at the protrusion in the central part, constitutes a toroidal vibrating cavity 21a2 with a diameter d₁₁=66 μm. FIG. 5E illustrates the internal displacement of the vibrating body 22a2 in a vibrating state when PZT is used in the vibrating body 22a2, based on the structure shown in FIG. 5A and FIG. 5B. The lower part of FIG. 5E shows the arrangement of the circles when the vibrating body 22a2 deflects downward as two downward-convex curves, as well as the displacement position of each circle after 0.13 μs has elapsed since the arrival of the ultrasonic pulse. On the other hand, the upper part shows the arrangement of the circles when the vibrating body 22a2 deflects upward as two upward-convex curves, as well as the displacement position of each circle after 0.18 μs has elapsed since the arrival of the ultrasonic pulse. It represents the displacement degrees in the X and Y directions of the circles arranged at equal intervals in the X direction under no-load conditions, due to the vibration of the vibrating body 22a2.

In the scenario depicted in FIG. 5E, on both sides of the fixed position in the central part, when the vibrating body 22a2 flexes upward with a convex shape, the interval between circles near the fixed position in the central part tends to decrease in the X direction. Conversely, when the vibrating body 22a2 flexes downward with a convex shape, the interval between circles near the fixed position in the central part tends to increase in the X direction. Therefore, the change in the interval between circles of the vibrating body 22a2 is asymmetric when flexing upward and downward. Consequently, it can be observed that the internal stress of the vibrating body 22a2 is also uneven.

In the case where the vibrator 22a2 in FIGS. 5A and 5B uses PZT, FIG. 5F(a) shows the stress variation in the XX direction, FIG. 5F(b) shows the stress variation in the YY direction, and FIG. 5F(c) shows the stress variation in the XY direction. The X and Y directions used in FIG. 5F(a) to 5F(c) are the same as those defined in FIG. 5E. As shown in the legend of the line types in the upper right corner of each of FIG. 5F(a) to 5F(c), the thick solid line represents the transient response of the central stress T_{P0} generated in the central region P₀. In FIG. 5F(a) to 5F(c), the thick dashed line represents the transient response of the first peripheral stress T_{P1} generated in the first peripheral region P₁, the thin dashed line represents the transient response of the second peripheral stress T_{P2} generated in the second peripheral region P₂, the thin solid line represents the transient response of the third peripheral stress T_{P3} generated in the third peripheral region P₃, and the dashed-dotted line represents the transient response of the fourth peripheral stress T_{4P} generated in the fourth peripheral region P₄. As shown on the left side of FIG. 5C, when an ultrasonic wave composed of a single pulse sine wave with a maximum ±1 Pa vibration amplitude is input to the voltage generating section (22a2, 24a), the central stress T_{P0} in the XX direction, the first peripheral stress T_{P1}, . . . , and the fourth peripheral stress T_{4P} generated in the vibrator 22a2 corresponding to the central region P₀, the first peripheral region P₁, . . . , and the fourth peripheral region P₄ exhibit transient responses, with the second vibration amplitude being the maximum near approximately 0.13 μs, and decaying vibrations after the third time.

Taking the central stress T_{P0} in the XX direction indicated by the thick solid line in FIG. 5F(a) as an example, the first vibration amplitude reaching its peak near the time point after approximately 0.06 μs of ultrasonic pulse input is approximately −50 N/m². In contrast, the second vibration amplitude reaching its peak near the time point after approximately 0.13 μs is approximately +120 N/m², reaching the maximum amplitude value. Subsequently, the third vibration amplitude reaching its peak near the time point after approximately 0.19 μs is approximately −110 N/m², the fourth vibration amplitude reaching its peak near the time point after approximately 0.26 μs is approximately +60 N/m², the fifth vibration amplitude reaching its peak near the time point after approximately 0.31 μs is approximately −40 N/m², and the sixth vibration amplitude reaching its peak near the time point after approximately 0.37 μs attenuates to approximately +20 N/m². The other first peripheral stress T_{P1}, . . . , fourth peripheral stress T_{4P} also exhibit the same trend. According to FIG. 5F(a), among the central stress T_{P0}, first peripheral stress T_{P1}, . . . , fourth peripheral stress T_{4P} generated in the vibrating body 22a2 in the XX direction, the central stress T_{P0} is the largest.

As shown in FIG. 5F(b), the stress (N/m²) generated by the vibrating body 22a2 in the YY direction also exhibits a maximum amplitude of the second vibration near approximately 0.13 μs, followed by a transient response of decaying vibration after the third time. Taking the central stress T_{P0} in the YY direction represented by the thick solid line as an example, the first vibration amplitude reaching a peak near approximately 0.06 μs after the input of the ultrasonic pulse is approximately +15 N/m². In contrast, the second vibration amplitude reaching a peak near approximately 0.13 μs is approximately −42 N/m², reaching the maximum amplitude value. Subsequently, the third vibration amplitude reaching a peak near approximately 0.19 μs is approximately +39 N/m², the fourth vibration amplitude reaching a peak near approximately 0.26 μs is approximately −22 N/m², the fifth vibration amplitude reaching a peak near approximately 0.31 μs is approximately +12 N/m², and the sixth vibration amplitude reaching a peak near approximately 0.37 μs decays to approximately −8 N/m². The other first peripheral stress T_{P1}, . . . , fourth peripheral stress T_{4P} also exhibit the same trend. According to FIG. 5F(b), among the central stress T_{P0}, first peripheral stress T_{P1}, . . . , fourth peripheral stress T_{4P} generated in the vibrating body 22a2 in the YY direction, the central stress T_{P0} is the largest, similar to the XX direction.

Similarly, when an ultrasonic pulse composed of sine waves is input to the voltage generating section (22a2, 24a), the central stress T_{P0} in the XY direction, the first peripheral stress T_{P1}, . . . , and the fourth peripheral stress T_{4P} generated in the vibrating body 22a2 corresponding to the central region P₀, the first peripheral region P₁, . . . , and the fourth peripheral region P₄, respectively, exhibit a transient response with the second vibration amplitude being the largest near approximately 0.13 μs, followed by decaying vibrations after the third time, as shown in FIG. 5F(c). Taking the central stress T_{P0} in the XY direction represented by the thick solid line in FIG. 5F(c) as an example, the first vibration amplitude reaching a peak near approximately 0.06 μs after the input of the ultrasonic pulse is approximately +12 N/m², compared to which, the second vibration amplitude reaching a peak near approximately 0.13 μs is approximately−35 N/m², reaching the maximum amplitude value. Subsequently, the third vibration amplitude reaching a peak near approximately 0.19 μs is approximately +32 N/m², the fourth vibration amplitude reaching a peak near approximately 0.26 μs is approximately −20 N/m², the fifth vibration amplitude reaching a peak near approximately 0.31 μs is approximately +11 N/m², and the sixth vibration amplitude reaching a peak near approximately 0.37 μs decays to approximately −7 N/m². The other first peripheral stress T_{P1}, . . . , and fourth peripheral stress T_{4P} also exhibit the same trend. According to FIG. 5F(c), among the stresses generated in the vibrating body 22a2 in the XY direction, the central stress T_{P0} is the largest, similar to the XX direction and YY direction.

Next, the central part of FIG. 5B is enlarged, as shown in FIG. 6A. The central region P₀ of FIG. 5B is subdivided into a subdivided central region Poo, a first subdivided peripheral region P₀₁, a second subdivided peripheral region P₀₂, and a third subdivided peripheral region P₀₃. The minute potential distribution of the voltage generated at the central protrusion and its vicinity in FIG. 5B is verified. The subdivided central region P₀₀ is located at the center of the central protrusion. Surrounding the subdivided central region P₀₀ at the center, the first subdivided peripheral region P₀₁, the second subdivided peripheral region P₀₂, and the third subdivided peripheral region P₀₃ are located around it. In FIG. 6A, more refined potential detection ideal electrodes are arranged at the positions of the subdivided central region P₀₀, the first subdivided peripheral region P₀₁, the second subdivided peripheral region P₀₂, and the third subdivided peripheral region P₀₃, respectively, compared to the situation in FIG. 5B. The silicon substrate 11ₛₐ is inserted with a vibrating body 22a2, and a parallel ring-shaped vibrating cavity 21a2 is arranged around the protrusion in the central part. The structure of the vibrating body 22a2, which is equipped with a fixed potential electrode 24a and a fixed potential electrode protective film 23, is the same as that in FIG. 5B.

The positions of the first, second, and third subdivided peripheral areas P₀₁, P₀₂, and P₀₃ outside the ideal electrode for potential detection are surrounded by three concentric rings of ideal electrodes for potential detection. The ideal electrodes for potential detection in the first, second, and third subdivided peripheral areas P₀₁, P₀₂, and P₀₃ are arranged with the same line width Δr_{L} and spacing width Δr_{S} in the radial direction (Δr_{L}=Δr_{S}), and are spaced at the same interval. Since the line width and spacing width of the ideal electrodes for potential detection are the same, the ideal electrodes for potential detection divide the radius r₂₂ₐ₂ of the central protrusion (=d₂₂ₐ₂/2) into seven parts, defining the positions of the subdivided central area P₀₀, the first subdivided peripheral area P₀₁, the second subdivided peripheral area P₀₂, and the third subdivided peripheral area P₀₃ along the radius. Therefore, the diameter d₂₂ₐ₂ of the protrusion in the central part of the vibrating cavity is approximately equal to the outer circumferential diameter 14 Δr_{S} of the ideal electrode P₀₃ for potential detection arranged in the third subdivided peripheral area P₀₃ (14Δr_{S}=d₂₂ₐ₂). Furthermore, setting the radius of the central protrusion as r₂₂ₐ₂=d₂₂ₐ₂/2, the subdivided central area P₀₀ is defined as an area where a ring-shaped ideal electrode for potential detection with a certain line width is arranged from the center to a radial position of (1/7)r₂₂ₐ₂.

Similarly, the first subdivided peripheral area Poi is defined as: a region where an annular potential detection ideal electrode with a certain line width is arranged from the radius position (2/7)r₂₂ₐ₂ to the radius position (3/7)r₂₂ₐ₂. The second subdivided peripheral area P₀₂ is defined as: a region where an annular potential detection ideal electrode with a certain line width is arranged from the radius position (4/7)r₂₂ₐ₂ to the radius position (5/7)r₂₂ₐ₂. The third subdivided peripheral area P₀₃ is defined as: a region where an annular potential detection ideal electrode with a certain line width is arranged from the radius position (6/7)r₂₂ₐ₂ to the radius position (7/7)r₂₂ₐ₂. Additionally, the fourth subdivided peripheral area P₀₄ is defined as: a region where an annular potential detection ideal electrode with a certain line width is arranged on the vibration cavity 21a2 outside the central protrusion from the radius position (8/7)r₂₂ₐ₂ to the radius position (9/7)r₂₂ₐ₂. Furthermore, the fifth subdivided peripheral area P₀₃ is defined as: a region where an annular potential detection ideal electrode with a certain line width is arranged on the vibration cavity 21a2 outside the central protrusion from the radius position (10/7)r₂₂ₐ₂ to the radius position (11/7)r₂₂ₐ₂.

In the simulation, it is assumed that the six ideal potential detection electrodes, respectively positioned in the central region P₀₀, the first peripheral region P₀₁, . . . , and the fifth peripheral region P₀₅, are all in an electrically open state (open circuit). On the output surface of the vibrating body 22a2, the radial electric field within the ideal potential detection electrodes located in each of the central region P₀₀, the first peripheral region P₀₁, . . . , and the fifth peripheral region P₀₅ is short-circuited by the ideal potential detection electrodes.

FIG. 6B illustrates the transient response of voltage generated during ultrasonic reception when the diameter of the protrusion d₂₂ₐ₂ in the central part of the parallel annular vibration cavity 21a2 of the voltage generating unit (22a2, 24a) is set to 2.4 μm, in the case where the entire vibrator 22a2 is made of PZT. The diagram uses the positions of the potential transfer areas, namely the central region P₀₀, the first peripheral region P₀₁, . . . , and the fifth peripheral region P₀₅, as parameters. This scenario assumes that the thickness t₂₂ₐ₂ of the vibrator 22a2 excluding the central protrusion is 2.4 μm, and the thickness t₀₂₀₃ of the fixed potential electrode protective film 23 is 6.0 μm. As shown in the legend of the line types in the upper right corner of FIG. 6B, the thick solid line represents the transient response of the voltage generated in the central region P₀₀, namely the central region voltage V_{P00}. In FIG. 6B, the thick dashed line represents the voltage generated in the first peripheral region P₀₁, namely the first peripheral region voltage V_{P01}, the dotted line represents the voltage generated in the second peripheral region P₀₂, namely the second peripheral region voltage V_{P02}, the dashed-dotted line represents the voltage generated in the third peripheral region P₀₃, namely the third peripheral region voltage V_{P03}, the thin solid line represents the voltage generated in the fourth peripheral region P₀₄, namely the fourth peripheral region voltage V_{P04}, and the thin dashed line represents the voltage generated in the fifth peripheral region P₀₅, namely the fifth peripheral region voltage V_{P05}.

As shown on the left side of FIG. 6B, when an ultrasonic wave consisting of a 1.5-cycle sine wave vibrating asymmetrically at 0.3 Pa on the positive side and 1 Pa on the negative side is input to the voltage generation section (22a2, 24a), the voltage signals generated in the subdivided central region P₀₀, the first subdivided peripheral region P₀₁, . . . , and the fifth subdivided peripheral region P₀₅ exhibit a transient response where the amplitude of the second vibration reaches its maximum near approximately 0.13 μs, and the third and subsequent vibrations are damped.

Specifically, in FIG. 6B, the first subdivided central voltage V_{P00} in the first subdivided central region P₀₀ of the central part of the vibrating body 22a2, represented by the thick solid line, reaches a peak near the time point after approximately 0.06 μs following the input of the ultrasonic pulse, with a first vibration amplitude of approximately −1.3 μV. In contrast, the second vibration amplitude, which peaks near the time point after approximately 0.13 μs, is approximately +3.5 μV, reaching the maximum amplitude value. Subsequently, the third vibration amplitude, which peaks near the time point after approximately 0.19 μs, is approximately −3.2 μV, and the fourth vibration amplitude, which peaks near the time point after approximately 0.26 μs, decays to approximately +1.8 μV. The first subdivided peripheral voltage V_{P01} in the first subdivided peripheral region P₀₁, represented by the thick dashed line in FIG. 6B, reaches a peak near the time point after approximately 0.06 μs following the input of the ultrasonic pulse, with a first vibration amplitude of approximately −1.2 μV. In contrast, the second vibration amplitude, which peaks near the time point after approximately 0.13 μs, is approximately +3.4 μV, reaching the maximum amplitude value. However, the absolute value of the amplitude |V_{P01}| of the first subdivided peripheral voltage V_{P01} is less than the absolute value of the amplitude |V_{P00}| of the subdivided central voltage V_{P00}. Subsequently, the third vibration amplitude of the first subdivided peripheral voltage V_{P01}, which peaks near the time point after approximately 0.19 μs, is approximately −3.1 μV, and the fourth vibration amplitude, which peaks near the time point after approximately 0.26 μs, decays to approximately +1.7 μV Due to the decrease in peak vibration amplitude, explanations for the fifth and subsequent times are omitted.

In FIG. 6B, the absolute value of the amplitude |V_{P02}| exhibited by the transient response vibration of the second segmented peripheral voltage V_{P02} in the second segmented peripheral region P₀₂, indicated by the dashed line, is slightly smaller than the absolute value |V_{P01}| of the first segmented peripheral voltage V_{P01} in the first segmented peripheral region P₀₁, ranking third. Additionally, the absolute value of the amplitude |V_{P03}| exhibited by the transient response vibration of the third segmented peripheral voltage V_{P03} in the third segmented peripheral region P₀₃, indicated by the dashed-dotted line, is slightly smaller than the absolute value |V_{P02}| of the second segmented peripheral voltage V_{P02}, ranking fourth. Furthermore, the absolute value of the amplitude |V_{P04}| exhibited by the transient response vibration of the fourth segmented peripheral voltage V_{P04} in the fourth segmented peripheral region P₀₄, indicated by the thin solid line, is slightly smaller than the absolute value |V_{P03}| of the third segmented peripheral voltage V_{P03}, ranking fifth.

Furthermore, in FIG. 6B, the fifth subdivided peripheral voltage V_{P05} in the fifth subdivided peripheral region P05, indicated by the thin dashed line, reaches its peak near the time after approximately 0.06 μs, with a first vibration amplitude of approximately −0.2 μV Subsequently, it reaches its peak near the time after approximately 0.13 μs, with a second vibration amplitude of approximately +0.6 μV, reaching its maximum amplitude value. The absolute value of the amplitude |V_{P05}| of the fifth subdivided peripheral voltage V_{P05} is smaller than the absolute values |V_{P00}| to |V_{P04}| of the subdivided central voltage V_{P00} to the fourth subdivided peripheral voltage V_{P04}, representing the smallest value. It should be noted that the subdivided central voltage V_{P00} to the fifth subdivided peripheral voltage V_{P05} are all in the same phase relationship. Afterwards, the third vibration amplitude of the fifth subdivided peripheral voltage V_{P05}, which reaches its peak near the time after approximately 0.19 μs, is approximately −0.4 μV. The fourth vibration amplitude, which reaches its peak near the time after approximately 0.26 μs, decays to approximately +0.2 μV. That is, the potential relationship generated by the piezoelectric effect on the output surface of the vibrator 22a2 of the voltage generating section (22a2, 24a) is as follows:

$$\vert {V}_{P 00} \vert > \vert {V}_{P 01} \vert > \vert {V}_{P 02} \vert > \vert {V}_{P 03} \vert > \vert {V}_{P 04} \vert > \vert {V}_{P 05} \vert \qquad ( 10 )$$

It presents a potential distribution with position-dependent magnitude relationships.

FIG. 6C illustrates the relationship between the voltage (V) generated on the vibrating body 22a2 and the generation position (m) measured from the center, with the diameter d₂₂ₐ₂ of the central protrusion of the vibrating cavity 21a2 as a parameter, when using PZT for the vibrating body 22a2. In this case, the thickness t₂₂ₐ₂ of the vibrating body 22a2 is t₂₂ₐ₂=2.4 μm, and the thickness t₂₃ of the fixed potential electrode protective film 23 is t₂₃=6 μm. As shown in FIG. 6C, the curve representing the voltage position dependence is symmetrical about the center of the voltage generating section (22a2, 24a), and it can be seen that the smaller the diameter d₂₂ₐ₂ of the central protrusion of the vibrating cavity 21a2, the greater the generated voltage. Specifically, when the protrusion diameter d₂₂ₐ₂ is d₂₂ₐ₂=2.4 μm (reference value), the maximum generated voltage is approximately 3.2 μV, which is the largest among the parameters used in the simulation. Additionally, when the protrusion diameter d₂₂ₐ₂ is d₂₂ₐ₂=4.8 μm, which is twice the reference value, the maximum generated voltage is approximately 1.5 μV, which is reduced by approximately half, when the protrusion diameter d₂₂ₐ₂ is d₂₂ₐ₂=7.2 μm, which is three times the reference value, the maximum generated voltage is approximately 1.0 μV, which is reduced to approximately one-third; when the protrusion diameter d₂₂ₐ₂ is d₂₂ₐ₂=9.6 μm, which is four times the reference value, the maximum generated voltage is approximately 0.8 μV, which is reduced to approximately one-fourth. That is, as can be seen from FIG. 6C, the larger the diameter d₂₂ₐ₂ of the central protrusion of the vibrating cavity 21a2, the smaller the maximum generated voltage.

### V-Shaped (Inclined Annular Surface)

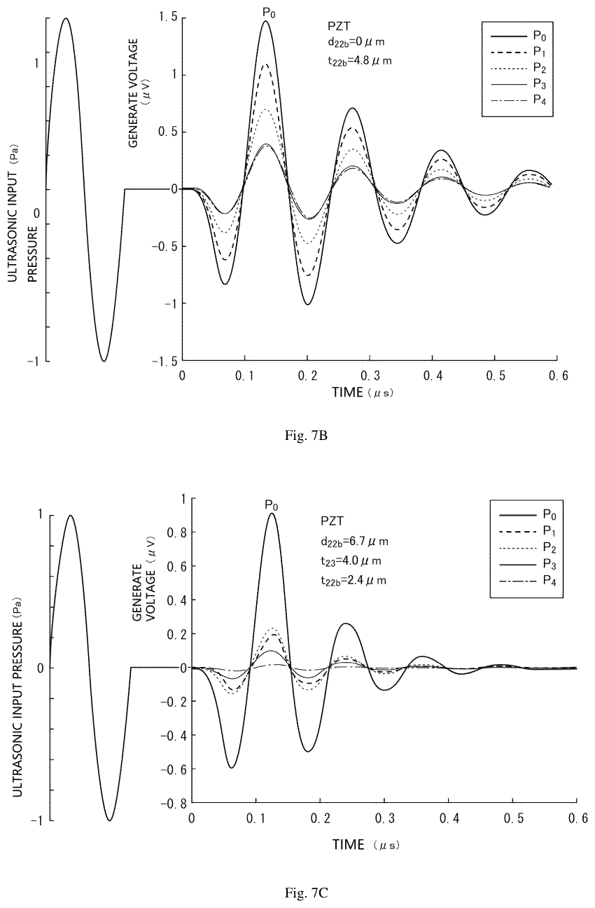

Next, the voltage distribution on the output surface of the stress distribution reinforcement structure with a V-shaped cross-sectional structure, as shown in FIG. 7A, was studied for different positions on the vibrator 22b constituting the voltage generation section (22b, 24b). This research serves as the foundation for enhancing sensitivity and broadening bandwidth. The vibrator 22b is arranged on the recessed portion of the silicon substrate 11_{sb}, with a fixed potential electrode 24b grounded arranged on the vibrator 22b. A fixed potential electrode protective film 23 made of resin is arranged on the fixed potential electrode 24b. The vibrator 22b takes on a conical shape tapering downwards on the recessed portion of the silicon substrate 11_{sb}. Specifically, as shown in FIG. 7A, due to the V-shaped cross-sectional shape, the lower tip of the V-shape contacts the bottom surface of the recessed portion of the silicon substrate 11_{sb}. Therefore, in the space formed by the recessed portion, inclined toroidal vibration cavities 21b with two triangular cross-sections are provided on both sides of the V-shaped cutting area. “Inclined toroidal” refers to the cross-sectional structure of the space constituting the toroid, which is a three-dimensional structure with one main surface inclined relative to the other, as shown in FIG. 7A. In the simulation, using the same definition as in Table 2, an ideal electrode for potential detection was arranged in the central region P₀ at the lower tip position of the V-shape, and around the central region P₀, four concentric circular rings of the first peripheral region P₁, . . . , the fourth peripheral region P₄ surrounding the central region P₀ were arranged along the shape of the V-shape.

FIG. 7B presents the simulation results when PZT is used throughout the entire vibrating body 22b. When the silicon substrate 11_{sb} μmakes point contact with the vibrating body 22b in the central part of the vibrating cavity 21b (assuming a contact width d_{22b}=0 μm), a transient response of voltage generation occurs. This response is displayed with parameters indicating the positions of the potential transfer areas, namely the central region P₀, the first peripheral region P₁, . . . , and the fourth peripheral region P₄. In this case, the thickness t_{22b} of the vibrating body 22b is set to 4.8 μm, and the thickness t₂₃ of the fixed potential electrode protective film 23 is set to 6 μm. When a single-frequency sine wave with a maximum vibration amplitude of ±1 Pa is input to the voltage generating sections (22b, 24b) as shown on the left side of FIG. 7B, pulse responses are generated in the potential transfer areas, namely the central region P₀, the first peripheral region P₁, . . . , and the fourth peripheral region P₄. These responses exhibit a transient response where the second vibration amplitude reaches its maximum near approximately 0.13 μs, and subsequent amplitudes decay.

Specifically, the transient response of the central voltage V_{P0} in the central region P₀, represented by the thick solid line in FIG. 7B, shows a first vibration amplitude of approximately −0.8 μV after about 0.06 μs following the input of the ultrasonic pulse. In contrast, the second vibration amplitude, which reaches its peak after about 0.13 μs, is approximately +1.5 μV, reaching its maximum amplitude value. Subsequently, the third vibration amplitude, which peaks after about 0.19 μs, is approximately −1.2 μV, and the fourth vibration amplitude, which peaks after about 0.26 μs, decays to approximately +0.7 μV. The transient response of the first peripheral voltage V_{P1}, represented by the thick dashed line in FIG. 7B, shows a first vibration amplitude of approximately −0.6 μV after about 0.06 μs following the pulse input. In comparison, the second vibration amplitude, which reaches its peak after about 0.13 μs, is approximately +1.2 μV, reaching its maximum amplitude value. However, the absolute amplitude value |V_{P1}| of the first peripheral voltage V_{P1} is smaller than the absolute amplitude value |V_{P0}| of the central voltage V_{P0}. Subsequently, the third vibration amplitude of the first peripheral voltage V_{P1}, which peaks after about 0.19 μs, is approximately −0.7 μV, and the fourth vibration amplitude, which peaks after about 0.26 μs, decays to approximately +0.6 μV. The peak amplitudes of the vibrations after the fifth time decrease, so further explanations are omitted.

In FIG. 7B, the absolute amplitude |V_{P2}| of the second peripheral voltage V_{P2}, represented by the dashed line, is slightly smaller than the absolute amplitude |V_{P1}| of the first peripheral voltage V_{P1}, ranking as the third value. Additionally, the absolute amplitude |V_{P3}| of the third peripheral voltage V_{P3}, depicted by the thin solid line in FIG. 7B, is slightly smaller than the absolute amplitude |V_{P2}| of the second peripheral voltage V_{P2}, ranking as the fourth value.

Moreover, the transient response of the fourth peripheral voltage V_{P4}, represented by the dashed-dotted line in FIG. 7B, exhibits a first vibration amplitude of approximately 0.2 μV after approximately 0.06 μs. In contrast, the second vibration amplitude, which reaches its peak after approximately 0.13 μs, is approximately +0.4 μV, reaching the maximum amplitude value. However, the absolute amplitude value |V_{P4}| of the fourth peripheral voltage V_{P4} is smaller than the absolute amplitude values |V_{P0}| to |V_{P2}| of the central voltage V_{P0} to the third peripheral voltage V_{P3}, representing the smallest value. It should be noted that the central voltage V_{P0} to the fourth peripheral voltage V_{P4} are all in the same phase relationship. Therefore, the relationship between the absolute values of the potentials generated on the output surface of the vibrating body 22b is as follows:

$$\vert {V}_{P 0} \vert > \vert {V}_{P 1} \vert > \vert {V}_{P 2} \vert > \vert {V}_{P 3} \vert > \vert {V}_{P 4} \vert \qquad ( 11 )$$

Exhibit a potential distribution with position-dependent magnitude relationships.

FIG. 7C is similar to FIG. 7B, showing the simulation results when PZT is used in the vibrating body 22b of FIG. 7A. Assuming a contact width d_{22b}=6.7 μm between the silicon substrate 11_{sb} and the vibrating body 22b in the central part of the vibrating cavity 21b, the transient response of the generated voltage is displayed with the positions of the potential transfer regions, namely the central region P₀, the first peripheral region P₁, . . . , and the fourth peripheral region P₄, as parameters. At this time, the thickness t_{22b} of the vibrating body 22b is t_{22b}=2.4 μm, and the thickness t₂₃ of the fixed potential electrode protective film 23 is t₂₃=4 μm. When a single-frequency sine wave with a maximum vibration amplitude of ±1 Pa is input to the voltage generating sections (22b, 24b) as shown on the left side of FIG. 7C, the pulse responses generated in the potential transfer regions, namely the central region P₀, the first peripheral region P₁, . . . , and the fourth peripheral region P₄, are similar to the example shown in FIG. 7B, exhibiting a transient response where the second vibration amplitude reaches its maximum near approximately 0.13 μs, and the third and subsequent vibrations are decaying vibrations.

Specifically, in FIG. 7C, the transient response of the center voltage V_{P0} in the central region P₀, represented by the thick solid line, shows that the amplitude of the first oscillation after the pulse input is approximately 0.6 μV after about 0.06 μs. In contrast, the peak amplitude of the second oscillation after about 0.13 μs is approximately +0.9 μV, reaching the maximum amplitude value. Subsequently, the peak amplitude of the third oscillation after about 0.19 μs is approximately −0.5 μV, and the peak amplitude of the fourth oscillation after about 0.26 μs decays to approximately +0.3 μV. The peak amplitudes of the oscillations after the fifth time decrease, so the explanation is omitted.

The transient response of the first peripheral voltage V_{P1}, represented by the thick dashed line in FIG. 7C, exhibits a peak amplitude of approximately 0.16 μV during the first oscillation after approximately 0.06 μs following the pulse input. In contrast, the peak amplitude of the second oscillation, occurring after approximately 0.13 μs, reaches a maximum value of approximately +0.18 μV. However, the absolute amplitude value |V_{P1}| of the first peripheral voltage V_{P1} is smaller than the absolute amplitude value |V_{P0}| of the central voltage V_{P0}. Subsequently, the amplitude of the third oscillation of the first peripheral voltage V_{P1}, which peaks after approximately 0.19 μs, is approximately −0.12 μV, and the amplitude of the fourth oscillation, which peaks after approximately 0.26 μs, decays to approximately +0.6 μV.

In FIG. 7C, the absolute amplitude value |V_{P2}| of the second peripheral voltage V_{P2}, represented by the dashed line, is slightly larger than the absolute amplitude value |V_{P1}| of the first peripheral voltage V_{P1}. Additionally, the absolute amplitude value |V_{P3}| of the third peripheral voltage V_{P3}, represented by the thin solid line in FIG. 7C, is slightly smaller than the absolute amplitude values |V_{P1}| and |V_{P2}| of the first and second peripheral voltages V_{P1} and V_{P2}, respectively, and ranks as the fourth value.

Moreover, in FIG. 7C, the second peak amplitude of the fourth peripheral voltage V_{P4}, represented by the dashed-dotted line, also reaches the maximum amplitude after approximately 0.13 μs. However, the absolute amplitude value |V_{P4}| of the fourth peripheral voltage V_{P4} is smaller than the absolute amplitude values |V_{P0}| to |V_{P3}| of the central voltage V_{P0} to the third peripheral voltage V_{P3}, and is the smallest value. It should be noted that the central voltage V_{P0} to the fourth peripheral voltage V_{P4} are all in the same phase relationship. Therefore, the relationship between the absolute values of the potentials generated on the output surface of the vibrating body 22b is as follows:

$$\vert {V}_{P 0} \vert > \vert {V}_{P 2} \vert > \vert {V}_{P 1} \vert > \vert {V}_{P 3} \vert > \vert {V}_{P 4} \vert \qquad ( 12 )$$

Presenting a potential distribution with position-dependent magnitude relationships.

### Λ-Shaped

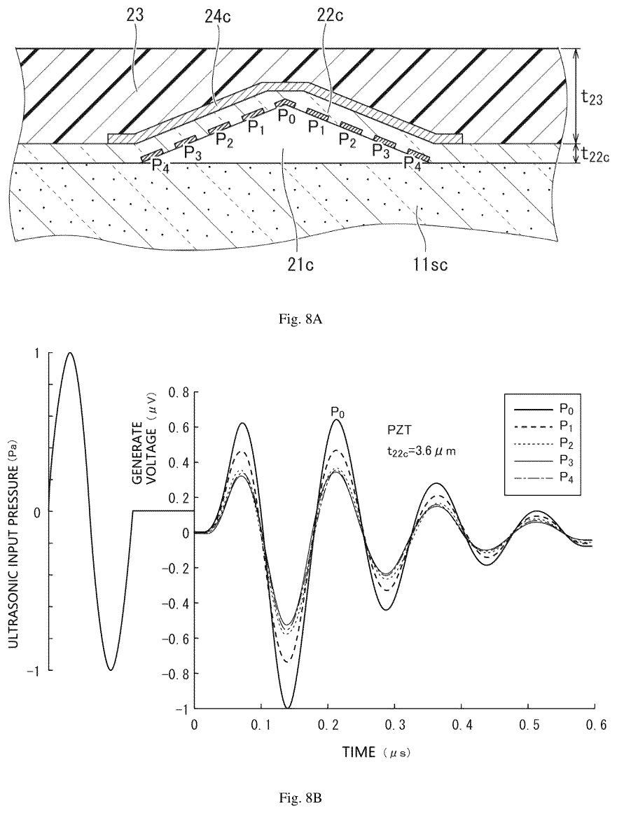

Next, as shown in FIG. 8A, the voltage distribution on the output surface of the stress distribution reinforcement structure with a Λ-shaped cross-sectional structure was studied for each position, serving as the basis for high sensitivity and broadbanding. The vibrator 22c was arranged on the silicon substrate 11_{sc}, with a grounded fixed potential electrode 24c arranged on the vibrator 22c, and a fixed potential electrode protective film 23 made of resin was arranged on the fixed potential electrode 24c. The vibrator 22c had a conical shape tapering upward on the silicon substrate 11_{sc}, as shown in FIG. 8A, with a Λ-shaped cross-sectional shape, where the bottom sides of the Λ-shape were in contact with the surface of the silicon substrate 11_{sc}. Therefore, a conical vibrating cavity 21c with an isosceles triangular cross-section was provided on the silicon substrate 11_{sc}. Additionally, on the lower surface of the vibrator 22c, to verify the generated voltage distribution, one circular potential detection ideal electrode was arranged at the upper tip of the Λ shape, and four concentric ring-shaped potential detection ideal electrodes were arranged around the central potential detection ideal electrode P₀, with the potential transfer areas defined as the central region P₀, the first peripheral region P₁, . . . , and the fourth peripheral region P₄ (refer to Table 2) from the inside out. Then, by verifying the transient response of the voltage generated in the central region P₀, the first peripheral region P₁, . . . , and the fourth peripheral region P₄, the voltage distribution on the output surface (lower surface) of the vibrator 22c was simulated.

FIG. 8B presents the simulation results when PZT is used throughout the entire vibrating body 22c. When the thickness t_{22c} of the vibrating body 22c on the conical vibrating cavity 21c is set to 3.6 μm, and the thickness t₂₃ of the fixed potential electrode protective film 23 on the vibrating body 22c is set to 6 μm, a transient response of voltage generation occurs. The parameters are displayed at positions ranging from the central region P₀ to the fourth peripheral region P₄, which serve as potential transmission areas. When a single-frequency sine wave with a maximum vibration amplitude of ±1 Pa is inputted to the voltage generating sections (22c, 24c) as shown on the left side of FIG. 8B, transient responses of pulse generation are observed in the central region P₀, the first peripheral region P₁, . . . , and the fourth peripheral region P₄, which serve as potential transmission areas. The second vibration amplitude reaches its maximum near approximately 0.13 μs, and the transient responses after the third time are decaying vibrations.

Specifically, in FIG. 8B, the transient response of the central voltage V_{P0} in the central part of the vibrating body 22c, represented by the thick solid line, shows a peak amplitude of approximately +0.61 μV during the first vibration after approximately 0.06 μs following the pulse input. Compared to the peak amplitude of the first vibration, the peak amplitude of the second vibration, occurring after approximately 0.13 μs, is approximately −1.0 μV, reaching the maximum amplitude value. Subsequently, the peak amplitude of the third vibration, occurring after approximately 0.19 μs, is approximately +0.63 μV, and the peak amplitude of the fourth vibration, occurring after approximately 0.26 μs, decays to approximately −0.5 μV. The transient response of the first peripheral voltage V_{P1}, represented by the thick dashed line in FIG. 8B, shows a peak amplitude of approximately +0.42 μV during the first vibration after approximately 0.06 μs following the pulse input. Compared to the peak amplitude of the first vibration, the peak amplitude of the second vibration, occurring after approximately 0.13 μs, is approximately −0.74 μV, reaching the maximum amplitude value. However, the absolute amplitude value |V_{P1}| of the first peripheral voltage V_{P1} is smaller than the absolute amplitude value |V_{P0}| of the central voltage V_{P0}. Subsequently, the peak amplitude of the third vibration of the first peripheral voltage V_{P1}, occurring after approximately 0.19 μs, is approximately +0.45 μV, and the peak amplitude of the fourth vibration, occurring after approximately 0.26 μs, decays to approximately −0.38 μV. The peak amplitudes of vibrations after the fifth time decrease, so further explanations are omitted.

In FIG. 8B, the absolute amplitude value |V_{P2}| of the second peripheral voltage V_{P2}, represented by the dashed line, is slightly smaller than the absolute amplitude value |V_{P1}| of the first peripheral voltage V_{P1}, ranking as the third value. Additionally, the absolute amplitude value |V_{P3}| of the third peripheral voltage V_{P3}, depicted by the thin solid line in FIG. 8B, is slightly smaller than the absolute amplitude value |V_{P2}| of the second peripheral voltage V_{P2}, ranking as the fourth value.

Moreover, the transient response of the fourth peripheral voltage V_{P4}, represented by the dashed-dotted line in FIG. 8B, exhibits a peak amplitude of approximately +0.28 μV after approximately 0.06 μs of the first vibration. Compared to the peak amplitude of the first vibration, the peak amplitude of the second vibration after approximately 0.13 μs is approximately −0.5 μV reaching the maximum amplitude value. However, the absolute amplitude value |V_{P4}| of the fourth peripheral voltage V_{P4} is smaller than the absolute amplitude values |V_{P0}| to |V_{P3}| of the central voltage V_{P0} to the third peripheral voltage V_{P3}, and is the smallest value. Additionally, the central voltage V_{P0} to the fourth peripheral voltage V_{P4} are all in the same phase relationship. Therefore, the relationship between the absolute values of the potentials generated on the output surface of the vibrating body 22c is the same as that given by Equation (11), exhibiting a position-dependent potential distribution with a magnitude relationship.

### M-Shaped

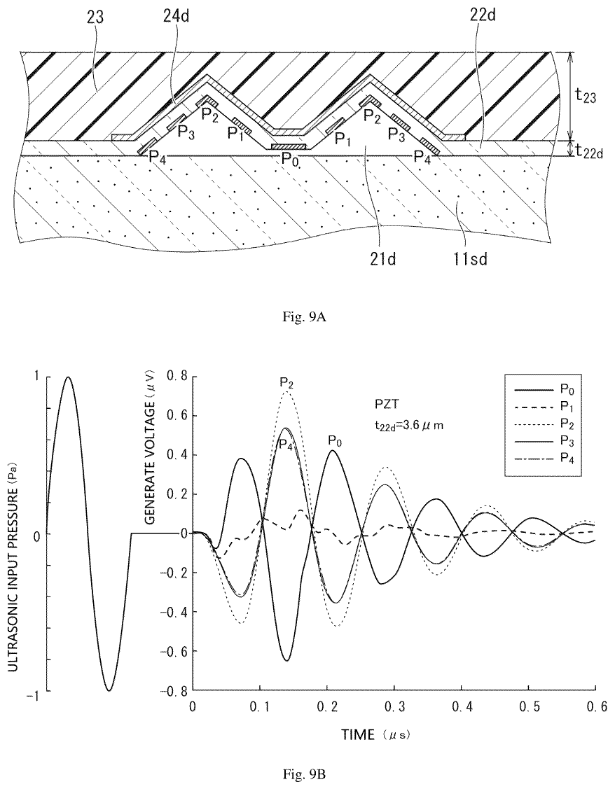

Next, as shown in FIG. 9A, the voltage distribution on the output surface of the vibrating body 22d with an M-shaped cross-sectional structure is studied for each position, serving as the foundation for enhancing sensitivity and broadening bandwidth. The vibrating body 22d is arranged on the silicon substrate 11sd, with a fixed potential electrode 24d grounded arranged on the vibrating body 22d, and a fixed potential electrode protective film 23 made of resin arranged on the fixed potential electrode 24d. Due to the M-shaped cross-sectional structure, the vibrating body 22d has a conical shape with a downward taper at the central part, and an upward taper surrounding the conical shape. Moreover, the lower end of the conical shape in the central part of the M-shaped vibrating body 22d is close to the surface of the silicon substrate 11_{sd}, with both sides of the bottom contacting the surface of the silicon substrate 11_{sd}. Therefore, two spaces with approximately isosceles triangular cross-sections are provided on the silicon substrate 11_{sd}, forming an inclined toroidal vibrating cavity 21d in a mirror-symmetrical manner. Additionally, to verify the generated voltage distribution, one circular potential detection ideal electrode is arranged at the lower end of the conical shape in the central part of the M-shaped vibrating body 22d, and four concentric ring-shaped potential detection ideal electrodes are arranged around the central part of the potential detection ideal electrode, defining the potential transfer area as the central region P₀, the first peripheral region P₁, . . . , the fourth peripheral region P₄. By verifying the transient response of the voltage generated in the central region P₀, the first peripheral region P₁, . . . , the fourth peripheral region P₄, the voltage distribution on the output surface (lower surface) of the vibrating body 22d is simulated.

FIG. 9B presents the simulation results when the entire vibrating body 22d is made of PZT. When the thickness t_{22d} of the vibrating body 22d on the inclined annular vibrating cavity 21d is set to 3.6 μm, and the thickness t₂₃ of the fixed potential electrode protective film 23 on the vibrating body 22d is set to 6 μm, a transient response of voltage generation occurs. This transient response is displayed with parameters in the potential transfer regions, namely the central region P₀, the first peripheral region P₁, . . . , and the fourth peripheral region P₄. When a single-frequency sine wave with a maximum vibration amplitude of ±1 Pa is inputted to the voltage generating sections (22d, 24d) as shown on the left side of FIG. 9B, the transient responses of the pulse responses generated in the potential transfer regions, namely the central region P₀, the first peripheral region P₁, . . . , and the fourth peripheral region P₄, exhibit a second-order vibration amplitude reaching its maximum near approximately 0.13 μs, followed by decaying vibrations in the third and subsequent orders.

Specifically, the transient response of the central voltage V_{P0} in the central part of the vibrator 22d, represented by the thick solid line in FIG. 9B, exhibits a peak amplitude of approximately +0.38 μV during the first vibration after approximately 0.06 μs following the pulse input. Compared to the peak amplitude of the first vibration, the peak amplitude of the second vibration, occurring after approximately 0.13 μs, is approximately −0.65 μV, reaching the maximum amplitude value. Subsequently, the peak amplitude of the third vibration, occurring after approximately 0.19 μs, is approximately +0.4 μV, and the peak amplitude of the fourth vibration, occurring after approximately 0.26 μs, decays to approximately −0.35 μV. The peak amplitudes of vibrations after the fifth time decrease, and thus are omitted for explanation. The transient response of the first peripheral voltage V_{P1}, represented by the thick dashed line in FIG. 9B, undergoes irregular changes after the pulse input, reaching a peak after approximately 0.13 μs. The absolute value of the amplitude |V_{P1}| of the first peripheral voltage V_{P1} is smaller than any of the absolute values of the amplitudes |V_{P0}|, |V_{P2}|, and |V_{P4}| of the central voltage V_{P0} and the second to fourth peripheral voltages V_{P2} to V_{P4}, indicating that it is the smallest value.

The transient response of the second peripheral voltage V_{P2}, represented by the dashed line in FIG. 9B, shows a peak amplitude of approximately 0.42 μV after approximately 0.06 μs following the pulse input. Compared to the peak amplitude of the first oscillation, the peak amplitude of the second oscillation after approximately 0.13 μs is approximately +0.65 μV, reaching the maximum amplitude value. Subsequently, the peak amplitude of the third oscillation after approximately 0.19 μs is approximately −0.44 μV, and the peak amplitude of the fourth oscillation after approximately 0.26 μs decays to approximately +0.35 μV. The peak amplitude of the fifth and subsequent oscillations decreases, so the explanation is omitted. The absolute amplitude value |V_{P2}| of the second peripheral voltage V_{P2} is approximately the same as the absolute amplitude value |V_{P0}| of the central voltage V_{P0}, which is the maximum value. Additionally, the transient response of the third peripheral voltage V_{P3}, represented by the thin solid line in FIG. 9B, exhibits a peak amplitude of approximately 0.3 μV during the first oscillation after approximately 0.06 μs following the pulse input. Compared to the peak amplitude of the first oscillation, the peak amplitude of the second oscillation, occurring after approximately 0.13 μs, is approximately +0.5 μV, reaching the maximum amplitude value. Subsequently, the peak amplitude of the third oscillation, occurring after approximately 0.19 μs, is approximately −0.4 μV, and the peak amplitude of the fourth oscillation, occurring after approximately 0.26 μs, decays to approximately +0.24 μV. The peak amplitudes of the oscillations after the fifth time decrease, so further explanations are omitted.

Moreover, the transient response of the fourth peripheral voltage V_{P4}, represented by the dashed-dotted line in FIG. 9B, exhibits a peak amplitude of approximately 0.3 μV after approximately 0.06 μs of the first vibration. Compared to the peak amplitude of the first vibration, the peak amplitude of the second vibration after approximately 0.13 μs is approximately +0.5 μV, reaching the maximum amplitude value. The absolute amplitude value |V_{P4}| of the fourth peripheral voltage V_{P4} is roughly the same as the absolute amplitude value |V_{P3}| of the third peripheral voltage V_{P3}. However, the absolute amplitude value |V_{P4}| of the fourth peripheral voltage V_{P4} is smaller than the absolute amplitude value |V_{P0}| of the central voltage V_{P0} and the absolute amplitude value |V_{P2}| of the second peripheral voltage V_{P2}. Additionally, the second peripheral voltage V_{P2} to the fourth peripheral voltage V_{P4} vibrate in a phase relationship with each other, and they vibrate in an anti-phase relationship with the central voltage V_{P0}. Therefore, the relationship between the absolute values of the potentials generated on the output surface of the vibrating body 22d is as follows:

$$\vert {V}_{P 0} \vert \approx \vert {V}_{P 2} \vert > \vert {V}_{P 3} \vert \approx \vert {V}_{P 4} \vert > \vert {V}_{P 1} \vert \qquad ( 13 )$$

Exhibit a potential distribution with position-dependent magnitude relationships.

### W-Shaped

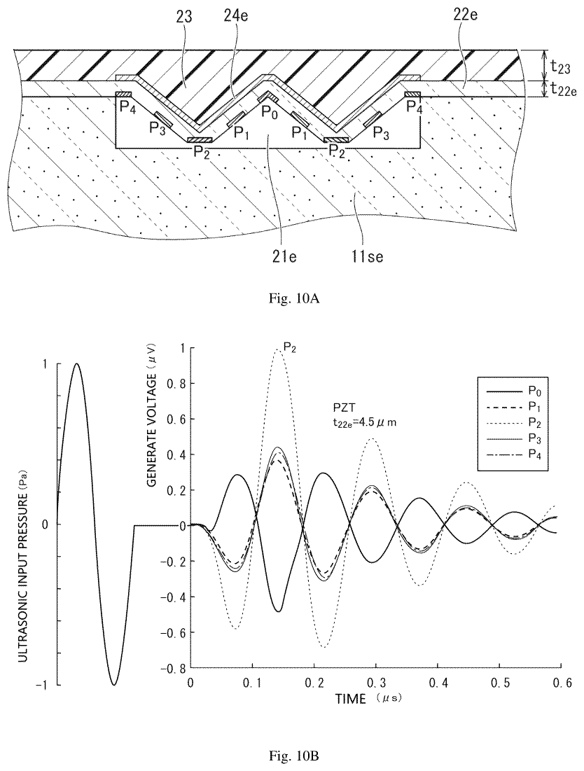

Next, as shown in FIG. 10A, the voltage distribution on the output surface of the vibrating body 22e, which has a W-shaped cross-sectional structure, is studied at each position, serving as the foundation for enhancing sensitivity and broadening bandwidth. The vibrating body 22e is arranged on a silicon substrate 11ₛₑ with a cylindrical recess. A fixed potential electrode 24e grounded is arranged on the vibrating body 22e, and a fixed potential electrode protective film 23 made of resin is arranged on the fixed potential electrode 24e. Due to the W-shaped cross-sectional structure, the vibrating body 22e has a conical shape that tapers upward at the central part of the W-shape. Moreover, around the conical space in the central part of the W-shape, there is a downward-tapering protrusion that surrounds the conical shape in a circular ring shape. In the cross-sectional structure, an inclined toroidal structure represented by two downward-tapering inverted triangles on both sides of the triangular space in the central part of the W shape is formed. Additionally, the lower end of the downward-tapering protrusion, which is approximately halfway from the central part to the radial direction of the vibrating cavity 21e, is close to the surface of the silicon substrate 11ₛₑ.

Therefore, on the concave portion of the silicon substrate 11ₛₑ, a conical vibration cavity 21e is provided in the central part, and another part of the vibration cavity 21e with a right-angled triangular cross-section is provided at the end. Additionally, to verify the generated voltage distribution, a circular potential detection ideal electrode is arranged at the upper tip of the conical shape in the central part of the W-shaped vibrator 22e, and a concentric ring-shaped potential detection ideal electrode is arranged around the central potential detection ideal electrode, defining the potential transmission areas as the central region P₀ and the first peripheral region P₁ (refer to Table 2). Furthermore, a concentric ring-shaped potential detection ideal electrode is arranged at the lower end of the downward-pointing protrusion around the conical shape in the central part of the W-shaped vibrator 22e, which is defined as the second peripheral region P₂.

Furthermore, on the inclined surface of the vibrating body 22e exposed in the vibrating cavity 21e surrounding the second peripheral region P₂, a concentric circular ring-shaped potential detection ideal electrode surrounding the second peripheral region P₂ is arranged, which is defined as the third peripheral region P₃. Then, on the lower surface of the vibrating body 22e at the outermost circumference of the vibrating cavity 21e, a concentric circular ring-shaped potential detection ideal electrode surrounding the third peripheral region P₃ is arranged, which is defined as the fourth peripheral region P₄. Subsequently, by verifying the transient response of the voltage generated in the potential transmission areas, namely the central region P₀, the first peripheral region P₁, . . . , and the fourth peripheral region P₄, the voltage distribution on the output surface (lower surface) of the vibrating body 22e is simulated.

FIG. 10B shows the simulation results when PZT is used throughout the entire vibrator 22e. When the thickness of the vibrator 22e is t₂₂ₑ=4.5 μm and the thickness of the fixed potential electrode protective film 23 on the vibrator 22e is t₂₃=6 μm, a transient response of voltage generation occurs, which is displayed with the positions of the potential transfer regions, namely the central region P₀, the first peripheral region P₁, . . . , and the fourth peripheral region P₄, as parameters. When a single-frequency sine wave with a maximum vibration amplitude of ±1 Pa is input to the voltage generation sections (22e, 24e) as shown on the left side of FIG. 10B, the transient responses of the pulse responses generated in the potential transfer regions, namely the central region P₀, the first peripheral region P₁, . . . , and the fourth peripheral region P₄, exhibit a second-order vibration amplitude reaching its maximum near approximately 0.13 μs, followed by decaying vibrations in the third and subsequent orders.

Specifically, in FIG. 10B, the transient response of the second peripheral voltage V_{P2} in the second peripheral region P₂, indicated by the dashed line, shows a peak amplitude of approximately 0.6 μV after approximately 0.06 μs following the pulse input. Compared to the peak amplitude of the first vibration, the peak amplitude of the second vibration after approximately 0.13 μs is approximately +0.98 μV, reaching the maximum amplitude value.

Subsequently, the peak amplitude of the third vibration after approximately 0.19 μs is approximately −0.68 μV, and the peak amplitude of the fourth vibration after approximately 0.26 μs decays to approximately +0.45 μV. The peak amplitude of vibrations after the fifth time decreases, so the explanation is omitted. The absolute amplitude value |V_{P2}| of the second peripheral voltage V_{P2} is larger than any of the absolute amplitude values |V_{P0}|, |V_{P1}|, |V_{P3}|, and |V_{P4}| of the central voltage V_{P0}, the first peripheral voltage V_{P1}, the third peripheral voltage V_{P3}, and the fourth peripheral voltage V_{P4}, respectively, and is the largest value.

The transient response of the central voltage V_{P0} in the central region P₀, represented by the thick solid line in FIG. 10B, shows a peak amplitude of approximately +0.28 μV after approximately 0.06 μs following the pulse input. Compared to the peak amplitude of the first vibration, the peak amplitude of the second vibration after approximately 0.13 μs is approximately −5.0 μV, reaching the maximum amplitude value. Subsequently, the peak amplitude of the third vibration after approximately 0.19 μs is approximately +0.28 μV, and the peak amplitude of the fourth vibration after approximately 0.26 μs decays to approximately −0.22 μV. The peak amplitude of vibrations after the fifth time decreases, so the explanation is omitted. The central voltage V_{P0} is in an anti-phase relationship with the second peripheral voltage V_{P2}, and its absolute amplitude |V_{P0}| is second only to the absolute amplitude |V_{P2}| of the second peripheral voltage V_{P2}, making it the second largest.

The transient response of the third peripheral voltage V_{P3}, represented by the thin solid line in FIG. 10B, exhibits a peak amplitude of approximately 0.26 μV during the first oscillation after approximately 0.06 μs following the pulse input. Compared to the peak amplitude of the first oscillation, the peak amplitude of the second oscillation, occurring after approximately 0.13 μs, is approximately +0.4 μV, reaching the maximum amplitude value. Subsequently, the peak amplitude of the third oscillation, occurring after approximately 0.19 μs, is approximately −0.32 μV, and the peak amplitude of the fourth oscillation, occurring after approximately 0.26 μs, decays to approximately +0.18 μV. The peak amplitudes of the fifth and subsequent oscillations decrease, hence the explanation is omitted. The third peripheral voltage V_{P3} is the third largest value.

In FIG. 10B, the absolute amplitude |V_{P4}| of the fourth peripheral voltage V_{P4}, represented by the dashed-dotted line, is slightly smaller than that of the third peripheral voltage V_{P3}, ranking as the fourth largest value. Additionally, the absolute amplitude |V_{P1}| of the first peripheral voltage V_{P1}, indicated by the thick dashed line in FIG. 10B, is slightly smaller than the absolute amplitude |V_{P4}| of the fourth peripheral voltage V_{P4}, representing the smallest value. Furthermore, in the potential transfer region, specifically from the first peripheral region P₁ to the fourth peripheral region P₄, the first peripheral voltage V_{P1} to the fourth peripheral voltage V_{P4} vibrate in a phase-aligned relationship with each other, and they vibrate in an anti-phase-aligned relationship with the central voltage V_{P0} in the central region P₀. Therefore, in the case of a W-shaped stress distribution reinforcement structure, the relationship between the absolute values of the potentials generated on the output surface of the vibrating body 22e is as follows:

$$\vert {V}_{P 2} \vert > \vert {V}_{P 0} \vert > \vert {V}_{P 3} \vert > \vert {V}_{P 4} \vert > \vert {V}_{P 1} \vert \qquad ( 14 )$$

Exhibit a potential distribution with position-dependent magnitude relationships.

### Flat Disc-Shaped Conventional Structure (Traditional Structure)

Finally, for comparison purposes, as shown in FIG. 11A, in the case of a conventional flat disk-type structure (non-enhanced stress distribution structure) with a parallel flat plate cross-section in the vibration cavity formed by the vibrator 22f, the voltage distribution generated on the output surface of the vibrator 22f was simulated for each position. FIG. 11B shows the simulation results when using PZT as the vibrator 22f, while FIGS. 11C and 11D show the simulation results when using AlN. As shown in FIG. 11A, the voltage generation section (22f, 24f) of the conventional flat disk-type structure consists of the vibrator 22f forming a uniform flat plane, the fixed potential electrode 24f grounded above the vibrator 22f, and the fixed potential electrode protective film 23 made of epoxy resin above the fixed potential electrode 24f. Additionally, the voltage generation section (22f, 24f) is arranged on a silicon substrate 11sf with a recess. The receiving surface and output surface of the vibrator 22f, which face each other, together form an Euclidean plane with Gaussian curvature and average curvature always being zero on the recess of the silicon substrate 11_{sf}. Therefore, a thin cylindrical (disk-shaped) vibration cavity 21f is formed on the recess of the silicon substrate 11_{sf}, and the cross-sectional structure of the vibration cavity 21f is a parallel flat plate structure with a certain thickness and parallel receiving and output surfaces.

In the stress distribution non-enhanced structure, to verify the generated voltage distribution, as shown in FIG. 11A, one disc-shaped potential detection ideal electrode is arranged at the central part of the lower surface of the vibrating body 22f, and four concentric ring-shaped potential detection ideal electrodes are arranged around the central potential detection ideal electrode. In the stress distribution non-enhanced structure, as defined in Table 2, the disc and four concentric rings are numbered sequentially from the center as P₀, P₁, . . . , P₄, and the potential transfer areas are defined as the central area P₀, the first peripheral area P₁, . . . , and the fourth peripheral area P₄.

FIG. 11B presents the simulation results of the stress distribution non-enhanced structure of the vibrator 22f, where PZT is used throughout. When the thickness of the vibrator 22f is t_{22f}=5 μm and the thickness of the fixed potential electrode protective film 23 is t₂₃=6 μm, a transient response of voltage generation occurs, displayed with parameters at the potential transfer regions, namely the central region P₀, the first peripheral region P₁, . . . , and the fourth peripheral region P₄. When a single-frequency sine wave ultrasonic wave with a maximum vibration of ±1 Pa is input to the voltage generation section (22f, 24f) as shown on the left side of FIG. 11B, the voltage signals generated in the potential transfer regions, namely the central region P₀, the first peripheral region P₁, . . . , and the fourth peripheral region P₄, exhibit a transient response where the amplitude of the second vibration reaches its maximum near approximately 0.13 μs, and subsequent vibrations are attenuated.

The first peripheral voltage V_{P1}, represented by the thick dashed line in FIG. 11B, reaches its peak amplitude of approximately +0.12 μV after approximately 0.06 μs following the input of the ultrasonic pulse. After the peak amplitude of the first vibration, the peak amplitude of the second vibration, occurring approximately 0.13 μs later, is approximately −0.22 μV, reaching the maximum amplitude value. After that, the third peak of vibration amplitude occurred approximately 0.19 μs later, with a value of about +0.15 μV. The fourth peak of vibration amplitude decayed to approximately −0.12 μV after about 0.26 μs. The vibration amplitude decreased after the fifth time, so further explanations are omitted. The first peripheral voltage V_{P1} is larger than the other central voltage V_{P0}, as well as the second peripheral voltage V_{P2} to the fourth peripheral voltage V_{P4}, and is the largest value.

The second peripheral voltage V_{P2}, indicated by the dashed line in FIG. 11B, reaches its peak amplitude of approximately +0.1 μV after approximately 0.06 μs following the input of the ultrasonic pulse during the first vibration. After the peak amplitude of the first vibration, the peak amplitude of the second vibration, occurring approximately 0.13 μs later, is approximately −0.16 μV, reaching the maximum amplitude value. Subsequently, the peak amplitude of the third vibration, occurring approximately 0.19 μs later, is approximately +0.11 μV, and the peak amplitude of the fourth vibration, occurring approximately 0.26 μs later, decays to approximately −0.08 μV. The amplitude of vibrations decreases after the fifth time, so further explanations are omitted. The second peripheral voltage V_{P2} is in phase with the first peripheral voltage V_{P1}, and the absolute amplitude value |V_{P2}| of the second peripheral voltage V_{P2} is the second largest after the absolute amplitude value |V_{P1}| of the first peripheral voltage V_{P1}.

The third peripheral voltage V_{P3}, represented by the thin solid line in FIG. 11B, reaches its peak amplitude of approximately +0.06 μV after approximately 0.06 μs following the input of the ultrasonic pulse during its first vibration. After the peak amplitude of the first vibration, the peak amplitude of the second vibration, occurring approximately 0.13 μs later, is approximately −0.1 μV, reaching its maximum amplitude value. Subsequently, the peak amplitude of the third vibration, occurring approximately 0.19 μs later, is approximately +0.06 μV, and the peak amplitude of the fourth vibration, occurring approximately 0.26 μs later, decays to approximately −0.05 μV. The amplitude of the vibrations decreases after the fifth time, so further explanations are omitted. The third peripheral voltage V_{P3} is the third largest value.

In FIG. 11B, the absolute amplitude |V_{P4}| of the fourth peripheral voltage V_{P4}, represented by the dashed-dotted line, is generally smaller than the absolute amplitudes |V_{P1}| to |V_{P3}| of the first to third peripheral voltages V_{P1} to V_{P3}, and it is the fourth largest value. Additionally, the absolute amplitude |V_{P0}| of the central voltage V_{P0}, represented by the thick solid line in FIG. 11B, is generally slightly smaller than the absolute amplitude |V_{P4}| of the fourth peripheral voltage V_{P4}, and it is the smallest. Furthermore, these central voltage V_{P0} to fourth peripheral voltage V_{P4} vibrate in a roughly in-phase relationship with each other. Therefore, in the case of using PZT as the vibrating body 22f and not actively enhancing the stress distribution in a conventional flat disk structure, the relationship of the absolute values of the potentials generated on the output surface of the vibrating body 22f is as follows:

$$\vert {V}_{P 1} \vert > \vert {V}_{P 2} \vert > \vert {V}_{P 3} \vert > \vert {V}_{P 4} \vert > \vert {V}_{P 0} \vert \qquad ( 15 )$$

It can be inferred that even for conventional structures with non-actively reinforced stress distribution as shown in FIG. 11A, there exists a position-dependent potential distribution.

FIG. 11C presents the simulation results of a conventional flat disk structure where the entire vibrator 22f is made of AlN. When the thickness of the vibrator 22f is t_{22f}=0.2 μm and the thickness of the fixed potential electrode protective film 23 is t₂₃=3 μm, a transient response of voltage generation occurs, which is displayed with parameters indicating the positions of the potential transfer region, namely the central region P₀, the first peripheral region P₁, . . . , and the fourth peripheral region P₄. When an ultrasonic wave vibrating at a maximum of ±1 Pa is input to the voltage generating sections (22f, 24f) as shown on the left side of FIG. 11C, the voltage signals generated in the central region P₀, the first peripheral region P₁, . . . , and the fourth peripheral region P₄, respectively, exhibit a transient response similar to that in FIG. 11B, where the amplitude of the second vibration reaches its maximum near approximately 0.13 μs, and subsequent vibrations are decaying vibrations.

The central voltage V_{P0}, represented by the thick solid line in FIG. 11C, reaches its peak amplitude of approximately −0.57 μV after approximately 0.06 μs following the input of the ultrasonic pulse. After the peak amplitude of the first vibration, the peak amplitude of the second vibration, occurring approximately 0.13 μs later, is approximately +0.9 μV, reaching the maximum amplitude value. Subsequently, the peak amplitude of the third vibration, occurring approximately 0.19 μs later, is approximately −0.48 μV, and the peak amplitude of the fourth vibration, occurring approximately 0.26 μs later, decays to approximately +0.28 μV. The amplitude of vibrations after the fifth time decreases, so further explanations are omitted. The absolute amplitude value |V_{P0}| of the central voltage V_{P0} is larger than the absolute amplitude values |V_{P1}| to |V_{P3}| of the other first peripheral voltage V_{P1} to fourth peripheral voltage V_{P4}, and is the largest value.

The first peripheral voltage V_{P1}, indicated by the thick dashed line in FIG. 11C, reaches its peak amplitude of approximately −0.42 μV after approximately 0.06 μs following the input of the ultrasonic pulse. After the peak amplitude of the first vibration, the peak amplitude of the second vibration, approximately 0.13 μs later, is approximately +0.7 μV, reaching the maximum amplitude value. Subsequently, the peak amplitude of the third vibration, approximately 0.19 μs later, is approximately −0.4 μV, and the peak amplitude of the fourth vibration, approximately 0.26 μs later, decays to approximately +0.22 μV The vibration amplitude decreases after the fifth time, so the explanation is omitted. The first peripheral voltage V_{P1} is in a phase relationship with the central voltage V_{P0}, and the absolute value of the amplitude |V_{P1}| of the first peripheral voltage V_{P1} is the second largest after the absolute value of the amplitude |V_{P0}| of the central voltage V_{P0}.

The fourth peripheral voltage V_{P4}, represented by a dashed-dotted line in FIG. 11C, reaches its peak amplitude of approximately +0.32 μV after approximately 0.06 μs following the input of the ultrasonic pulse during the first vibration. After the peak amplitude of the first vibration, the peak amplitude of the second vibration, occurring approximately 0.13 μs later, is approximately −0.46 μV, reaching the maximum amplitude value. Subsequently, the peak amplitude of the third vibration, occurring approximately 0.19 μs later, is approximately +0.25 μV, and the peak amplitude of the fourth vibration, occurring approximately 0.26 μs later, decays to approximately −0.16 μV. The vibration amplitude decreases after the fifth time, so further explanations are omitted. The fourth peripheral voltage V_{P4} is in an anti-phase relationship with the central voltage V_{P0} and the first peripheral voltage V_{P1}, and the absolute value of the amplitude |V_{P4}| is the third largest value.

The first peripheral voltage V_{P2}, represented by the dashed line in FIG. 11C, reaches its peak amplitude of approximately −0.2 μV after approximately 0.06 μs following the input of the ultrasonic pulse during the first vibration. After the peak amplitude of the first vibration, the peak amplitude of the second vibration, occurring approximately 0.13 μs later, is approximately +0.34 μV, reaching the maximum amplitude value. Subsequently, the peak amplitude of the third vibration, occurring approximately 0.19 μs later, is approximately −0.18 μV, and the peak amplitude of the fourth vibration, occurring approximately 0.26 μs later, decays to approximately +0.12 μV. The vibration amplitude decreases after the fifth time, so further explanations are omitted. The second peripheral voltage V_{P2} is in phase with the central voltage V_{P0} and the first peripheral voltage V_{P1}, and is in antiphase with the fourth peripheral voltage V_{P4}. The absolute value of the amplitude V_{P2}| is the fourth largest value.

In FIG. 11C, the absolute amplitude |V_{P3}| of the third peripheral voltage V_{P3}, represented by a thin solid line, is in a phase relationship with the fourth peripheral voltage V_{P4}, but overall, it is smaller than the absolute amplitude |V_{P4}| of the fourth peripheral voltage V_{P4} and is the smallest. Therefore, in the case of using AlN as the vibrating body 22f and not actively enhancing the stress distribution in a flat disk-shaped conventional structure, the relationship of the absolute potential generated on the output surface of the vibrating body 22f is as follows:

$$\vert {V}_{P 0} \vert > \vert {V}_{P 1} \vert > \vert {V}_{P 4} \vert > \vert {V}_{P 2} \vert > \vert {V}_{P 3} \vert \qquad ( 16 )$$

It can be inferred that even for conventional structures that do not actively enhance stress distribution, there exists a position-dependent potential distribution.

FIG. 11D, similar to FIG. 11C, presents the simulation results of a conventional flat disk structure where the entire vibrator 22f is made of AlN. The thickness t_{22f} of the vibrator 22f is 0.2 μm, which is the same as in FIG. 11C. The thickness t₂₃ of the fixed potential electrode protective film 23 is 6 μm, which is thicker than in FIG. 11C, resulting in a transient response of voltage generation. The transient response is displayed with parameters for the central region P₀, the first peripheral region P₁, . . . , and the fourth peripheral region P₄. When an ultrasonic wave vibrating at a maximum of ±1 Pa is input to the voltage generating sections (22f, 24f) as shown on the left side of FIG. 11D, the voltage signals generated in the central region P₀, the first peripheral region P₁, . . . , and the fourth peripheral region P₄ are similar to those in FIG. 11C, exhibiting a transient response where the amplitude of the second vibration reaches its maximum near approximately 0.13 μs, and subsequent vibrations are decaying vibrations.

The central voltage V_{P0}, represented by the thick solid line in FIG. 11D, reaches its peak amplitude of approximately −0.29 μV after approximately 0.06 μs following the input of the ultrasonic pulse. Following the peak amplitude of the first vibration, the peak amplitude of the second vibration, occurring approximately 0.13 μs later, is approximately +0.34 μV, reaching the maximum amplitude value. Subsequently, the peak amplitude of the third vibration, occurring approximately 0.19 μs later, is approximately −0.22 μV, and the peak amplitude of the fourth vibration, occurring approximately 0.26 μs later, decays to approximately +0.12 μV. The amplitude of vibrations after the fifth time decreases, so further explanations are omitted. The absolute amplitude value |V_{P0}| of the central voltage V_{P0} is larger than the absolute amplitude values |V_{P1}| to |V_{P4}| of the other first peripheral voltage V_{P1} to fourth peripheral voltage V_{P4}, and is the largest value.

In FIG. 11D, the first peripheral voltage V_{P1}, represented by the thick dashed line, reaches its peak amplitude of approximately −0.24 μV after about 0.06 μs following the input of the ultrasonic pulse. Following the peak amplitude of the first vibration, the peak amplitude of the second vibration, occurring approximately 0.13 μs later, is approximately +0.26 μV, reaching the maximum amplitude value. Subsequently, the peak amplitude of the third vibration, occurring approximately 0.19 μs later, is approximately −0.18 μV, and the peak amplitude of the fourth vibration, occurring approximately 0.26 μs later, decays to approximately +0.08 μV. The vibration amplitude decreases after the fifth time, so further explanations are omitted. The first peripheral voltage V_{P1} is in phase with the central voltage V_{P0}, and the absolute amplitude value |V_{P1}| of the first peripheral voltage V_{P1} is the second largest after the absolute amplitude value |V_{P0}| of the central voltage V_{P0}.

In FIG. 11D, the fourth peripheral voltage V_{P4}, represented by a dashed-dotted line, reaches its peak amplitude of approximately +0.17 μV during the first vibration approximately 0.06 μs after the input of the ultrasonic pulse. Following the peak amplitude of the first vibration, the peak amplitude of the second vibration, occurring approximately 0.13 μs later, is approximately −0.21 μV, reaching its maximum amplitude value. Subsequently, the peak amplitude of the third vibration, occurring approximately 0.19 μs later, is approximately +0.12 μV, and the peak amplitude of the fourth vibration, occurring approximately 0.26 μs later, decays to approximately −0.06 μV. The vibration amplitude decreases after the fifth time, so further explanations are omitted. The fourth peripheral voltage V_{P4} is in an anti-phase relationship with the central voltage V_{P0} and the first peripheral voltage V_{P1}, and the absolute value of its amplitude |V_{P4}| is the third largest value.

The second peripheral voltage V_{P2}, indicated by the dashed line in FIG. 11D, reaches its peak amplitude of approximately −0.12 μV after approximately 0.06 μs following the input of the ultrasonic pulse. After the peak amplitude of the first vibration, the peak amplitude of the second vibration approximately 0.13 μs later is approximately +0.15 μV, reaching the maximum amplitude value. Subsequently, the peak amplitude of the third vibration approximately 0.19 μs later is approximately −0.09 μV, and the peak amplitude of the fourth vibration approximately 0.26 μs later decays to approximately +0.05 μV. The vibration amplitude decreases after the fifth time, so the explanation is omitted. The second peripheral voltage V_{P2} is in phase with the central voltage V_{P0} and the first peripheral voltage V_{P1}, and is in antiphase with the fourth peripheral voltage V_{P4}. The absolute value of the amplitude |V_{P2}| is the fourth largest value.

In FIG. 11D, the absolute amplitude |V_{P3}| of the third peripheral voltage V_{P3}, represented by a thin solid line, is in phase with the fourth peripheral voltage V_{P4}, but overall, it is smaller than the absolute amplitude |V_{P4}| of the fourth peripheral voltage V_{P4} and is the smallest. Therefore, in the case where AlN is used for the flat disk-shaped common structure of the vibrating body 22f, even if the thickness t₂₃ of the fixed potential electrode protective film 23 increases, the absolute value relationship of the potential generated on the output surface of the vibrating body 22f is the same as in FIG. 11C, as shown in the size relationship in Equation (16). Therefore, even in a common structure that does not actively intend to enhance the stress distribution, as shown in FIG. 11A, it can be seen that there is a position-dependent potential distribution.

Comparison of Characteristics of Stress Distribution-enhanced Structures Focusing on the use of PZT as the piezoelectric layer, the voltage sensitivity and frequency bandwidth of the parallel annular stress distribution enhancement structure (T) shown in FIGS. 5A and 5B, the V-shaped stress distribution enhancement structures (V₁, V₂) shown in FIG. 7A, the Λ-shaped stress distribution enhancement structure (Λ) shown in FIG. 8A, the M-shaped stress distribution enhancement structure (M) shown in FIG. 9A, and the W-shaped stress distribution enhancement structure (W) shown in FIG. 10A were compared with the characteristics of the flat disc-type common structure (P), serving as the basis for achieving high sensitivity and broadband performance.

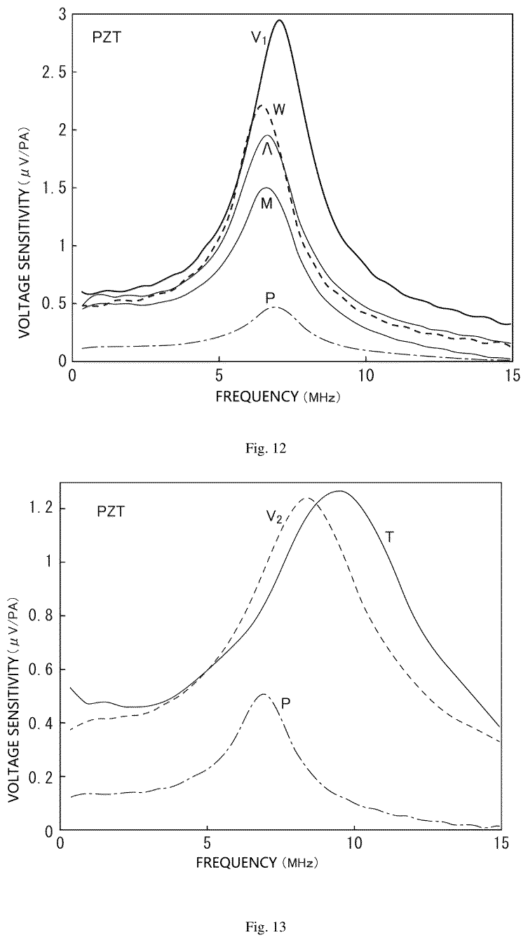

As shown in FIG. 12, within the frequency bandwidth of 5-10 MHz for receiving ultrasonic waves, the sensitivity curve represented by the thick solid line marked with V₁, indicating the V-shaped stress distribution enhancement structure, exhibits the highest maximum voltage sensitivity of approximately 2.9 μV/Pa. Next, the sensitivity curve represented by the dashed line marked with W, indicating the W-shaped stress distribution enhancement structure, exhibits the second highest maximum voltage sensitivity of approximately 2.2 μV/Pa. The sensitivity curve represented by the thin solid line marked with Λ, indicating the Λ-shaped stress distribution enhancement structure, exhibits the third highest maximum voltage sensitivity of approximately 1.9 μV/Pa. The sensitivity curve represented by the thin solid line marked with M, indicating the M-shaped stress distribution enhancement structure, exhibits the fourth highest maximum voltage sensitivity of approximately 1.4 μV/Pa. Compared to these stress enhancement structures, the traditional structure (flat disc-type common structure) represented by the dashed line marked with P exhibits the lowest maximum receiving sensitivity of approximately 0.4 μV/Pa.

As shown in FIG. 13, the maximum voltage sensitivity of the parallel annular stress distribution enhancement structure represented by the solid line marked with T, and the maximum voltage sensitivity of the V-shaped (inclined annular) stress distribution enhancement structure represented by the dashed line marked with V₂, both exhibit values slightly exceeding 1.2 μV/Pa, which are the highest. In contrast, the maximum voltage sensitivity of the traditional structure (flat disc-type common structure) represented by the dashed-dotted line marked with P is only slightly exceeding 0.4 μV/Pa, which is the lowest. The frequency characteristics of the sensitivity of the parallel annular stress distribution enhancement structure exhibit a wide frequency band exceeding 0.6 μV/Pa within the frequency bandwidth of 5-15 MHz. Although the frequency characteristics of the sensitivity of the V-shaped stress distribution enhancement structure are slightly narrower than those of the parallel annular stress distribution enhancement structure, they also exhibit a frequency band similar to that of the parallel annular stress distribution enhancement structure. On the other hand, it can be seen that the frequency characteristics of the sensitivity of the traditional structure (flat disc-type common structure) represented by the dashed-dotted line are very narrow compared to those of the parallel annular and V-shaped stress distribution enhancement structures.

### The First Variation of the First Embodiment

In FIG. 2, within the parallel annular stress distribution reinforcement structure, the hexagonal potential transfer region defined by the protrusion on the output surface side of the vibrator 22a1 is shown in the channel formed on the surface of the rectangular region sandwiched between the first main electrode region 15a and the second main electrode region 15b, illustrating an example of a single heterojunction FET structure. However, as shown in FIG. 14, in the acoustic element according to the first variation of the first embodiment, the buffer layer 13h is sandwiched between the vibrator 22a1 and the base region 14, forming a double heterojunction. As mentioned earlier, due to the good compatibility of AlN and GaN as heterojunctions, even when heteroepitaxially growing AlN as the vibrator 22a1 on the base region 14 composed of a GaN substrate, the interface energy level and lattice defects between GaN and AlN are relatively few. However, by inserting a Ga₁₋ₓAlₓN layer as the buffer layer 13h between GaN and AlN, the interface energy level and lattice defects between GaN and AlN can be further reduced. When epitaxially growing Ga₁₋ₓAlₓN with a longer bond length on the Ga face of GaN with c-axis orientation, due to the difference in lattice constants between the two, tensile strain is generated in Ga₁₋ₓAlₓN, and piezoelectric polarization is applied internally within Ga₁₋ₓAlₓN. GaN, as a polar crystal, also exhibits piezoelectric polarization. At the Ga₁₋ₓAlₓN/GaN heterojunction interface, due to the difference in work functions, like ordinary heterojunction FETs, a potential distribution is generated in the direction perpendicular to the interface, so as to bend the end band structures of the conduction band and valence band as one approaches the interface.

If GaN is set as the i-type and Ga₁₋ₓAlₓN is set as the n-type, two-dimensional electron gas will be generated at the interface of the Ga₁₋ₓAlₓN/GaN heterojunction. Additionally, the effects of both piezoelectric polarizations can coexist. Unlike conventional heterojunction FETs, the acoustic element according to the first variation of the first embodiment does not have a gate electrode. Despite the absence of a gate electrode, the Fermi level inside Ga₁₋ₓAlₓN, especially at the Ga₁₋ₓAlₓN/GaN heterojunction interface, vibrates due to ultrasonic input. Since there is no gate electrode in the acoustic element according to the first variation of the first embodiment, there is no need to connect the PMUT and FET through external wiring as described in Non-Patent Document 2, so there is no inherent floating impedance issue. Furthermore, due to the use of voltage generating sections (22a1, 24a) with stress-enhanced structures as shown in FIGS. 4A to 6C, the voltage generating sections (22a1, 24a) themselves achieve high sensitivity and broadband performance. Therefore, the acoustic element according to the first variation of the first embodiment can achieve high sensitivity and broadband performance. Specifically, by conducting microscopic research on the internal structure of the stress-enhanced structure, selecting a specific position on the output surface of the vibrator 22a1 that generates the highest voltage as the potential transfer region, and driving the active elements of the impedance conversion elements (14, 15a, 15b), high sensitivity can be easily achieved.

On the other hand, when heteroepitaxially growing GaN or AlN as the vibrating body 22a1 on the base region 14 composed of a Si substrate with a diamond-type crystal structure to constitute an acoustic element according to a first variation of the first embodiment, due to the lattice constant of Si being 0.543 nm, there is a significant lattice mismatch. When heteroepitaxially growing GaN or AlN as the vibrating body 22a1 using the base region 14 composed of a Si substrate, as shown in FIG. 14, it is necessary to set up a buffer layer 13h such as Ga₁₋ₓAlₓN to form a double heterojunction structure. When epitaxially growing polar crystal layers such as GaN or AlN on non-polar substrates such as Si, inversion of atomic arrangement phase may occur. This is due to the fact that whether the step of the substrate is composed of one atom or two atoms can lead to different atomic arrangements in polar crystals, known as “antiphase domains”. To prevent antiphase domains, it is preferable to use off-angle substrates.

When heteroepitaxially growing SiC, a polar crystal, as the vibrator 22a1 on the substrate region 14 composed of an Si substrate to form an acoustic element according to the first variation of the first embodiment, it is possible to carbonize the surface of the Si substrate with a hydrocarbon gas such as C₂H₄ and grow SiC as the buffer layer 13h. When carbonizing the Si surface, β-SiC (cubic crystal) will epitaxially grow. Alternatively, it is possible to form zincblende-type crystal boron phosphide (BP) as the buffer layer 13h on the substrate region 14 composed of an Si substrate, and heteroepitaxially grow SiC through the buffer layer 13h to form a double heterojunction. The structures other than the buffer layer 13h shown in FIG. 14 are redundant with those described in FIG. 2, so they are omitted.

### The Second Variation of the First Embodiment

Similar to the structure shown in FIG. 2, the acoustic element according to the second variation of the first embodiment shown in FIG. 15 also adopts a parallel annular stress distribution reinforcement structure. As shown in FIG. 15, the first main electrode distribution line 25a is connected to the first main electrode region 15a, and the second main electrode distribution line 25b is connected to the second main electrode region 15b, through contact holes drilled in the interlayer insulating film 17 provided on the first main electrode region 15a and the second main electrode region 15b. In FIG. 15, the first main electrode distribution line 25a is led out to the left side through the element isolation insulating film 16, and the second main electrode distribution line 25b is led out to the right side through the element isolation insulating film 16. In the acoustic element according to the second variation of the first embodiment, the structure above the first main electrode distribution line 25a and the second main electrode distribution line 25b, which is covered by the cavity inner wall protective film 19, differs from the structure shown in FIG. 2. Through the cavity inner wall protective film 19, the protrusion on the output surface side of the vibrator 22a1 reaches the upper surface of the base region 14, and the potential transfer region of the vibrator 22a1 heterojunctions with the upper surface of the base region 14. The structures other than the cavity inner wall protective film 19 shown in FIG. 15 are redundant with those described in FIG. 2, and thus omitted.

Since there is no gate electrode in the acoustic element according to the second variation of the first embodiment, the issue of floating impedance, as described in Non-Patent Document 2, does not exist. Furthermore, due to the adoption of the voltage generation sections (22a1, 24a) with stress reinforcement structures as shown in FIGS. 4A to 6C, the voltage generation sections (22a1, 24a) themselves achieve high sensitivity and broadband performance. Consequently, the acoustic element according to the second variation of the first embodiment can achieve high sensitivity and broadband performance. Specifically, through microscopic examination of the internal structure of the stress reinforcement structure, a specific position on the output surface of the vibrator 22a1 that generates the highest voltage is selected as the potential transfer region, and the active elements of the impedance conversion elements (14, 15a, 15b) are driven. Therefore, high sensitivity is easily achieved.

### Manufacturing Method of Acoustic Element According to the Second Variation of the First Embodiment

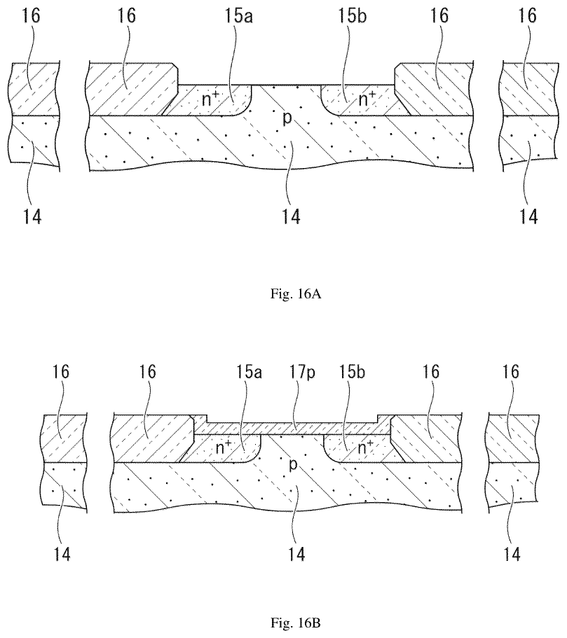

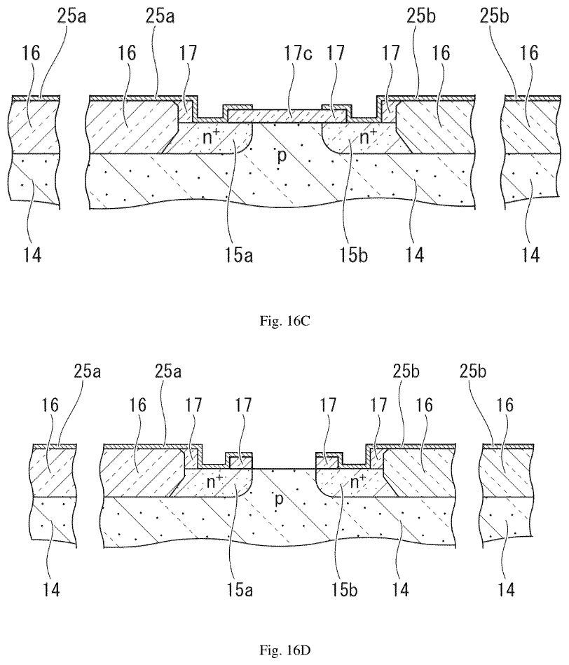

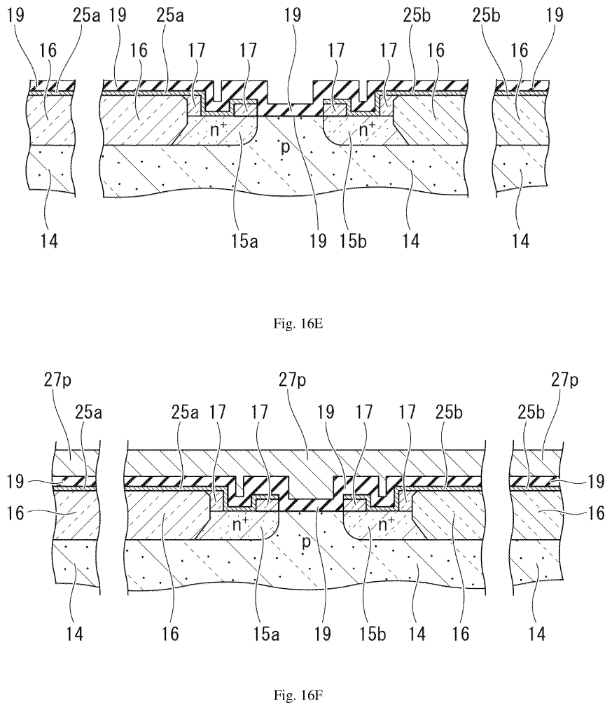

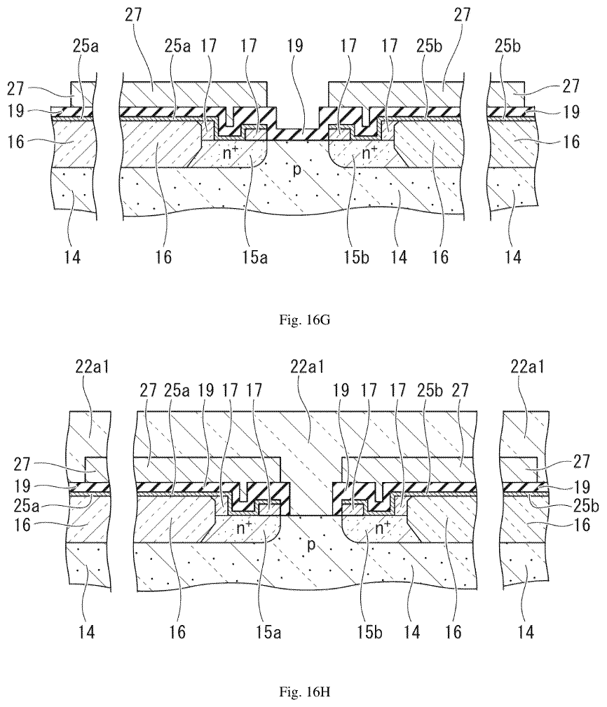

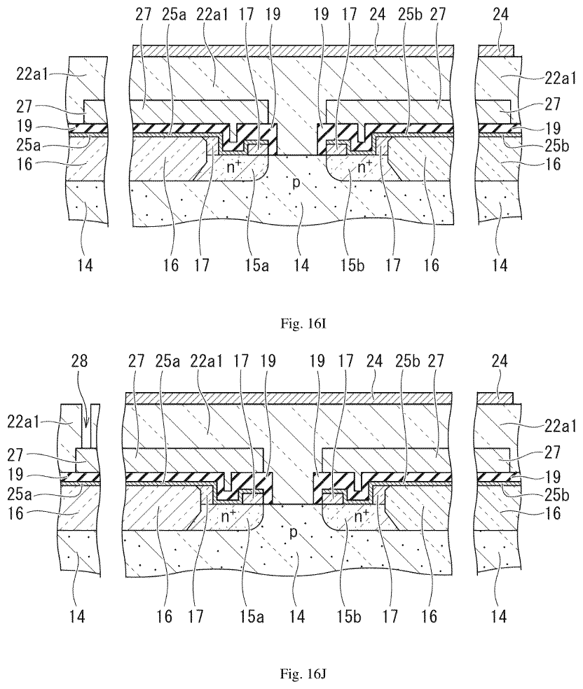

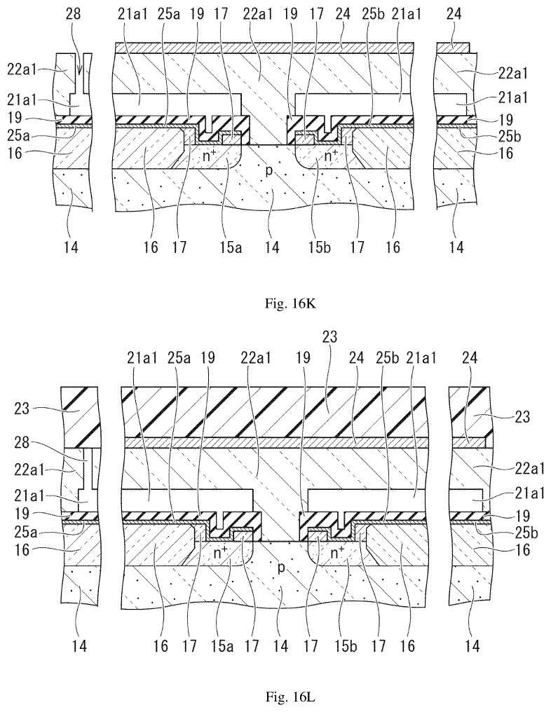

Using FIGS. 16A to 16R, we will illustrate the manufacturing method of the acoustic element according to the second variation of the first embodiment shown in FIG. 15. It should be noted that the manufacturing method of the acoustic element described below is merely an example. As long as the structure described in the claims can be achieved, it can certainly be realized through various other manufacturing methods. Additionally, the use of names with ordinal numbers such as “first photoresist film” in the following description is merely a rhetorical device used to distinguish it from other photoresist films, and does not imply that it is the first photoresist film used in the actual process. In fact, processing using a photoresist film is usually already implemented at a stage prior to the structure shown in FIG. 16A.

(a) Firstly, prepare a substrate region 14 composed of a p-type silicon substrate with a (100) plane as the main surface and a resistivity of 0.1-10 Ωcm. Then, using known LOCOS or STI technology, form an element isolation insulating film 16 such as a silicon oxide film to a thickness of approximately 0.5-1.2 μm. Inside the pattern of the active region surrounded by the element isolation insulating film 16, form n⁺-type first main electrode regions 15a and second main electrode regions 15b as shown in FIG. 16A, with a cross-sectional structure facing each other. An example of the planar pattern of the first main electrode region 15a and the second main electrode region 15b can be a rectangular pattern as shown in FIG. 2. Afterwards, an ion implantation process for MOSFET threshold control can be added as needed.

(b) Then, on the first main electrode region 15a, the second main electrode region 15b, and the substrate region 14 exposed between the first main electrode region 15a and the second main electrode region 15b, as shown in FIG. 16B, a first insulating film 17p, such as a silicon oxide film, with a thickness of approximately 10-250 nm is deposited by a deposition method such as CVD. When the substrate region 14 is made of Si, thermal oxidation can also be used. After depositing the first insulating film 17p by CVD or other methods, it is planarized using chemical mechanical polishing (CMP) or other methods until the upper surface of the element isolation insulating film 16 is exposed, as shown in FIG. 16B. Afterwards, a first photoresist film is coated on the first insulating film 17p, and the first photoresist film is exposed and developed using lithography technology to form a first etching mask for opening contact holes. Using the first etching mask, the first insulating film 17p is selectively etched by dry etching techniques such as reactive ion etching (RIE), as shown in FIG. 16F, to open contact hole patterns in the upper portions of the first main electrode region 15a and the second main electrode region 15b. Hereinafter, the first insulating film 17p with contact holes is referred to as the “interlayer insulating film 17”.

(c) Furthermore, on the first insulating film 17p, a first conductor film composed of a doped polysilicon (DOPOS) film or a conductor layer such as a high-melting-point metal is deposited on the entire surface with a thickness of approximately 80-200 nm by a deposition method such as CVD. A second photoresist film is coated on the first conductor film, and the second photoresist film is exposed and developed using lithography technology to form a second etching mask for patterning the first main electrode distribution line 25a and the second main electrode distribution line 25b. Using the second etching mask, the first conductor film is selectively etched by a dry etching technique such as RIE, as shown in FIG. 16C, to form patterns of the first main electrode distribution line 25a connected to the first main electrode region 15a and patterns of the second main electrode distribution line 25b connected to the second main electrode region 15b. In FIG. 16C, the interlayer insulating film 17 exposed between the first main electrode distribution line 25a and the second main electrode distribution line 25b is defined as the “channel protection insulating film 17c”.

(d) Then, a third photoresist film is coated on the channel protection insulating film 17c, the first main electrode power distribution line 25a, and the second main electrode power distribution line 25b. The third photoresist film is exposed and developed using lithography technology to form a third etching mask for exposing the upper part of the channel. Using the third etching mask, the channel protection insulating film 17c is selectively etched through dry etching techniques such as RIE, as shown in FIG. 16D, to open a contact hole pattern on the upper surface of the substrate region 14 between the first main electrode region 15a and the second main electrode region 15b.

(e) Then, on the exposed substrate region 14 between the first main electrode distribution line 25a and the second main electrode distribution line 25b, as well as between the first main electrode region 15a and the second main electrode region 15b, as shown in FIG. 16E, a cavity inner wall protective film 19 such as a silicon oxide film with a thickness of about 180-250 nm is deposited by a deposition method such as CVD. Then, a sacrificial layer material layer 27p such as tungsten (W) is deposited on the entire surface by a deposition method such as sputtering, vacuum evaporation, or CVD. Then, planarization is performed by a CMP method or the like.

(f) Then, a fourth photoresist film is coated on the sacrificial layer material layer 27p, and the fourth photoresist film is exposed and developed using lithography technology to form a fourth etching mask for sacrificial layer formation. Using the fourth etching mask, the sacrificial layer material layer 27p is selectively etched through dry etching techniques such as RIE, as shown in FIG. 16G, to form a pattern of sacrificial layers 27. In the cross-sectional view representation of FIG. 16G, the two patterns of sacrificial layers 27 are symmetrically located on both sides. However, from an external perspective, the two sacrificial layers 27 at the symmetrical positions on both sides of FIG. 16G are an integrated structure of a continuous ring structure on the front and back sides of the paper surface of FIG. 16G.

(g) Furthermore, a fifth photoresist film is coated on the sacrificial layer 27 forming the annular structure and on the cavity inner wall protective film 19 exposed in the center of the sacrificial layer 27 of the annular structure. The fifth photoresist film is exposed and developed using lithography technology to form a fifth etching mask for exposing the upper part of the channel. Using the fifth etching mask, the cavity inner wall protective film 19c is selectively etched through dry etching techniques such as RIE, exposing the upper surface of the substrate region 14 in the center of the sacrificial layer 27 of the annular structure.

(h) As shown in FIG. 16H, the vibrator 22a1 is heteroepitaxially grown on the upper surface of the substrate region 14 through a contact hole pattern exposed in the center of the sacrificial layer 27 of the ring structure. For example, when the substrate region 14 is made of GaN, an AlN layer can be grown as the vibrator 22a1 using the photo-excited molecular layer epitaxy (MLE) method. MLE of the AlN layer involves introducing source gases such as trimethylaluminum (TMAI) as a group III element gas and ammonia (NH₃) as a group V element gas alternately in a beam-like manner in a time-division manner in a vacuum, to grow the AlN layer in units of one molecular layer. Photo-excited MLE is an epitaxial growth method that further irradiates the growth layer surface with ultraviolet light such as excimer laser on the basis of this MILE method, utilizing ultraviolet energy to assist growth. Through photo-excited MILE, utilizing surface migration caused by light energy, it is possible to heteroepitaxially grow an AlN layer in units of one molecular layer at low temperatures below 1000° C. The AlN layer can be grown at approximately 350-1200° C., but by utilizing ultraviolet energy, good crystallinity can be obtained even at low temperatures below 1000° C. Alternatively, when the substrate region 14 is made of Si, a HfO₂ layer can be grown as the vibrator 22a1 using CVD at approximately 400° C. with the use of tetraethylmethylammonium hafnium (TEMAH) or the like. The surface of the vibrator 22a1 can be planarized as needed using methods such as CMP.

(i) Then, on the vibrating body 22a1, a second conductor film such as aluminum (Al) or aluminum alloy is deposited on the entire surface using deposition methods such as sputtering, vacuum evaporation, or CVD. Furthermore, a sixth photoresist film is coated on the second conductor film, and a pattern for forming a fixed potential electrode is formed using photolithography technology. Using the sixth photoresist film as a sixth etching mask, the second conductor film is selectively etched to form a pattern of the fixed potential electrode 24 as shown in FIG. 16I.

(j) Next, on the vibrating body 22a1, a fixed electrode protection underlayer film (not shown) such as epoxy resin is deposited using methods such as spin coating to cover the pattern of the fixed potential electrode 24. Furthermore, a seventh photoresist film is coated on the fixed electrode protection underlayer film, and a pattern for removing the liquid introduction is formed using lithography technology. Using the seventh photoresist film as a seventh etching mask, as shown in FIG. 16J, a liquid introduction hole 28 is formed that penetrates the fixed electrode protection underlayer film and the vibrating body 22a1 and reaches the sacrificial layer 27. FIG. 16J shows the cross-sectional shape after removing the seventh photoresist film as the seventh etching mask, but as mentioned earlier, the illustration of the fixed electrode protection underlayer film is omitted.

(k) Then, for example, heated hydrogen peroxide water (H₂O₂) is introduced into the sacrificial layer 27 from the liquid introduction hole 28. When the heated hydrogen peroxide water is introduced from the liquid introduction hole 28, the sacrificial layer 27 is selectively dissolved through wet etching. As the sacrificial layer 27 dissolves, a parallel annular vibration cavity 21a1 is formed on the cavity inner wall protective film 19, as shown in FIG. 16K. Subsequently, using methods such as spin coating, a fixed potential electrode protective film 23, such as epoxy resin, with a thickness of approximately 400-600 nm, is deposited on the fixed electrode protective bottom layer film, as shown in FIG. 16L, to seal the liquid introduction hole 28. During the process of sealing the liquid introduction hole 28, the interior of the vibration cavity 21a1 is treated in a reduced pressure atmosphere of approximately 1 kPa, with an inert gas such as helium (He) as the main component, resulting in a reduced pressure state that can be considered almost vacuum-like, with the inert gas as the main component. The acoustic element according to the second variation of the first embodiment is completed.

### Second Embodiment

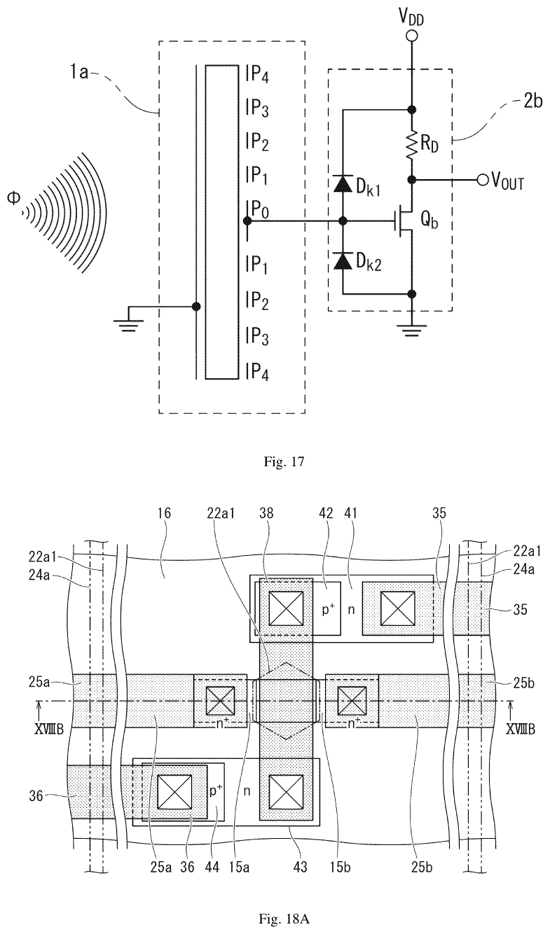

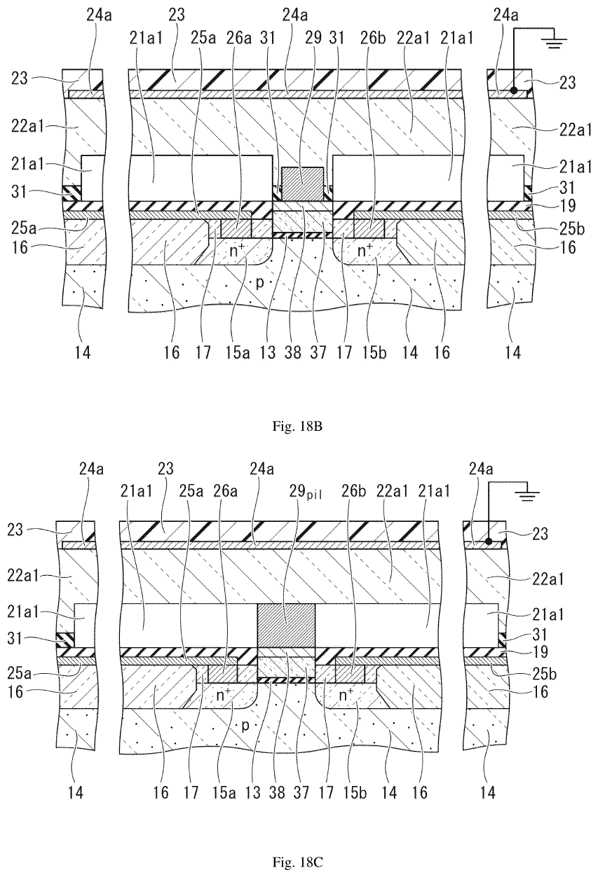

In the acoustic element according to the first embodiment, the structure modeled by the equivalent circuit of FIG. 3B, focusing on the vibrator 22a1 functioning as a gate insulating layer, has been described. In the acoustic element according to the second embodiment of the present disclosure, attention is focused on the structure corresponding to the equivalent circuit shown in FIG. 3A, which is the premise of FIG. 3B. That is, as shown in FIGS. 17, 18A, and 18B, the acoustic element according to the second embodiment is a receiving element X_{i,j}, which includes a voltage generating portion 1a that generates a non-uniform voltage through the piezoelectric effect, and an impedance transforming element 2b that operates using the potential at a specific position (local) of the voltage generating portion 1a as a control voltage. As can be seen from the cross-sectional view of FIG. 18B, the voltage generating portion 1a has a unipolar structure, including a vibrator 22a1 similar to that of the acoustic element according to the first embodiment, and a fixed potential electrode 24a in contact with the receiving surface (upper main surface in FIG. 18B) of the vibrator 22a1. A fixed potential electrode protective film 23 such as epoxy resin is provided on the fixed potential electrode 24a.

The vibrating body 22a1 can be entirely composed of piezoelectric layers as shown in FIG. 18B, or only the central downward protrusion (stress concentration location) can be composed of piezoelectric layers, with the remaining parts being non-piezoelectric layers (not shown). That is, as long as the voltage generating part 1a is located in a part of the vibrating body 22a1, specifically at the stress concentration location of the vibrating body 22a1, it can be configured with at least a piezoelectric layer. Therefore, the impedance transformation element 2b can utilize a specific part of the piezoelectric layer, at least located at the downward protrusion (stress concentration location), as a potential transmission area, and operate the potential of this potential transmission area as a control voltage.

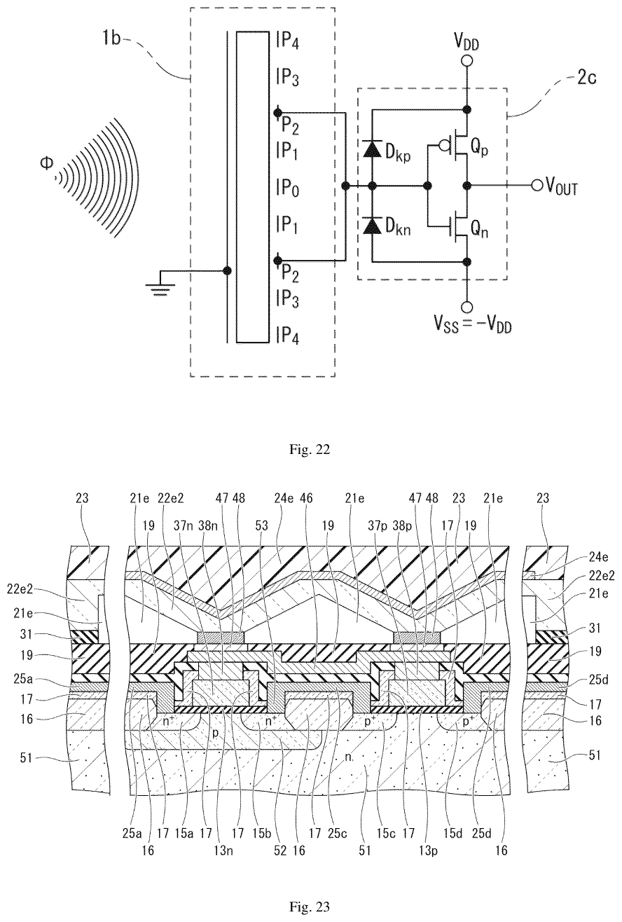

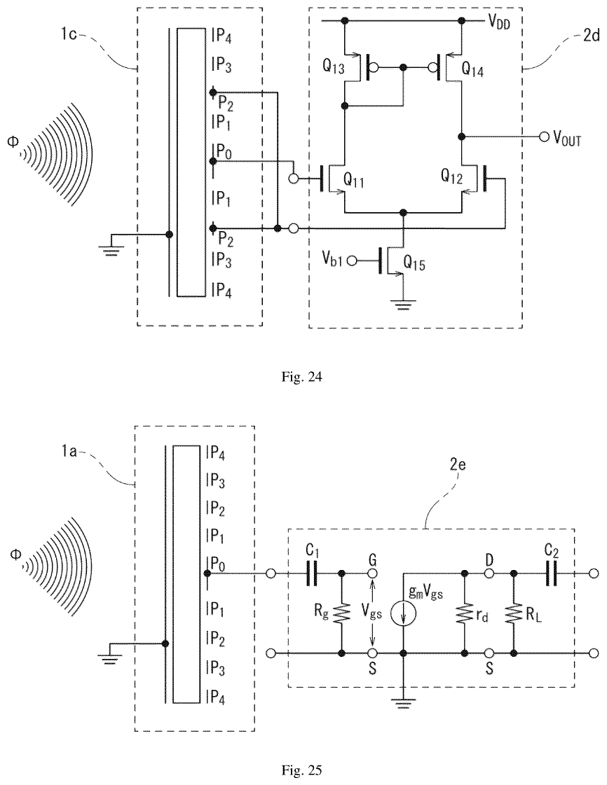

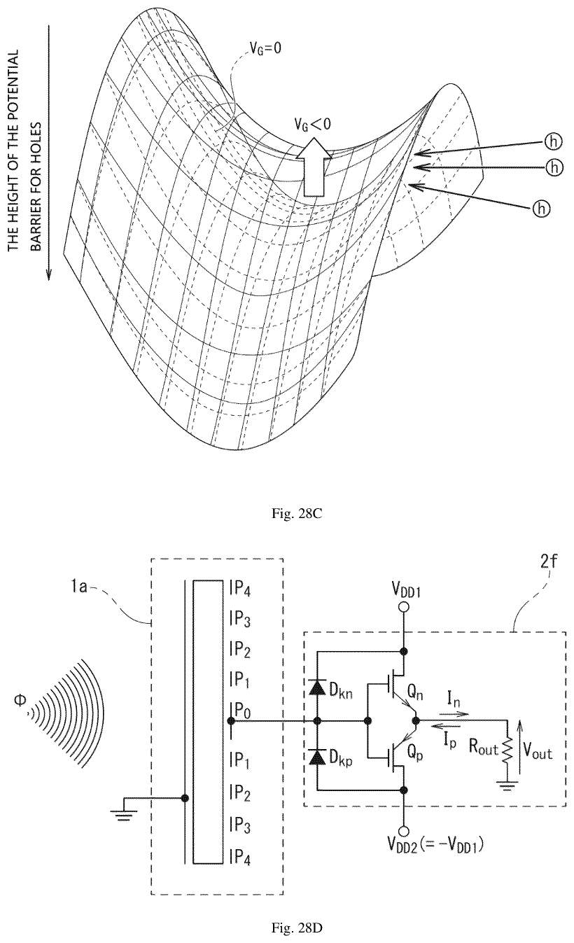

As mentioned earlier, the material that should be used at least for the downward protrusion at the center of the vibrating body 22a1, which is a stress concentration location, can be selected from among the 20 crystal point groups with piezoelectric properties belonging to the 32 crystal families. Since it is only required to be used at the stress concentration location, it is also possible, as shown in FIG. 18B, for the entire vibrating body 22a1 to be composed of piezoelectric materials. Among them, materials such as HfO₂, AlN, and PZT belonging to the 10 crystal point groups exhibiting pyroelectric properties are suitable. The voltage generating portion 1a with a unipolar structure has a voltage distribution that produces uneven voltage generation through the piezoelectric effect at specific locations on the output surface (the lower main surface in FIG. 18B) of the vibrating body 22a1, which is opposite to the receiving surface. The “specific locations” on the output surface of the vibrating body 22a1 are, for example, the central region P₀, the first peripheral region P₁, . . . , and the fourth peripheral region P₄, as schematically shown in the potential transfer region model in FIG. 17. In the model representation in FIG. 17, the central region P₀, the first peripheral region P₁, . . . , and the fourth peripheral region P₄ are arranged in a concentric hexagonal ring pattern centered around the central region P₀, with the pattern surrounding the central region P₀. It should be noted that in the model representation of the voltage generating portion 1a in FIG. 17, the P₀, P₁, . . . , P₄ numbered sequentially from the center outwards only indicate the positions of the potential transfer regions and do not imply that there are electrodes at the positions of P₀, P₁, . . . , P₄ in reality. The same applies to subsequent FIGS. such as FIG. 20, FIG. 22, FIG. 24, FIG. 25, and FIG. 28D.

As shown in FIG. 17, the impedance transformation element 2b includes an active element Q_{b} as a circuit component, which is an insulated gate type transistor (MIS transistor). The first main electrode region 15a is connected to a first power source (GND or negative power source V_{SS}), and the second main electrode region 15b is connected to a second power source V_{DD} with a higher potential than the first power source through an output resistor R_{d}. As the active element Q_{b}, it can correspond to MIS transistors such as MOSFET, MOSSIT, MISFET, MISIT, HEMT, etc. The active element Q_{b} constituting the impedance transformation element 2b operates with the potential of the first peripheral region P₀ as a control voltage, which is a protrusion on the output surface side of the vibrating body 22a1 as shown in the central part of FIG. 18B. That is, the impedance transformation element 2b of the acoustic element according to the second embodiment includes an active element Q_{b} that inputs the pressure of the ultrasonic wave (D applied to the vibrating body 22a1 of the voltage generation section 1a as the potential of the first peripheral region P₀ and outputs a signal after impedance conversion. Then, the acoustic element according to the second embodiment uses the output signal of the active element Q_{b} as the output signal of the acoustic element.

The output surface side protrusion of the vibrator 22a1 of the voltage generating portion 1a of the acoustic element according to the second embodiment is a regular hexagonal prism-shaped protrusion as indicated by the two-dot chain line in FIG. 18A. As shown in FIG. 18B, around the protrusion located at the center of the output surface side of the vibrator 22a1, a parallel annular vibration cavity 21a1 is arranged in a centrally symmetric manner around the protrusion. The parallel annular surface constituting the vibration cavity 21a1 has a topological structure with a hexagonal planar pattern. In the cross-sectional view representation of FIG. 18B, from an external perspective, the two vibration cavities 21a1 are located on both sides of the central protrusion, but they are continuous with each other on the front and back sides of the paper surface, forming an integrated structure.

The active element Q_{b} of the impedance transforming element 2b of the acoustic element according to the second embodiment, as shown in FIG. 18B, features a base region 14 composed of a first conductive type (p-type) semiconductor region, and first and second main electrode regions 15a and 15b, respectively, which are separated from each other and located above the base region 14 and are composed of a second conductive type (n⁺-type) semiconductor region. Additionally, as shown in FIG. 18B, the active element Q_{b} contacts the upper surface of the base region 14 located between the first and second main electrode regions 15a and 15b, and includes a gate dielectric film 13 with a wider bandgap than the base region 14, as well as a control electrode 37 disposed on the gate dielectric film 13. In the case of the active element Q_{b} with the gate dielectric film 13, insulation breakdown of the gate dielectric film 13 can become a problem due to excessive gate voltage. Therefore, as shown in FIG. 17, a positive voltage clamp diode Dₖ₁ is connected between the control electrode 37 of the active element Q_{b} and the second power supply V_{DD}, and a negative voltage clamp diode Dₖ₂ is connected between the control electrode 37 and the first power supply (GND). By connecting the positive and negative voltage clamp diodes Dₖ₁ and Dₖ₂ to the control electrode 37, it is configured to prevent excessive gate voltage from being applied to the gate dielectric film 13. The circuit connection shown in FIG. 17 illustrates connecting the fixed potential electrode 24a to the ground potential (GND), but it is not limited to this circuit connection. As previously mentioned, using FIGS. 4C, 4D, 5C, 7B, 7C, 8B, 9B, 10B, etc. for illustration, when connecting the fixed potential electrode 24a to the ground potential (GND), the central voltage V_{P0}, the first peripheral voltage V_{P1}, the second peripheral voltage V_{P2}, the third peripheral voltage V_{P3}, and the fourth peripheral voltage V_{P4} of the voltage generation unit 1a will form a vibration waveform that oscillates in both positive and negative directions centered around 0V Unlike the circuit connection shown in FIG. 17, if the fixed potential electrode 24a is connected to a bias voltage V_{bias}>0, the central voltage V_{P0}, the first peripheral voltage V_{P1}, the second peripheral voltage V_{P2}, the third peripheral voltage V_{P3}, and the fourth peripheral voltage V_{P4} generated by the voltage generation unit 1a will form a vibration waveform that oscillates around the bias voltage V_{bias}, centered at a value different from 0V That is, if we choose a V_{bias} that maximizes the amplification factor at the operating point of the impedance transformation element 2b's I-V characteristics and connect the fixed potential electrode 24a to V_{bias}, we can enhance the sensitivity of the acoustic element according to the second embodiment. In other words, as long as the fixed potential electrode 24a is at a fixed potential, any bias voltage V_{bias} can be selected. A circuit structure that adjusts any required bias voltage V_{bias} from a variable voltage source can also be adopted.

According to the film formation conditions, the bandgap width of the silicon dioxide (SiO₂) film is approximately 7.6-9.0 eV, that of the aluminum oxide (Al₂O₃) film is approximately 8.3 eV, and that of the silicon nitride (Si₃N₄) film is approximately 4.9 eV The active element Q_{b} can be considered to have a heterojunction gate structure similar to that of a heterojunction FET. As shown in FIG. 17, in the acoustic element according to the second embodiment, the control electrode 37 of the active element Q_{b} is electrically connected to the potential generation position P₀, and the height of the potential barrier that controls carrier movement generated in the channel defined between the first main electrode region 15a and the second main electrode region 15b of the active element Q_{b} is controlled by the potential at the potential generation position P₀. Since the impedance transformation element 2b of the acoustic element according to the second embodiment includes the active element Q_{b} with the gate dielectric film 13 and the control electrode 37, as an equivalent circuit illustrating the main constituent parts, it can formally correspond to FIG. 3A already explained in the first embodiment.

Around the periphery of the base region 14, an element isolation insulating film 16 is arranged in a frame shape to define the range of the active region of the active element Q_{b}. In the cross-sectional representation of FIG. 18B, the element isolation insulating film 16 is located on both sides of the active region. However, similar to the structure of the acoustic element according to the first embodiment, the element isolation insulating film 16 located on both sides of the active region is continuous with each other on the front and back surfaces of the paper, forming an integrated structure. Inside the pattern of the active region surrounded by the element isolation insulating film 16, the range (region) of the upper surface of the base region 14 is defined, and a first main electrode region 15a and a second main electrode region 15b are provided in the upper portion near the upper surface (surface) of the active region surrounded by the element isolation insulating film 16. In the center of FIG. 18A, the range of the potential transfer region of a regular hexagon is indicated by a two-dot chain line. For the hexagonal potential transfer region defined as the output surface side protrusion of the vibrating body 22a1, the channel of the active element Q_{b} is formed on the surface of the rectangular region sandwiched between the first main electrode region 15a and the second main electrode region 15b. Within the range of the active region, the height of the potential barrier generated in the channel between the first main electrode region 15a and the second main electrode region 15b of the active element Q_{b}, which affects carrier movement, is controlled by the potential electrostatic of the potential transfer region of the vibrating body 22a1.

As shown in FIG. 18B, an interlayer insulating film 17 is provided on the first main electrode region 15a and the second main electrode region 15b. Through contact holes opened in the interlayer insulating film 17, the first main electrode distribution line 25a is connected to the first main electrode region 15a, and the second main electrode distribution line 25b is connected to the second main electrode region 15b. As shown in FIGS. 18A and 18B, an input signal distribution line 38 composed of a conductor is provided on the control electrode 37, and they are connected by metal bonding. In FIG. 18A, the input signal distribution line 38 is a distribution line in the length direction orthogonal to the length direction of the first main electrode distribution line 25a and the second main electrode distribution line 25b, which connects the control electrode 37 to the p⁺-type anode region 42 and the n-type cathode region 43, respectively. Corresponding to the positive voltage clamp diode Dₖ₁ in the equivalent circuit representation of FIG. 17, the p-n junction diode composed of the p⁺-type anode region 42 and the n-type cathode region 41 is located in the paper region above the pattern of the first main electrode distribution line 25a and the second main electrode distribution line 25b in FIG. 18A. The length direction of the p-n junction diode composed of the p⁺-type anode region 42 and the n-type cathode region 41 is parallel to the length direction of the pattern of the first main electrode distribution line 25a and the second main electrode distribution line 25b.

Similarly, corresponding to the negative voltage clamp diode Dₖ₂ in FIG. 17, a p-n junction diode composed of a p⁺-type anode region 44 and an n-type cathode region 43 is provided in the lower region of the paper surface in FIG. 18A, with its length direction parallel to the patterns of the first main electrode distribution line 25a and the second main electrode distribution line 25b. The anode region 44 of the negative voltage clamp diode Dₖ₂ is connected to the first power-side diode distribution line 36, and the cathode region 41 of the positive voltage clamp diode Dₖ₁ is connected to the second power-side diode distribution line 35. As shown in FIG. 18B, a columnar (block-shaped) connection plug 29 is embedded as a contact portion (contact area) from the tip side of the central protrusion on the output surface side of the vibrating body 22a1, and the connection plug 29 is in ohmic contact with the vibrating body 22a1. The surface layer of the lower end of the connection plug 29, that is, the lower surface of the connection plug 29, can be made of a softer metal than the upper part, and the connection plug 29 can be constructed with a laminated structure of hard and soft metals. The lower end of the connection plug 29, which functions as an electrical contact portion of the voltage generating section 1a, is processed into a flat surface, becoming the end face connected to the upper surface of the input signal wiring 38. Moreover, by physically contacting the lower surface (i.e., the connection end face) of the connection plug 29 with the upper surface of the input signal wiring 38, the potential of the central region P₀ of the voltage generating section 1a is inputted as a control voltage for the active element Q_{b} that constitutes the impedance transforming element 2b.

To reduce the ohmic contact resistance between the vibrating body 22a1 and the connection plug 29, a contact resistance improvement layer such as an alloy layer can be inserted between them. The connection plug 29 does not necessarily have to be embedded into the tip of the central protrusion, and it can also be plate-shaped, forming a simple planar junction between the tip of the protrusion and the plate-shaped surface. If the connection plug 29 is considered as a constituent element, the voltage generating part 1a includes the vibrating body 22a1, the fixed potential electrode 24a, the fixed potential electrode protective film 23, and the connection plug 29. In addition, a new connection means such as a bump can be further inserted between the connection plug 29 and the input signal distribution line 38.

That is, the potential of the connection plug 29 is input to the control electrode 37 through the input signal distribution line 38, and the potential of the control electrode 37 is controlled by the gate dielectric film 13 to statically adjust the height of the potential barrier generated in the channel between the first main electrode region 15a and the second main electrode region 15b, which affects carrier movement. The structure shown in FIG. 18B is an example of a structure where the connection plug 29 of the voltage generation unit side chip disposed on the upper side and the input signal distribution line 38 of the impedance conversion element side chip disposed on the lower side are in physical contact with each other. Therefore, around the vibration cavity 21a1, the direct bonding insulating film 31 with a mirror surface disposed on the voltage generation unit side chip and the cavity inner wall protective film 19 with a mirror surface disposed on the impedance conversion element side chip are directly bonded through hydrophilic bonding (hydrogen bonding between silanol groups).

Compared to the floating impedance when connecting PMUT and FET through external wiring as described in Non-patent Document 2, the acoustic element according to the second embodiment can significantly reduce the floating impedance due to the adoption of a thin plate-shaped input signal distribution line 38 and control electrode 37, which provide an electrical connection path that is directly connected with the shortest distance in the thickness direction. Additionally, compared to the PMUT in Non-patent Document 2, the voltage generation unit 1a adopts a new structure with a stress reinforcement structure, achieving high sensitivity and broadband performance. Therefore, the acoustic element according to the second embodiment can achieve high sensitivity and broadband performance. Specifically, by conducting microscopic research on the internal structure of the voltage generation unit 1a, selecting a specific location with the highest voltage generation as the potential transfer area, and using it as the input transfer position to the impedance conversion element 2b, it is easy to achieve high sensitivity.

### A Variation of the Second Embodiment

In FIG. 18B, an example is shown where the connection plug 29 is embedded upward from the tip side of the downward protrusion on the output surface side of the vibrating body 22a1, serving as the contact portion. However, this is not limited to this structure. For instance, as shown in FIG. 18C, a connection plug 29ₚᵢₗ composed of a cylindrical conductor can be set as the central pillar of the vibrating cavity 21a1, and a parallel toroidal vibrating cavity 21a1 can be arranged around the connection plug 29ₚᵢₗ in a centrosymmetric manner. In the description of FIG. 18B, it is mentioned that the connection plug 29 can be plate-shaped. The structure shown in FIG. 18C corresponds to a structure where the thickness of the central protrusion in FIG. 18B is set to zero, and it is entirely composed of thick plate-shaped connection plugs 29.

The connection plug 29ₚᵢₗ becomes a regular hexagonal prism occupying the range of the potential transmission area indicated by the two-dot chain line in the center of FIG. 18A, and the parallel toroid constituting the vibrating cavity 21a1 has a topological structure with a hexagonal ring pattern around the connection plug 29ₚᵢₗ. Through the connection plug 29ₚᵢₗ, planar bonding is achieved at the center of the output surface side of the vibrating body 22a1. As a result, the connection plug 29ₚᵢₗ corresponds to its six side surfaces exposed to the contact portions (contact areas) of the hexagonal ring surface. In the cross-sectional view representation of FIG. 18C, from an external view, two vibrating cavities 21a1 are located on both sides of the central connection plug 29ₚᵢₗ, but they are continuous with each other on the front and back sides of the paper surface, forming an integrated structure.

The active element shown in FIG. 18C is similar to the active element Q_{b} shown in FIG. 18B. It contacts the upper surface of the body region 14 located between the first main electrode region 15a and the second main electrode region 15b, and includes a gate dielectric film 13 with a wider bandgap than the body region 14, as well as a control electrode 37 disposed on the gate dielectric film 13. Additionally, as shown in FIG. 18C, an input signal distribution line 38 composed of a conductor is connected to the control electrode 37 through metal bonding. On the other hand, the flat upper surface of the connection plug 29ₚᵢₗ constituting the central pillar structure is in ohmic contact with the vibrating body 22a1 at the center of the output surface side of the vibrating body 22a1. Although not shown, a contact resistance improvement layer such as an alloy layer can be inserted between the center of the output surface side of the vibrating body 22a1 and the flat upper surface of the connection plug 29ₚᵢₗ.

Then, the flat lower surface of the connection plug 29ₚᵢₗ, which uses a soft metal as the surface layer (the bottom layer in FIG. 18C), physically contacts the upper surface of the input signal distribution line 38. The connection plug 29ₚᵢₗ is electrically connected to the input signal distribution line 38, and the potential of the central region P₀ of the voltage generation section 1a shown in FIG. 17 is input as a control voltage to the active element Q_{b} constituting the impedance conversion element 2b. In the representation of FIG. 18C, the width of the connection plug 29ₚᵢₗ, the width of the input signal distribution line 38, and the width of the control electrode 37 appearing in the cross-sectional view are shown to be the same, but this is only an example. The width of the connection plug 29ₚᵢₗ and the width of the input signal distribution line 38 may be different, and the width of the input signal distribution line 38 and the width of the control electrode 37 may also be different. In addition, the width of the connection plug 29ₚᵢₗ and the width of the control electrode 37 may also be different. For example, the width of the control electrode 37 may be larger than the width of the connection plug 29ₚᵢₗ shown in FIG. 18C, forming an inverted T shape, or conversely, the width of the control electrode 37 may be smaller than the width of the connection plug 29ₚᵢₗ, forming a T shape. Other aspects are the same as those of the acoustic element according to the second embodiment shown in FIG. 18B, so redundant explanations are omitted.

Compared to the floating impedance when connecting PMUT and FET through external wiring as described in Non-patent Document 2, in the acoustic element according to the modified example of the second embodiment, the connection plug 29ₚᵢₗ, input signal distribution line 38, and control electrode 37 are directly connected in the thickness direction with the shortest distance, forming an electrical connection path. Therefore, the floating impedance can be significantly reduced. Furthermore, compared to the PMUT in Non-patent Document 2, the voltage generation section 1a adopts a new structure with a stress reinforcement structure, achieving high sensitivity and broadband performance. Therefore, the acoustic element according to the modified example of the second embodiment can achieve high sensitivity and broadband performance. Specifically, a specific position on the output surface of the vibrator 22a1 that generates the highest voltage is selected as the potential transfer area, and the short connection plug 29ₚᵢₗ is used as the input transfer position to the active element, making it easy to achieve high sensitivity.

### Hardness Dependence of Central Pillar Material

In the case where PZT with a thickness of t₂₂ₐ₁=2.4 μm is used as the vibrating body 22a1, the voltage sensitivity and half-value bandwidth when varying the material hardness of the cylindrical connection plug 29ₚᵢₗ with a diameter of 2.4 μm, which functions as the central pillar in FIG. 18C, are shown in FIG. 18D. The outer circumferential diameter of the annular surface, d₁₁, is 60 μm (refer to the definition of d₁₁ in FIG. 4A), and it is assumed that the vibrating body 22a1 is covered with a fixed potential electrode protective film 23 composed of soft epoxy resin with a thickness of t₂₃=6 μm. As shown in FIG. 18D, within the half-value bandwidth of 5-11 MHz for receiving ultrasonic waves, the maximum voltage sensitivity of the central pillar structure made of tungsten (W) represented by the thin solid line and silicon nitride film (Si₃N₄ film) represented by the thin dashed line is approximately 5.14 μV/Pa, which is the highest. In FIG. 18D, the thin solid line for W and the thin dashed line for Si₃N₄ film almost overlap. W and Si₃N₄ film are the materials with the highest and second-highest Young's modulus among the materials shown in Table 3.

TABLE 3

| Material Name | Poisson's Ratio | Elastic Modulus(Gpa) |
|---|---|---|
| Cu | 0.343 | 124-129 |
| W | 0.28 | 380-411 |
| Al | 0.345 | 69-70 |
| Si₃N₄ | 0.27-0.25 | 210-310 |
| Si | 0.266 | 107 |
| SiO₂ | 0.17-0.2 | 66-94 |
| Polyurethane | 0.05 | 0.01-0.06 |
| Soft Epoxy Resin | 0.34-0.37 | 2.6-3 |
| Polyethylene | 0.30-0.458 | 0.2-1.3 |

Moreover, although the sensitivity curve of copper (Cu), represented by the thick solid line, is slightly lower in frequency than those of W and Si₃N₄ films, it is almost identical to the sensitivity curves of W and Si₃N₄ films in terms of the central pillar structure made of Cu. Additionally, when Cu is used as the connecting plug 29ₚᵢₗ, its maximum voltage sensitivity is approximately 5.14 μV/Pa. Furthermore, the sensitivity curve of the central pillar structure made of silicon dioxide film (SiO₂ film), represented by the thick dashed line, which is approximately 0.7 MHz lower than the sensitivity curve of Cu, is almost identical to the sensitivity curves of W, Si₃N₄ films, and Cu, exhibiting the same maximum voltage sensitivity and half-value bandwidth curve.

Furthermore, the sensitivity curve of aluminum (Al) as the central pillar structure of the material, represented by a single-dot dashed line approximately 0.5 MHz lower than the sensitivity curve of Cu, is slightly lower than those of W, Si₃N₄ film, Cu, and SiO₂ film. The maximum voltage sensitivity is approximately 5.0 μV/Pa, and the half-value bandwidth curve is almost the same as theirs. Additionally, the sensitivity curve of silicon (Si) as the central pillar structure of the material, represented by a double-dot dashed line approximately 0.3 MHz lower than the sensitivity curve of Cu, has a maximum voltage sensitivity of approximately 4.9 μV/Pa, slightly lower than that of Al, and the half-value bandwidth curve is almost the same as those of W, Si₃N₄ film, Cu, SiO₂ film, and Al. Within the range of metals and non-organic compounds such as W, Si₃N₄ film, Cu, SiO₂ film, Al, and Si shown in Table 3, it can be seen that the hardness of the material constituting the central pillar structure does not have a significant dependence on the maximum voltage sensitivity and half-value bandwidth.

In comparison, the two sensitivity curves representing polyurethane (PUR) with a thick dashed line and polyethylene (PE) with a thin solid line, which serve as the central pillar structures of the materials, are located on the low-frequency side, approximately 3.8 MHz lower than the sensitivity curve of the SiO₂ film. The sensitivity curves of PUR and PE as the central pillar structures of the materials exhibit a maximum voltage sensitivity of approximately 3.9 μV/Pa, which is lower than a set of sensitivity curves composed of metal and non-organic compounds such as W and Si₃N₄ films, and are displayed as two overlapping curves with almost the same trajectory. The sensitivity curves of PUR and PE as the central pillar structures of the materials are displayed as half-value bandwidth curves in the 4.1-7.3 MHz region (lower frequency side compared to the region of the set of sensitivity curves composed of metal and non-organic compounds), with a narrowed half-value bandwidth. Furthermore, the sensitivity curve of soft epoxy resin (EP resin) represented by a thick solid line exhibits a maximum voltage sensitivity of approximately 3.5 μV/Pa, which is lower than the sensitivity curves of PUR and PE, and displays a half-value bandwidth of 4.1-8.0 MHz. As can be seen from FIG. 18D, compared to the case where the central pillar structure is composed of metal and non-organic compounds such as W and Si₃N₄ films, when the central pillar structure is composed of polymer materials such as PUR, the maximum voltage sensitivity is lower, the half-value bandwidth shifts to the low-frequency side, and the bandwidth becomes narrower.

### Method for Manufacturing an Acoustic Element According to the Second Embodiment

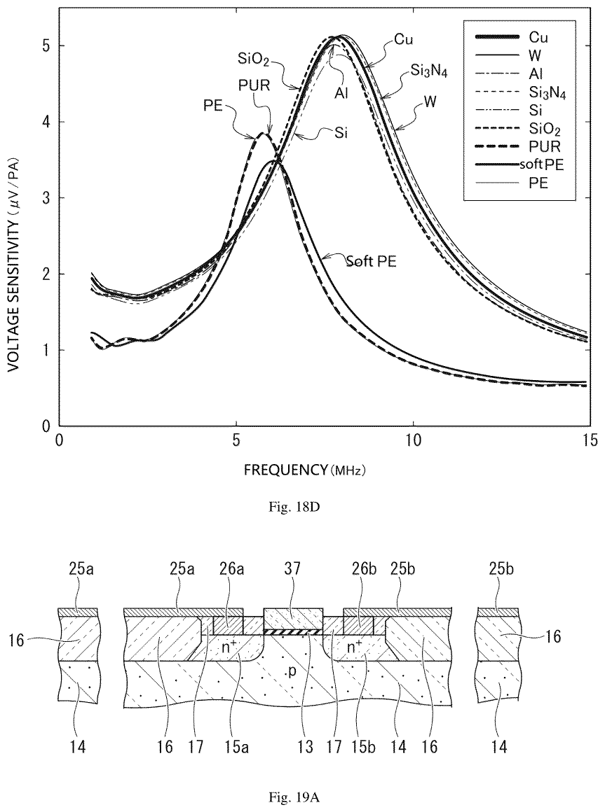

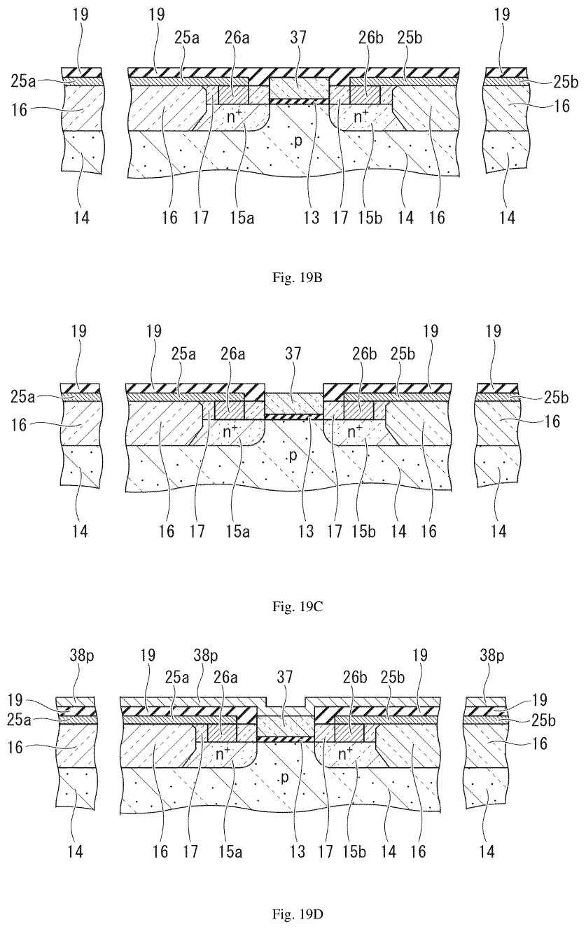

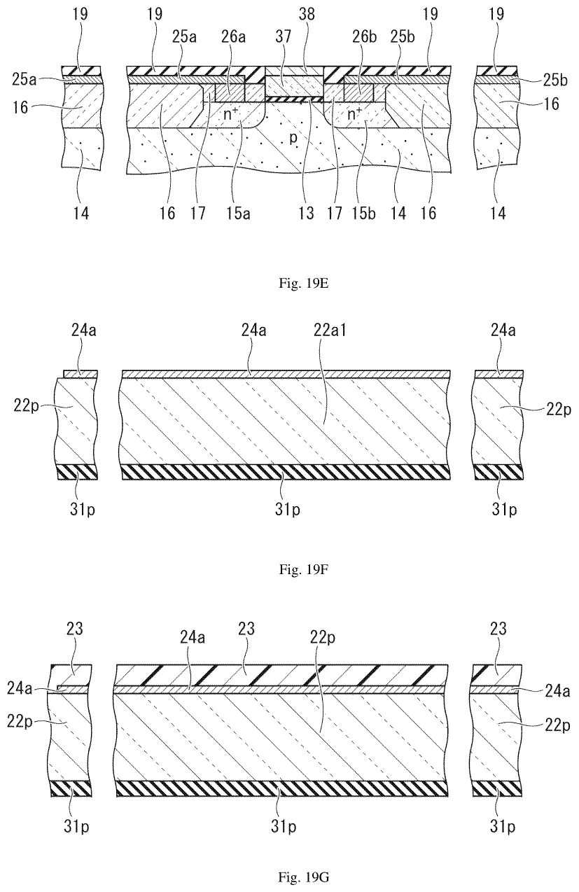

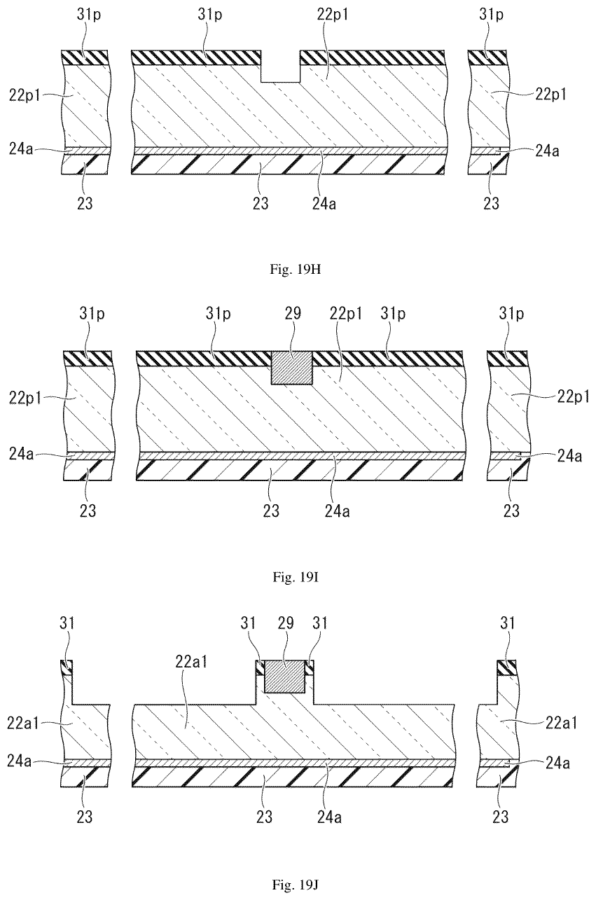

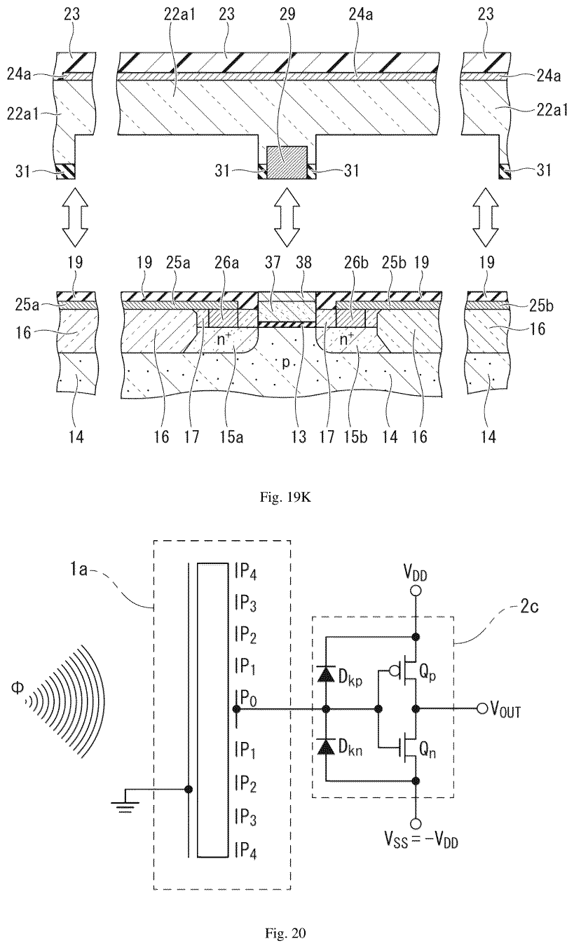

Using FIGS. 19A to 19K, we will illustrate the manufacturing method of the acoustic element according to the second embodiment, as exemplified in FIG. 18B, where the voltage generation unit side chip and the impedance conversion element side chip are directly bonded. It should be noted that the manufacturing method of the acoustic element according to the second embodiment described below is merely an example, and it is not necessarily limited to this method when directly bonding the voltage generation unit side chip and the impedance conversion element side chip through hydrophilic bonding (fusion bonding). If the temperature process associated with the deposition of the vibrator 22a1 is not a problem, methods such as heteroepitaxy or CVD, similar to the manufacturing method of the acoustic element according to the second variation of the first embodiment mentioned above, can also be adopted. Furthermore, even when stacking the voltage generation unit side chip and the impedance conversion element side chip, electrical connection and physical strength can be achieved through bump bonding, similar to a common three-dimensional stacked chip structure, without being limited to the following manufacturing method. For bump bonding, in addition to the exemplified gold (Au)—Au direct bonding, copper (Cu)—Cu direct bonding, silver (Ag)-tin (Sn) series solder, indium (In)—Sn solder, or indirect bonding using eutectic components such as Au—Sn or Cu—Sn can also be used. Therefore, as long as the structure described in the claims can be realized, the acoustic element according to the second embodiment can certainly be implemented through various manufacturing methods other than the examples mentioned below.

Furthermore, as mentioned at the beginning of the description of the manufacturing method of the acoustic element according to the second variation of the first embodiment, the use of terms with ordinal numbers such as “first photoresist film” in the following description is merely a convenient name used for rhetorical purposes to distinguish it from other photoresist films, and does not imply the first or any other order in actual processes. In fact, before the structure shown in FIG. 19A, multiple processing stages using photoresist films have usually been implemented, and in actual processes, it is usually not the “first photoresist film”. Additionally, the voltage generation unit side chip process shown in FIG. 19F to FIG. 19J can be performed before (or prior to) the impedance conversion element side chip process shown in FIG. 19A to FIG. 19E in terms of sequence. If the voltage generation unit side chip process is performed first, the convenient use of ordinal numbers such as “first photoresist film” in the following description will naturally change.

(a) Firstly, as the foundation for the impedance transformation element side chip, a substrate region 14 composed of a p-type silicon substrate with a (100) surface as the main surface and a resistivity of 0.1-10 Ωcm is prepared. Then, using known LOCOS or STI technology, an element isolation insulating film 16 such as a silicon oxide film is formed to a thickness of approximately 0.4-1.2 μm. On the substrate region 14 exposed by the planar pattern of the active region surrounded by the element isolation insulating film 16, a gate dielectric film 13 and a DPOS film are deposited, and the DPOS film is patterned to form a control electrode 37. Through ion implantation, using the control electrode 37 as a mask, a cross-sectional structure of n⁺-type first main electrode region 15a and second main electrode region 15b facing each other is self-alignedly formed within the active region. An example of the planar pattern of the first main electrode region 15a and the second main electrode region 15b can be a rectangular pattern as shown in FIG. 18A. While forming the first main electrode region 15a and the second main electrode region 15b, a cathode region 41 shown in the planar view of FIG. 18A is formed on the back side of the paper in FIG. 19A, and a cathode region 43 is formed on the front side of the paper. After forming the cathode regions 41 and 43, a p⁺-type anode region 42 shown in FIG. 18A is formed inside the pattern of the cathode region 41 by ion implantation, and a p⁺-type anode region 44 is formed inside the pattern of the cathode region 43 by ion implantation.

(b) Then, on the first main electrode region 15a, the second main electrode region 15b, and the substrate region 14 exposed between the first main electrode region 15a and the second main electrode region 15b, a first insulating film 17p, such as a silicon oxide film, with a thickness of approximately 180-250 nm is deposited using a deposition method such as CVD. When the substrate region 14 is made of Si, thermal oxidation can also be used. After depositing the first insulating film 17p using methods such as CVD, it is planarized using methods such as chemical mechanical polishing (CMP) until the upper surface of the element isolation insulating film 16 is exposed. Subsequently, a first photoresist film is coated on the first insulating film 17p, and the first photoresist film is exposed and developed using lithography techniques to form a first etching mask for opening contact holes. Using the first etching mask, the first insulating film is selectively etched using dry etching techniques such as reactive ion etching (RIE), to open contact hole patterns in the upper portions of the first main electrode region 15a, the second main electrode region 15b, the control electrode 37, the anode regions 42 and 44, and the cathode regions 41 and 43.

(c) Furthermore, a first conductor film, consisting of a conductor layer such as a DOPOS film or a high-melting-point metal, is deposited on the first insulating film with a thickness of approximately 80-200 nm using deposition methods such as CVD. A second photoresist film is coated on the first conductor film, and the second photoresist film is exposed and developed using lithography techniques to form a second etching mask for patterning the first main electrode distribution line 25a and the second main electrode distribution line 25b (refer to FIG. 18A). Using the second etching mask, the first conductor film is selectively etched using dry etching techniques such as RIE, as shown in FIG. 19A, to form patterns of the first main electrode distribution line 25a connected to the first main electrode region 15a and patterns of the second main electrode distribution line 25b connected to the second main electrode region 15b.

(d) Then, on the first main electrode power distribution line 25a, the second main electrode power distribution line 25b, and the control electrode 37, as shown in FIG. 19B, a silicon oxide film or other cavity inner wall protective film 19 with a thickness of approximately 180-250 nm is deposited using a deposition method such as CVD. Furthermore, a third photoresist film is coated on the cavity inner wall protective film 19, and the third photoresist film is exposed and developed using lithography technology to form a third etching mask for opening contact holes on the control electrode 37, the anode regions 42 and 44, and the cathode regions 41 and 43 (refer to FIG. 18A). Using the third etching mask, the cavity inner wall protective film 19 is selectively etched using dry etching technology such as RIE, to open contact holes on the control electrode 37, the anode regions 42 and 44, and the cathode regions 41 and 43. In FIG. 19A, the contact holes on the anode region 42 and the cathode region 41 are located on the back side of the paper, while the contact holes on the anode region 44 and the cathode region 43 are located on the front side of the paper (refer to FIG. 18A).

(e) Next, after removing the third photoresist film, a fourth photoresist film is coated on the cavity inner wall protective film 19, and the fourth photoresist film is exposed and developed using lithography technology, thereby forming a fourth etching mask for patterning the Damascus groove of the input signal wiring 38, the first power supply side diode wiring 36, and the second power supply side diode wiring 35 (see FIG. 18A). Using the fourth etching mask, the cavity inner wall protective film 19 is selectively etched by dry etching techniques such as RIE, as shown in FIG. 19C, to form Damascus grooves for connecting the control electrode 37 to the anode region 42 and cathode region 43, connecting the first power supply side diode wiring 36 to the anode region 44, and connecting the second power supply side diode wiring 35 to the cathode region 41. The Damascus groove of the input signal wiring 38 is integrated with the contact hole on the control electrode 37 above it. In FIG. 19C, the Damascus groove of the first power supply side diode wiring 36 is located deep in the paper, and the Damascus groove of the second power supply side diode wiring 35 is located near the paper (see FIG. 18A).

(f) Further, as shown in FIG. 19D, a second conductor film 38p, composed of a conductor layer such as a copper (Cu) film, is deposited on the cavity inner wall protective film 19 with a thickness of approximately 80-200 nm using a deposition method such as CVD. Subsequently, the upper surface of the cavity inner wall protective film 19 is exposed through planarization using methods such as CMP, thereby embedding the second conductor film 38p into each Damascus groove, as shown in FIG. 19E. By embedding the second conductor film 38p into the Damascus groove, input signal wiring 38 connecting the control electrode 37 to the anode region 42 and cathode region 43, first power supply side diode wiring 36 connecting to the anode region 44, and second power supply side diode wiring 35 connecting to the cathode region 41 are formed as Damascus wiring. The top layer of the Damascus wiring is preferably a soft metal with a Vickers hardness of approximately 20Hv-30Hv, such as Au. Additionally, Au alloys with a Vickers hardness of approximately 15Hv-120Hv, such as Au-silicon (Si), Au-germanium (Ge), Au-antimony (Sb), Au-tin (Sn), Au-lead (Pb), Au-zinc (Zn), and Au-copper (Cu), with an Au content of over 80%, can also be used on the top layer of the Damascus wiring.

In FIG. 19E, the first power supply side diode wiring 36 is located deeper in the paper, and the second power supply side diode wiring 35 is located closer to the paper (see FIG. 18A). The upper surface of the cavity inner wall protective film 19, after being planarized using methods such as CMP, is finally processed into a mirror surface suitable for the bonding process, completing the “impedance conversion element side chip”.

(g) On the other hand, to prepare the “voltage generation unit side chip”, a PZT substrate with a thickness of approximately 100 μm is prepared. On one main surface of the prepared PZT substrate, a second insulating film 31p composed of a silicon oxide film or the like is deposited to a thickness of approximately 180-250 nm using deposition methods such as CVD. Subsequently, the other main surface of the PZT substrate is adjusted to the thickness required for the vibrator 22a1. To maintain the strength of the PZT substrate, it is feasible to retain the peripheral portion of the PZT substrate in the shape of a frame with the thickness of the base material, with a recess inside the frame, and adjust only the thickness of the central portion corresponding to the bottom of the recess to the required thickness for the vibrator 22a1. This stepped structure is also feasible. Then, on the bottom of the recess on the other main surface side of the PZT substrate serving as the vibrator 22a1, a third conductor film such as Al or Al alloy is deposited using deposition methods such as sputtering, vacuum evaporation, or CVD. Next, a fifth photoresist film is applied on the third conductor film, and a pattern for forming a fixed potential electrode is formed using lithography technology. Using the fifth photoresist film as a fifth etching mask, the third conductor film is selectively etched to form a pattern of fixed potential electrodes 24a as shown in FIG. 19F on the bottom of the recess.

(h) Next, as shown in FIG. 19G, a layer of fixed potential electrode protective film 23, such as epoxy resin, is deposited on the vibrating body 22a1 using methods such as spin coating, to cover the pattern of the fixed potential electrode 24a. To ensure the strength of the vibrating body 22a1, the thickness of the fixed potential electrode protective film 23 can be thicker than the final design value. Alternatively, a reinforcement substrate (not shown in the FIG.) can also be bonded onto the fixed potential electrode protective film 23.

(i) Then, flip the vibrator 22a1 over so that one main surface of the PZT substrate faces upward. Apply a sixth photoresist film on the second insulating film 31p on one main surface of the PZT substrate, and use photolithography technology to form a pattern for embedding the connection plug buried groove. Using the sixth photoresist film as a sixth etching mask, form a plug insertion groove that penetrates through the second insulating film 31p and reaches the vibrator 22a1, as shown in FIG. 19H. Next, deposit a fourth conductive film composed of a conductive layer such as a DOPOS film or a high-melting-point metal on the second insulating film 31p using deposition methods such as CVD, sputtering, or vacuum evaporation, with a thickness thicker than the depth of the plug buried groove. After planarization by methods such as CMP, embed the connection plug 29 into the plug insertion groove, as shown in FIG. 19I. At least the topmost layer of the connection plug 29 is preferably a metal film with low Vickers hardness, such as Au or Au alloy. To reduce the ohmic contact resistance between the vibrator 22a1 and the connection plug 29, heat treatment can be performed after embedding the connection plug 29 to form an alloy layer between the vibrator 22a1 and the connection plug 29. Alternatively, before embedding the connection plug 29 into the vibrator 22a1, deposit an ohmic contact resistance improvement layer composed of other metals or the like as a bottom layer, then embed the connection plug 29, and finally perform heat treatment.

(j) Afterwards, a seventh photoresist film is coated on the second insulating film 31p, and the seventh photoresist film is exposed and developed using lithography technology to form a seventh etching mask for sacrificial layer formation. Using the seventh etching mask, the second insulating film 31p is selectively etched through dry etching techniques such as RIE, forming a pattern of concave portions for the annular vibration cavity as shown in FIG. 19J. In the cross-sectional view of FIG. 19J, the two patterns of concave portions for the vibration cavity are symmetrically located on both sides. However, in reality, the two concave portions for the vibration cavity that appear symmetrically located on both sides in FIG. 19J are actually continuous annular structures on both sides of the paper, forming a single unit. The second insulating film 31p remaining around the concave portions for the vibration cavity becomes the direct bonding insulating film 31, completing the voltage generation section side chip. The surface of the direct bonding insulating film 31 is also processed into a mirror surface.

(k) Then, flip the chip on the voltage generation side, ensuring that the side with the direct bonding insulating film 31 faces downwards, and position it above the chip on the impedance transformation element side, as shown in FIG. 19K. Next, perform hydrophilic bonding through “glass optical contact” between the direct bonding insulating film 31 and the cavity inner wall protective film 19, thereby directly bonding the chip on the voltage generation side to the chip on the impedance transformation element side. The silicon oxide film forming the ultra-smooth direct bonding insulating film 31 and the silicon oxide film constituting the cavity inner wall protective film 19 adhere closely to each other simply through contact. In hydrophilic bonding, due to the adsorption of water, hydrogen bonds formed between silanol groups on the glass surface cause the glass to adhere tightly. To achieve a firm bond, a post-annealing process at approximately 800° C. can be performed. During the post-annealing process, due to thermal expansion, the connection plug 29 protruding from the plug embedding groove is thermally pressed onto the input signal line 38 and bonded to the metal. If oxygen plasma is irradiated onto the surfaces of the direct bonding insulating film 31 and the cavity inner wall protective film 19 to form a porous oxide film for plasma activation bonding, the adsorbed excess moisture and hydrogen gas generated by the decomposition of silanol groups during the post-annealing process can more easily escape. The post-annealing temperature for hydrophilic bonding can be reduced to approximately 300° C. Through the direct bonding of the chip on the voltage generation side to the chip on the impedance transformation element side, the space above the cavity inner wall protective film 19, formed by the concave portion for the vibration cavity, becomes a parallel annular vibration cavity 21a1 as shown in FIG. 18B, completing the acoustic element of the second embodiment.

Additionally, as mentioned above, the method for manufacturing the acoustic element of the second embodiment, illustrated using FIGS. 19A to 19K, is merely an example. For instance, the structure shown in FIG. 19F can also commence from the step of forming a SiO₂ film on an Si substrate through methods such as thermal oxidation. In this scenario, a third conductor film is comprehensively deposited on the SiO₂ film formed on the Si substrate using a sputtering method or the like. Then, the third conductor film is selectively etched using photolithography technology to form the pattern of the fixed potential electrode 24a as shown in FIG. 19F. Subsequently, on the pattern of the fixed potential electrode 24a, PZT22p is deposited to a desired thickness using methods such as high-frequency magnetron sputtering, MOCVD, or solution coating (sol-gel method). For instance, after performing high-frequency magnetron sputtering at room temperature, rapid thermal treatment at temperatures below approximately 500° C. using a halogen lamp or excimer laser can enhance the crystallinity of PZT22p.

Furthermore, if a second insulating film 31p is deposited on PZT22p using methods such as CVD, a “substructure” corresponding to the structure without the fixed potential electrode protection film 23 on the Si substrate is formed in the structure shown in FIG. 19F. However, not only the substructure corresponding to FIG. 19F, but also an enhanced structure is formed due to the substructure being set on a thick Si substrate through a SiO₂ film, which enhances the physical strength of the thin PZT22p by the thick Si substrate. The enhanced structure with the Si substrate is maintained until the process stage shown in FIG. 19K. That is, after directly bonding the voltage generating unit side chip and the impedance conversion element side chip, the SiO₂ film between the Si substrate and the fixed potential electrode 24a is removed to expose the fixed potential electrode 24a. Then, a fixed potential electrode protection film 23 such as epoxy resin is deposited on the exposed fixed potential electrode 24a, which also completes the acoustic element of the second embodiment.

### The Third Embodiment

As already illustrated in FIGS. 4C and 4D, in the circuit connection where the fixed potential electrode 24a is connected to the ground potential (GND), the potentials detected in the central region P₀, the first peripheral region P₁, . . . , and the fourth peripheral region P₄ defined in the potential transfer region of the voltage generation section 1a exhibit transient responses that oscillate in both positive and negative directions. To address the situation where the voltage generation section 1a generates voltage waveforms that oscillate in both positive and negative directions, the acoustic element according to the third embodiment of the present disclosure provides a structure that includes two types of active elements in the impedance conversion element 2c. Specifically, as shown in FIG. 20, the acoustic element according to the third embodiment includes a receiving element X_{i,j} that generates a non-uniform voltage through piezoelectric effect and operates with the potential at a specific position (local) of the voltage generation section 1a as a control voltage, and includes CMOS inverters (Qₚ, Qₙ) as the impedance conversion element 2c.

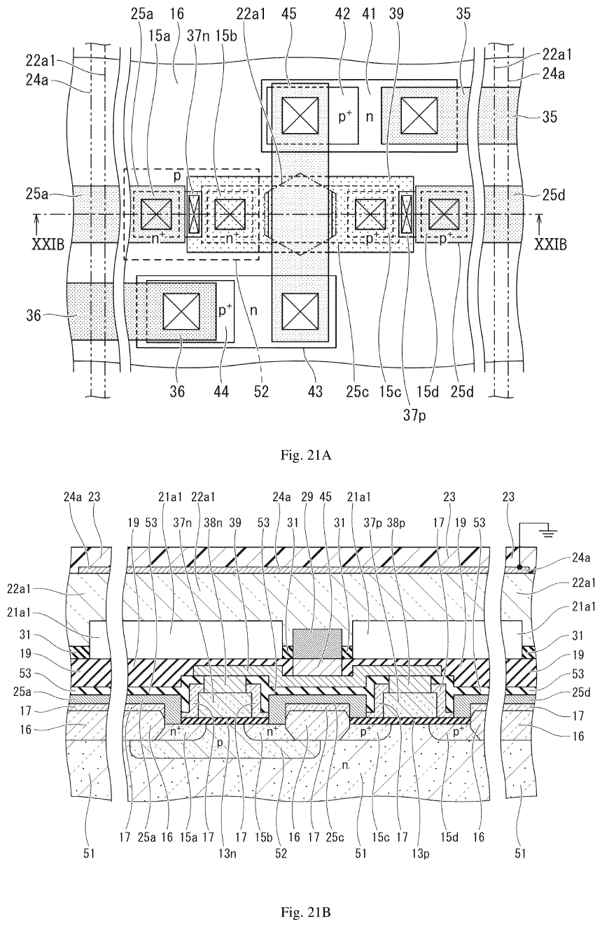

As can be seen from the cross-sectional view in FIG. 21B, the voltage generating section 1a features a vibrator 22a1 similar to the acoustic elements of the first and second embodiments, as well as a fixed potential electrode 24a in contact with the receiving surface (the upper main surface in FIG. 21B) of the vibrator 22a1, forming a unimorph structure. As shown in FIG. 21B, the entire vibrator 22a1 can be composed of piezoelectric materials belonging to 20 crystal point groups, or only the central downward protruding portion (stress concentration location) can be composed of 20 piezoelectric materials, while the remaining parts are composed of non-piezoelectric materials belonging to 12 other crystal groups. Among the 20 crystal point groups, materials such as HfO₂, AlN, and PZT belonging to the 10 crystal point groups with pyroelectric properties are particularly suitable as materials for the central downward protruding portion (stress concentration location) of the vibrator 22a1. That is, the voltage generating section 1a only needs to have a structure in which a piezoelectric layer is provided at the stress concentration location of the vibrator 22a1. Therefore, the impedance transforming element 2c can operate by using a specific local area of the piezoelectric layer provided at least in the downward protruding portion (stress concentration location) as a potential transfer area, and using the potential of this potential transfer area as a control voltage.

The voltage generation section 1a of the unimorph structure of the acoustic element according to the third embodiment is provided with at least a piezoelectric layer at a specific position on the output surface (the lower main surface in FIG. 21B) opposite to the receiving surface of the vibrating body 22a1 (the surface opposite to the receiving surface), and has a voltage distribution that generates uneven voltage through piezoelectric effect, producing higher voltage than other positions. The “specific position” on the output surface of the vibrating body 22a1 is, for example, any one of the central region P₀, the first peripheral region P₁, . . . , the fourth peripheral region P₄, or a combination of multiple regions, as shown schematically in FIG. 20 as a candidate model for arranging potential transfer regions. In the model representation of FIG. 20, the central region P₀, the first peripheral region P₁, . . . , the fourth peripheral region P₄ are arranged in a concentric hexagonal ring pattern centered around the central region P₀, with the first peripheral region P₁, the second peripheral region P₂, the third peripheral region P₃, and the fourth peripheral region P₄ surrounding the central region P₀ in a pattern that encircles it.

In the acoustic element of the third embodiment, the input electrodes of the CMOS inverters (Qₚ, Qₙ) functioning as the impedance conversion element 2c are connected to the central region P₀, which is the potential transfer region of the voltage generation unit 1a. By connecting the input electrodes to the central region P₀, which serves as the potential transfer region, the potential barrier heights generated in the respective channels of the p-type active element Qₚ and the n-type active element Qₙ of the CMOS inverters (Qₚ, Qₙ) are controlled by the potential of the central region P₀ of the voltage generation unit 1a. As the p-type active element Qₚ, it corresponds to p-channel MIS transistors such as p-channel MOSFET, p-channel MOSSIT, p-channel MISFET, p-channel MISSIT, and p-channel HEMT (hereinafter referred to as “pMIS transistor”). Similarly, as the n-type active element Qₙ, it corresponds to n-channel MIS transistors such as n-channel MOSFET, n-channel MOSSIT, n-channel MISFET, n-channel MISSIT, and n-channel HEMT (hereinafter referred to as “nMIS transistor”).

The CMOS inverter (Qₚ, Qₙ) includes an n-type active element Qₙ as the first active element, which connects the first main electrode region 15a to the first power supply V_{SS} (−V_{DD}) and connects the second main electrode region 15b to the output signal wiring 25c. The potential barrier in the n-type channel of the active element Qₙ acts as an obstacle for the main current (electrons) flowing between the first main electrode region 15a and the second main electrode region 15b of the active element Qₙ. On the other hand, the CMOS inverter (Qₚ, Qₙ) includes a p-type active element Qₚ as the second active element, which connects the third main electrode region 15d to the second power supply V_{DD}, which is at a higher potential than the first power supply V_{SS}, and connects the fourth main electrode region 15c to the output signal wiring 25c. The potential barrier in the p-type channel of the active element Qₚ acts as an obstacle for the main current (holes) flowing between the third main electrode region 15d and the fourth main electrode region 15c of the active element Qₚ. By connecting the CMOS inverter (Qₚ, Qₙ) as the impedance transforming element 2c between the first power supply V_{SS} (−V_{DD}) and the second power supply V_{DD}, as shown in FIG. 20, it is possible to correspond to input voltage waveforms that oscillate in both positive and negative directions, as exemplified in FIG. 4C and other FIGS.

The first control electrode 37n of the n-type active element Qₙ, which constitutes the CMOS inverter (Qₚ, Qₙ), is connected to the first input signal wiring 39 via the first gate connection plug 38n. On the other hand, the second control electrode 37p of the p-type active element Qₚ is connected to the first input signal wiring 39 via the second gate connection plug 38p. Then, as shown in FIG. 21B, a second input signal wiring 45 is provided on the first input signal wiring 39.

The CMOS inverters (Qₚ, Qₙ) constituting the impedance conversion element 2c transmit the potential of the central region P₀, located on the protruding portion of the output surface side of the vibrating body 22a1 (as shown in the central part of FIG. 21B), to the first control electrode 37n of the n-type active element Qₙ and the second control electrode 37p of the p-type active element Qₚ through the second input signal wiring 45 and the first input signal wiring 39. That is, the impedance conversion element 2c of the acoustic element according to the third embodiment uses the pressure of the ultrasonic wave Φ applied to the vibrating body 22a1 of the voltage generation section 1a as the potential of the central region P₀ as an input signal for the CMOS inverters (Qₚ, Qₙ), and outputs an impedance-converted signal from the output signal wiring 25c of the CMOS inverters (Qₚ, Qₙ). Then, the acoustic element according to the third embodiment uses the output signal of the CMOS inverters (Qₚ, Qₙ) as the output signal of the acoustic element.

The protruding portion on the output surface side of the vibrating body 22a1 constituting the voltage generating section 1a of the acoustic element according to the third embodiment is a regular hexagonal cylindrical protrusion as indicated by the two-dot chain line in FIG. 21A. As shown in FIG. 21B, around the protrusion provided at the central portion on the output surface side of the vibrating body 22a1, a parallel annular vibrating cavity 21a1 is provided in a centrally symmetric manner, surrounding the protrusion. The parallel annular structure constituting the vibrating cavity 21a1 has a hexagonal topology on the planar pattern. In the cross-sectional view representation of FIG. 21B, it appears that the two vibrating cavities 21a1 are located on both sides of the central protrusion, but in reality, they are a continuous integrated structure on the front and back of the paper surface.

The n-type active element Qₙ constituting the CMOS inverter (Qₚ, Qₙ) is shown in FIG. 21B. It features a well region 52 composed of a semiconductor region of the first conductivity type (p-type), and first and second main electrode regions 15a and 15b, spaced apart from each other, located above the well region 52 and composed of semiconductor regions of the second conductivity type (n⁺-type). The well region 52 is partially situated above a body region 51 composed of a semiconductor region of the second conductivity type (n-type). Additionally, as depicted in FIG. 21B, the n-type active element Qₙ comprises a first gate dielectric film 13n, which contacts the upper surface of the well region 52 between the first and second main electrode regions 15a and 15b and has a wider bandgap than the well region 52. A first control electrode 37n is positioned on the first gate dielectric film 13n, making it an active element. The p-type active element Qₚ, which constitutes the CMOS inverter (Qₚ, Qₙ), is shown in FIG. 21B. It features a body region 51, as well as a third main electrode region 15d and a fourth main electrode region 15c, which are spaced apart and composed of a first conductivity type (P⁺-type) semiconductor region, located above the body region 51. Additionally, as depicted in FIG. 21B, the p-type active element Qₚ includes a second gate dielectric film 13p, which contacts the upper surface of the body region 51 between the third main electrode region 15d and the fourth main electrode region 15c and has a wider bandgap than the body region 51. Furthermore, a second control electrode 37p is positioned on the second gate dielectric film 13p, making it an active element.

As shown in FIG. 20, a p-side clamp diode Dₖₚ is connected between the input signal terminals of the CMOS inverter (Qₚ, Qₙ) (corresponding to the first input signal wiring 39 and the second input signal wiring 45 in FIGS. 21A and 21B) and the second power supply V_{DD}. An n-side clamp diode Dₖₙ is connected between the input signal terminals and the first power supply V_{SS} (=−V_{DD}). By connecting the p-side clamp diode Dₖₚ and the n-side clamp diode Dₖₙ to the input signal terminals of the CMOS inverter (Qₚ, Qₙ), excessive gate voltage is prevented from being applied to the first gate dielectric film 13n of the n-type active element Qₙ and the second gate dielectric film 13p of the p-type active element Qₚ.

As described in the explanation of the second embodiment, it can be considered that the n-type active element Qₙ and the p-type active element Qₚ constituting the CMOS inverter (Qₚ, Qₙ) each have a heterojunction gate structure. As shown in FIG. 21B and other FIGS., in the acoustic element of the third embodiment, the second input signal wiring 45 of the CMOS inverter (Qₚ, Qₙ) is connected to the potential generation position P₀. Therefore, the potential barrier height generated in the n-type channel between the first main electrode region 15a and the second main electrode region 15b of the n-type active element Qₙ constituting the CMOS inverter (Qₚ, Qₙ) is controlled by the potential at the potential generation position P₀ through the first input signal wiring 39 connected to the second input signal wiring 45. Similarly, the potential barrier height generated in the p-type channel between the third main electrode region 15d and the fourth main electrode region 15c of the P-type active element Qₚ constituting the CMOS inverter (Qₚ, Qₙ) is also controlled by the potential at the potential generation position P₀, complementarily to the n-type active element Qₙ.

Around the well region 52, which is locally provided in the upper part of the n-type body region 51, there is a frame-shaped element isolation insulating film 16, which defines the range of the active region of the n-type active element Qₙ of the CMOS inverter (Qₚ, Qₙ). Adjacent to the frame-shaped bank defining the active region pattern of the n-type active element Qₙ, there is also a frame-shaped bank defining the active region pattern of the p-type active element Qₚ. That is, the active region of the n-type active element Q₁ and the active region of the p-type active element Qₚ are adjacent to each other through the element isolation insulating film 16. Inside the range of the active region of the n-type active element Qₙ surrounded by the element isolation insulating film 16, the region above the well region 52 is defined. Near the upper surface (surface) of the active region surrounded by the element isolation insulating film 16, there are provided a first main electrode region 15a and a second main electrode region 15b. Inside the active region pattern of the p-type active element Qₚ surrounded by the element isolation insulating film 16, the region above the body region 51 is defined. Near the upper surface (surface) of the active region surrounded by the element isolation insulating film 16, there are provided a third main electrode region 15d and a fourth main electrode region 15c. In the center of FIG. 21A, the potential transfer area of the regular hexagon is indicated by a double-dotted line. For the hexagonal potential transfer area defined as the protruding portion on the output surface side of the vibrating body 22a1, the n-type channel of the n-type active element Q₁ that constitutes the CMOS inverter (Qₚ, Qₙ) is formed near the surface of the rectangular area sandwiched between the first main electrode area 15a and the second main electrode area 15b. Similarly, the p-type channel of the P-type active element Qₚ that constitutes the CMOS inverter (Qₚ, Qₙ) is formed near the surface of the rectangular area sandwiched between the third main electrode area 15d and the fourth main electrode area 15c. Inside the active area of the n-type active element Qₙ, the potential barrier height for carrier movement generated in the n-type channel defined between the first main electrode area 15a and the second main electrode area 15b of the CMOS inverter (Qₚ, Qₙ) is controlled by the potential of the potential transfer area of the vibrating body 22a1. Similarly, inside the active area of the p-type active element Qₚ, the potential barrier height for carrier movement generated in the p-type channel defined between the third main electrode area 15d and the fourth main electrode area 15c of the CMOS inverter (Qₚ, Qₙ) is controlled by the potential of the potential transfer area of the vibrating body 22a1 in a complementary manner to the n-type active element Qₙ. As shown in FIG. 21B, an interlayer insulating film (first interlayer insulating film) 17 is provided on the first main electrode region 15a and the second main electrode region 15b. Through a contact hole opened in the first interlayer insulating film 17, the first main electrode region 15a is connected to a first main electrode wiring 25a, and the second main electrode region 15b is connected to an output signal wiring 25c. Additionally, through a contact hole opened in the first interlayer insulating film 17, the third main electrode region 15d is connected to a third main electrode wiring 25d, and the fourth main electrode region 15c is connected to an output signal wiring 25c. Above the first main electrode wiring 25a, the output signal wiring 25c, the third main electrode wiring 25d, as well as the first control electrode 37n of the n-type active element Qₙ and the second control electrode 37p of the p-type active element Qₚ, a second interlayer insulating film 53 is deposited. As shown in FIG. 21B, a first gate contact hole exposing the top of the first control electrode 37n and a second gate contact hole exposing the top of the second control electrode 37p are opened through the second interlayer insulating film 53 and the underlying first interlayer insulating film 17. A first gate connection plug 38n is embedded in the first gate contact hole, and a second gate connection plug 38p is embedded in the second gate contact hole, respectively achieving ohmic contact.

As shown in FIG. 21B, the first input signal wiring 39 is arranged on the second interlayer insulating film 53 to electrically connect the first gate connection plug 38n and the second gate connection plug 38p. As shown in the plan view of FIG. 21A, the second input signal wiring 45 is arranged in a direction orthogonal to the longitudinal direction of the first input signal wiring 39. As can be seen from the cross-sectional view of FIG. 21B, the second input signal wiring 45 is a wiring arranged on and in contact with the first input signal wiring 39. Since the first input signal wiring 39 electrically connects the first control electrode 37n of the n-type active element Qₙ and the second control electrode 37p of the p-type active element Qₚ to each other, as shown in FIG. 21A, the second input signal wiring 45 connects the first control electrode 37n and the second control electrode 37p together to the P⁺ type anode region 42 and the n-type cathode region 43.

Corresponding to the p-side clamping diode Dₖₚ in the equivalent circuit representation of FIG. 20, the p-n junction diode composed of the P⁺ type anode region 42 and the n type cathode region 41 is arranged in the paper area above the pattern of the first main electrode wiring 25a, the second input signal wiring 45, and the third main electrode wiring 25d in FIG. 21A. The longitudinal direction of the p-n junction diode composed of the P⁺ type anode region 42 and the n type cathode region 41 is parallel to the longitudinal direction of the pattern of the first main electrode wiring 25a and the output signal wiring 25c.

Similarly, corresponding to the n-side clamping diode Dₖₙ in FIG. 20, a p-n junction diode composed of a P⁺ type anode region 44 and an n-type cathode region 43 is arranged in the lower region of the paper surface in FIG. 21A, with its longitudinal direction parallel to the patterns of the first main electrode wiring 25a, the second input signal wiring 45, and the third main electrode wiring 25d. Connected to the anode region 44 of the n-side clamping diode Dₖₙ is the first power supply side diode wiring 36, and connected to the cathode region 41 of the p-side clamping diode Dₖₚ is the second power supply side diode wiring 35. As shown in FIG. 21B, a connection plug 29 with a multi-layer structure conductor whose surface layer is a soft metal is embedded from the tip side protruding from the center of the output surface side of the vibrating body 22a1, with its flat surface serving as the connection end face. Furthermore, the lower surface (connection end face) of the connection plug 29 is in physical contact with the upper surface of the second input signal wiring 45, thereby inputting the potential of the central region P₀ of the voltage generation section 1a as a control voltage to the CMOS inverters (Qₚ, Qₙ) constituting the impedance conversion element 2c. If the connection plug 29 is regarded as a constituent element, the voltage generation section 1a includes the vibrating body 22a1, the fixed potential electrode 24a, the fixed potential electrode protective film 23, and the connection plug 29.

That is, the potential of the connection plug 29 is input to the first input signal wiring 39 through the second input signal wiring 45, and the potential of the first input signal wiring 39 is transmitted to the first gate connection plug 38n and the second gate connection plug 38p. The potential of the first gate connection plug 38n is input to the first control electrode 37n, and the potential of the first control electrode 37n controls the potential barrier height between the first main electrode region 15a and the second main electrode region 15b through the first gate dielectric film 13n by electrostatic means. Similarly, the potential of the second gate connection plug 38p is input to the second control electrode 37p, and the potential of the second control electrode 37p controls the potential barrier height between the third main electrode region 15d and the fourth main electrode region 15c through the second gate dielectric film 13p by electrostatic means.

The structure shown in FIG. 21B is an example of a structure where the connection plug 29 provided on the voltage generation unit side chip on the upper side physically contacts the second input signal wiring 45 of the impedance conversion element side chip on the lower side. Therefore, around the vibration cavity 21a1, the direct bonding insulating film 31 with a mirror surface provided on the voltage generation unit side chip and the cavity inner wall protective film 19 with a mirror surface provided on the impedance conversion element side chip are directly bonded through hydrophilic bonding (hydrogen bonding between silanol groups). Compared to the structure connected by external wiring in Non-Patent Document 2, the acoustic element of the third embodiment is directly connected to the first gate connection plug 38n and the second gate connection plug 38p through the thin plate-shaped second input signal wiring 45 and the first input signal wiring 39, forming an electrical path, thereby enabling a reduction in floating impedance. In addition, due to the new structure of the stress reinforcement structure adopted for the voltage generation unit 1a, high sensitivity and broadband performance are achieved. Therefore, according to the acoustic element of the third embodiment, high sensitivity and broadband performance can be achieved. In particular, by microscopic research on the internal structure of the voltage generation unit 1a, selecting a specific position with the highest voltage generation as a potential transfer area, and using it as an input transmission position to the impedance conversion element 2c, it is easy to achieve high sensitivity.

### A Variation of the Third Embodiment

For convenience, the description has been provided with an example where the top (bottom) of the central protrusion of the vibration cavity 21a1 serves as the central region P₀ in the acoustic elements of the first to third embodiments. However, the potential transmission region for transmitting the potential at a specific position (local) of the voltage generation section 1b is not limited to the center of the vibration cavity 21a1. As shown in FIG. 22, the acoustic element of the modified example of the third embodiment of the present disclosure includes a receiving element X_{i,j} that generates a non-uniform voltage through piezoelectric effect and operates with the potential at a specific position (local) of the voltage generation section 1b as a control voltage. As can be seen from the cross-sectional view in FIG. 23, the voltage generation section 1b has a structure that is basically the same as that of the voltage generation section 1a of the acoustic elements of the first to third embodiments in terms of being a unimorph structure. However, as shown in FIGS. 22 and 23, the feature of transmitting the potential of the second peripheral region P₂ defined by the bottom of the hexagonal ring-shaped rib around the central region P₀ of the vibration cavity 21a1 to the impedance conversion element 2c differs from the structure of the acoustic elements of the first to third embodiments that have been described. The potential of the second peripheral region P₂ at the bottom of the hexagonal ring-shaped rib is determined by the W-shaped cross-sectional structure of the vibrating body 22e2 that transmits the potential to the impedance transformation element 2c, as well as the W-shaped cross-sectional structure of the fixed potential electrode 24e that contacts the receiving surface (the upper main surface in FIG. 23) of the vibrating body 22e2. The vibrating body 22e2 can be made of materials belonging to 20 crystal point groups. Among the 20 materials, materials such as HfO₂, AlN, and PZT belonging to 10 crystal point groups with pyroelectricity are suitable for use in the vibrating body 22e2. Although the cross-sectional structure shown in FIG. 23 is W-shaped, the planar structure of the acoustic element in the third embodiment variant is a hexagonal ring-shaped structure with 6-fold rotational symmetry about the rotation axis of the junction of two Vs that appear as a W-shape in the cross-sectional view.

As illustrated in FIGS. 10A and 10B, the voltage generating section 1b with a W-shaped cross-section in a unimorph structure exhibits a higher absolute potential |V_{P2}| in the second peripheral region P₂ located at the top of the two V-shaped sections of the W, compared to the absolute potentials |V_{P0}|, |V_{P1}|, |V_{P3}|, and |V_{P4}| in the central region P₀, the first peripheral region P₁, the third peripheral region P₃, and the fourth peripheral region P₄. Although the simulation results shown in FIGS. 10A and 10B depict a concentric circular pattern for the central region P₀, the first peripheral region P₁, . . . , and the fourth peripheral region P₄, there is essentially no difference even if they are in the shape of concentric hexagonal rings. That is, for the vibrator 22e2 with a W-shaped cross-section as shown in FIG. 23, the voltage is not generated at the central region P₀ defined by the central protrusion model, but rather at the second peripheral region P₂ surrounding the central region P₀, where a higher voltage is generated compared to other positions (central region P₀, first peripheral region P₁, third peripheral region P₃, and fourth peripheral region P₄). Therefore, the voltage generating section 1b with a W-shaped cross-section exhibits a non-uniform voltage distribution, with higher voltages generated at specific positions on the output surface (the lower main surface in FIG. 23) opposite the receiving surface of the vibrator 22e2, namely in the second peripheral region P₂, compared to other positions, namely the central region P₀, the first peripheral region P₁, the third peripheral region P₃, and the fourth peripheral region P₄.

As illustrated in FIG. 10B, the potentials detected in the central region P₀, the first peripheral region P₁, . . . , and the fourth peripheral region P₄ of the voltage generation unit 1b exhibit transient response waveforms that oscillate in both positive and negative directions. To accommodate input voltage waveforms that oscillate in both positive and negative directions, the acoustic element of the third embodiment variant is similar to that of the third embodiment, as shown in FIG. 22, and includes a CMOS inverter (Qₚ, Qₙ) as the impedance conversion element 2c. The input electrodes of the CMOS inverter (Qₚ, Qₙ) are connected to the second peripheral region P₂ of the voltage generation unit 1b, so that the potential barrier height generated in each channel of the p-type active element Qₚ and n-type active element Qₙ of the CMOS inverter (Qₚ, Qₙ) is controlled by the potential of the second peripheral region P₂ of the voltage generation unit 1b.

The CMOS inverter (Qₚ, Qₙ) includes an n-type active element Q₁ as the first active element, which connects the first main electrode region 15a to the first power supply Vss (−V_{DD}) and connects the second main electrode region 15b to the output signal wiring 25c. The potential barrier in the n-type channel of the n-type active element Qₙ acts as an obstacle for the main current (electrons) flowing between the first main electrode region 15a and the second main electrode region 15b of the active element Qₙ. On the other hand, the CMOS inverter (Qₚ, Qₙ) includes a p-type active element Qₚ as the second active element, which connects the third main electrode region 15d to the second power supply V_{DD}, which is at a higher potential than the first power supply V_{SS}, and connects the fourth main electrode region 15c to the output signal wiring 25c. The potential barrier in the p-type channel of the p-type active element Qₚ acts as an obstacle for the main current (holes) flowing between the third main electrode region 15d and the fourth main electrode region 15c of the active element Qₚ. By connecting the CMOS inverter (Qₚ, Qₙ) as the impedance transforming element 2c between the first power supply Vss (−V_{DD}) and the second power supply V_{DD}, as shown in FIG. 22, it is possible to correspond to input voltage waveforms that oscillate in both positive and negative directions, as exemplified in FIG. 10B and other FIGS.

The first control electrode 37n of the n-type active element Qₙ, which constitutes the CMOS inverter (Qₚ, Qₙ), is connected to the first input signal wiring 46 via the first gate connection plug 38n. On the other hand, the second control electrode 37p of the p-type active element Qₚ is connected to the first input signal wiring 46 via the second gate connection plug 38p. Then, as shown in FIG. 23, a hexagonal ring-shaped second input signal wiring 47 is provided on the first input signal wiring 46.

The CMOS inverters (Qₚ, Qₙ) constituting the impedance conversion element 2c transmit the potential of the second peripheral region P2, which is located in the middle of the radial direction of the vibration cavity 21e in FIG. 23 and serves as the hexagonal ring-shaped ridge portion on the output surface side of the vibrator 22e2, to the first control electrode 37n of the n-type active element Qₙ and the second control electrode 37p of the p-type active element Qₚ via the hexagonal ring-shaped second input signal wiring 47 and the first input signal wiring 46. That is, the impedance conversion element 2c of the acoustic element according to the modified example of the third embodiment uses the pressure of the ultrasonic wave (D applied to the vibrator 22e2 of the voltage generation unit 1b as the potential of the second peripheral region P₂ as an input signal to the CMOS inverters (Qₚ, Qₙ), and outputs an impedance-converted signal from the output signal wiring 25c of the CMOS inverters (Qₚ, Qₙ). Then, the acoustic element according to the modified example of the third embodiment uses the output signal of the CMOS inverters (Qₚ, Qₙ) as the output signal of the acoustic element.

In the acoustic element of the third embodiment variant, as shown in FIG. 23, a hexagonal ring-shaped rib is provided midway in the radial direction on the output surface side of the vibrating body 22e2. Therefore, in addition to the space of the vibrating cavity 21e inside the hexagonal ring-shaped rib, a space of the inclined annular vibrating cavity 21e is also provided outside the rib in a centrally symmetrical manner. The inclined annular structure constituting the space of the outer vibrating cavity 21e has a cross-sectional shape close to a right triangle, and its planar pattern is a hexagonal topology. In the cross-sectional view shown in FIG. 23, it appears that the two vibrating cavities 21e are located on both sides of the hexagonal ring-shaped rib, but in reality, they are a continuous integrated structure on the front and back of the paper surface.

The n-type active element Qₙ constituting the CMOS inverter (Qₚ, Qₙ) is shown in FIG. 23. It features a well region 52 composed of a p-type semiconductor region, as well as a first main electrode region 15a and a second main electrode region 15b, which are spaced apart and formed by n⁺-type semiconductor regions above the well region 52. The well region 52 is partially located above a body region 51 composed of an n-type semiconductor region. Additionally, as shown in FIG. 23, the n-type active element Qₙ includes a first gate dielectric film 13n, which contacts the upper surface of the well region 52 between the first main electrode region 15a and the second main electrode region 15b and has a wider bandgap than the well region 52. The first control electrode 37n is disposed on the first gate dielectric film 13n, making it an active element.

The p-type active element Qₚ constituting the CMOS inverter (Qₚ, Qₙ) is shown in FIG. 23. It features a body region 51, as well as a third main electrode region 15d and a fourth main electrode region 15c, which are spaced apart and composed of P⁺-type semiconductor regions, located above the body region 51. Additionally, as depicted in FIG. 23, the p-type active element Qₚ includes a second gate dielectric film 13p, which contacts the upper surface of the body region 51 between the third main electrode region 15d and the fourth main electrode region 15c and has a wider bandgap than the body region 51. Furthermore, a second control electrode 37p is positioned on the second gate dielectric film 13p, making it an active element. As shown in FIG. 22, a p-side clamp diode Dₖₚ is connected between the input signal terminals of the CMOS inverter (Qₚ, Qₙ) (corresponding to the first input signal wiring 46 and the second input signal wiring 47 in FIG. 23) and the second power supply V_{DD}. An n-side clamp diode Dₖₙ is connected between the input signal terminals and the first power supply Vss (−V_{DD}). By connecting the p-side clamp diode Dₖₚ and the n-side clamp diode Dₖₙ to the input signal terminals of the CMOS inverter (Qₚ, Qₙ), excessive gate voltage is prevented from being applied to the first gate dielectric film 13n of the n-type active element Qₙ and the second gate dielectric film 13p of the p-type active element Qₚ.

As shown in FIGS. 22 and 23, in the acoustic element of the third embodiment variant, the hexagonal ring-shaped second input signal wiring 47 of the CMOS inverter (Qₚ, Qₙ) is connected to the potential generation position P₂. Therefore, through the first input signal wiring 46 connected to the second input signal wiring 47, the potential barrier height generated in the n-type channel between the first main electrode region 15a and the second main electrode region 15b of the n-type active element Qₙ constituting the CMOS inverter (Qₚ, Qₙ) is controlled by the potential at the potential generation position P₂. Similarly, the potential barrier height generated in the p-type channel between the third main electrode region 15d and the fourth main electrode region 15c of the p-type active element Qₚ constituting the CMOS inverter (Qₚ, Qₙ) is also controlled by the potential at the potential generation position P₂, complementarily to the n-type active element Qₙ.

Around the well region 52, which is locally set on the upper part of the n-type substrate region 51, there is an element isolation insulating film 16, which is in the shape of a frame, used to define the range of the active region of the n-type active element Qₙ of the CMOS inverter (Qₚ, Qₙ). It is adjacent to the frame-shaped bank that defines the pattern of the active region of the n-type active element Qₙ. A frame-shaped bank is also provided to define the active region pattern of the p-type active element Qₚ. That is, the active region of the n-type active element Qₙ and the active region of the p-type active element Qₚ are adjacent to each other through the element isolation insulating film 16. Within the active region of the n-type active element Qₙ surrounded by the element isolation insulating film 16, the region on the upper surface of the well region 52 is defined. Near the upper surface (surface) of the active region surrounded by the element isolation insulating film 16, the first main electrode region 15a and the second main electrode region 15b are provided. Within the active region pattern of the p-type active element Qₚ surrounded by the element isolation insulating film 16, the region on the upper surface of the body region 51 is defined. Near the upper surface (surface) of the active region surrounded by the element isolation insulating film 16, the third main electrode region 15d and the fourth main electrode region 15c are provided.

The n-type channel of the n-type active element Qₙ constituting the CMOS inverter (Qₚ, Qₙ) is formed near the surface of the rectangular region sandwiched between the first main electrode region 15a and the second main electrode region 15b. Similarly, the p-type channel of the p-type active element Qₚ constituting the CMOS inverter (Qₚ, Qₙ) is formed near the surface of the rectangular region sandwiched between the third main electrode region 15d and the fourth main electrode region 15c. Inside the semiconductor region serving as the active area of the n-type active element Qₙ, the height of the potential barrier for carrier movement generated in the n-type channel defined by the first main electrode region 15a and the second main electrode region 15b is electrostatically controlled by the potential of the potential transfer region of the vibrating body 22e2. Similarly, inside the semiconductor region serving as the active area of the p-type active element Qₚ, the height of the potential barrier for carrier movement generated in the p-type channel defined by the third main electrode region 15d and the fourth main electrode region 15c is controlled in a complementary manner to the n-type active element Qₙ by the potential of the potential transfer region of the vibrating body 22e2.

As shown in FIG. 23, a first interlayer insulating film 17 is provided on the first main electrode region 15a and the second main electrode region 15b. Through contact holes opened in the first interlayer insulating film 17, the first main electrode region 15a is connected to a first main electrode wiring 25a, and the second main electrode region 15b is connected to an output signal wiring 25c. Additionally, through contact holes opened in the first interlayer insulating film 17, the third main electrode region 15d is connected to a third main electrode wiring 25d, and the fourth main electrode region 15c is connected to an output signal wiring 25c. A second interlayer insulating film 53 is deposited above the first main electrode wiring 25a, the output signal wiring 25c, the third main electrode wiring 25d, as well as the first control electrode 37n of the n-type active element Qₙ and the second control electrode 37p of the p-type active element Qₚ.

As shown in FIG. 23, holes are opened through the second interlayer insulating film 53 and the underlying first interlayer insulating film 17, exposing the first gate contact hole at the top of the first control electrode 37n and the second gate contact hole at the top of the second control electrode 37p. A first gate connection plug 38n is embedded in the first gate contact hole, and a second gate connection plug 38p is embedded in the second gate contact hole. It is also possible to refer to the integrated structure connecting the first control electrode 37n to the first gate connection plug 38n as the “first gate terminal (37n, 38n)”, and the integrated structure connecting the second control electrode 37p to the second gate connection plug 38p as the “second gate terminal (37p, 38p)”.

As shown in FIG. 23, the first input signal wiring 46 is provided on the second interlayer insulating film 53 to electrically connect the first gate connection plug 38n and the second gate connection plug 38p. Although not shown in the plan view, a hexagonal ring-shaped second input signal wiring 47 is provided in a direction intersecting the longitudinal direction of the first input signal wiring 46. As can be seen from the cross-sectional view of FIG. 23, the second input signal wiring 47 is a wiring that is provided on the first input signal wiring 46 and contacts the first input signal wiring 46 at two points. The first input signal wiring 46 electrically connects the first control electrode 37n of the n-type active element Qₙ and the second control electrode 37p of the p-type active element Qₚ to each other. Therefore, the second input signal wiring 47 connects the first control electrode 37n and the second control electrode 37p together to the anode region of the p-side clamp diode Dₖₚ and the cathode region of the n-side clamp diode Dₖₙ. It is also possible to refer to the integrated structure connecting the first input signal wiring 46 and the second input signal wiring 47 as “input signal wiring (46, 47)”. In this representation, the input signal wiring (46, 47) is connected to the first gate terminal (37n, 38n) and the second gate terminal (37p, 38p).

Connected to the anode region of the n-side clamping diode Dₖₙ is the first power-side diode wiring, while connected to the cathode region of the p-side clamping diode Dₖₚ is the second power-side diode wiring. As shown in FIG. 23, a conductor-made land 48 is provided at the bottom of the hexagonal ring-shaped ridge on the output surface side of the vibrating body 22e2 to achieve ohmic contact. Moreover, the lower surface (connection end face) of the hexagonal ring-shaped land 48 physically contacts the upper surface of the hexagonal ring-shaped second input signal wiring 47, thereby inputting the potential of the second peripheral region P₂ of the voltage generation section 1b as a control voltage to the CMOS inverters (Qₚ, Qₙ) constituting the impedance conversion element 2c. If the land 48 is regarded as a constituent element, the voltage generation section 1b includes the vibrating body 22e2, the fixed potential electrode 24e, the fixed potential electrode protective film 23, and the land 48. A connection means such as a bump may also be further sandwiched between the land 48 and the second input signal wiring 47.

That is, the potential of the hexagonal ring-shaped connection pad 48 is inputted to the first input signal wiring 46 through the hexagonal ring-shaped second input signal wiring 47, and the potential of the first input signal wiring 46 is transmitted to the first gate connection plug 38n and the second gate connection plug 38p. The potential of the first gate connection plug 38n is inputted to the first control electrode 37n, and the potential of the first control electrode 37n electrostatically controls the potential barrier height between the first main electrode region 15a and the second main electrode region 15b through the first gate dielectric film 13n. Similarly, the potential of the second gate connection plug 38p is inputted to the second control electrode 37p, and the potential of the second control electrode 37p electrostatically controls the potential barrier height between the third main electrode region 15d and the fourth main electrode region 15c through the second gate dielectric film 13p.

The structure shown in FIG. 23 is an example of a structure where the connection pad 48 provided on the voltage generation unit side chip on the upper side physically contacts the hexagonal ring-shaped second input signal wiring 47 of the impedance conversion element side chip on the lower side. Therefore, around the vibration cavity 21e, the direct bonding insulating film 31 with a mirror surface provided on the voltage generation unit side chip and the cavity inner wall protective film 19 with a mirror surface provided on the impedance conversion element side chip are directly bonded through hydrophilic bonding (hydrogen bonding between silanol groups). The acoustic element of the third embodiment variant is directly connected to the first gate connection plug 38n and the second gate connection plug 38p through a thin plate-shaped connection pad 48, the second input signal wiring 47, and the first input signal wiring 46, thereby reducing the floating impedance. In addition, since the voltage generation unit 1b adopts a W-shaped structure with a stress reinforcement structure, achieving high sensitivity and broadband performance, the acoustic element according to the third embodiment variant can achieve high sensitivity and broadband performance. In particular, selecting a specific position of the voltage generation unit 1b that generates the highest voltage as the potential transfer area and as the input transmission position to the impedance conversion element 2c makes it easy to achieve high sensitivity.

### The Fourth Embodiment

In the acoustic elements of the first to third embodiments, the structure has been described where one potential transfer region of the voltage generation section is selected, and the potential of this region is transmitted from the voltage generation section to the impedance conversion element. However, there can be multiple potential transfer regions for transmitting the potential of the voltage generation section to the impedance conversion element, and their potentials and phases can vary. For example, in the vibrator 22a1 with a parallel ring structure, as shown in FIG. 4C and other FIGS., the central voltage V_{P0} of the central region P₀ and the fourth peripheral voltage VP₄ of the fourth peripheral region P₄ vibrate in opposite phases to the first peripheral voltage V_{P1} of the first peripheral region P₁, the second peripheral voltage V_{P2} of the second peripheral region P₂, and the third peripheral voltage V_{P3} of the third peripheral region P₃, as already explained. For the vibrator 22d with an M-shaped structure, as shown in FIG. 9B, it has also been explained that the central voltage V_{P0} vibrates in opposite phases to the first peripheral voltage V_{P1}, the second peripheral voltage V_{P2}, and the third peripheral voltage V_{P3}. Additionally, for the vibrator 22e with a W-shaped structure, as shown in FIG. 10B, it has also been explained that the central voltage V_{P0} vibrates in opposite phases to the first peripheral voltage V_{P1}, the second peripheral voltage V_{P2}, the third peripheral voltage V_{P3}, and the fourth peripheral voltage V_{P4}.

The CMOS inverter described in the third embodiment is a semiconductor integrated circuit comprising two active elements. The acoustic element according to the fourth embodiment of the present disclosure, as shown in FIG. 24, includes: a voltage generation unit 1c that generates non-uniform voltages through the piezoelectric effect; and receiving elements X_{i,j}, where the potentials at specific multiple locations (local) of the voltage generation unit 1c are supplied as independent control voltages for multiple active elements constituting the semiconductor integrated circuit of the impedance conversion element 2d. Specifically, the potentials of specific multiple potential transfer regions of the voltage generation unit 1c are independently transmitted as independent control voltages for specific multiple active elements selected from among the multiple active elements included in the semiconductor integrated circuit. Furthermore, the selected multiple active elements are individually controlled, and through the operation of these active elements, the other unselected active elements also operate. In the example shown in FIG. 24, the potentials of two phase-different potential transfer regions, namely the central region P₀ and the second peripheral region P₂, of the voltage generation unit 1c, are independently transmitted to two input terminals of the semiconductor integrated circuit constituting the impedance conversion element 2d.

The acoustic element according to the fourth embodiment, as shown in FIG. 24, includes a semiconductor integrated circuit (Q₁₁, Q₁₂, Q₁₃, Q₁₄, Q₁₅) composed of five active elements Q₁₁, Q₁₂, Q₁₃, Q₁₄, and Q₁₅ as an impedance conversion element 2d. Among them, the selected two active elements Q₁₁ and Q₁₂ are controlled by the potentials of two potential transfer regions, namely, the central region P₀ and the second peripheral region P₂. Specifically, as the semiconductor integrated circuit (Q₁₁, Q₁₂, Q₁₃, Q₁₄, Q₁₅), a dual-input differential amplifier with first and second input terminals can be exemplified. That is, the semiconductor integrated circuit (Q₁₁, Q₁₂, Q₁₃, Q₁₄, Q₁₅), as shown in FIG. 24, includes a dual-input differential pair circuit (Q₁₁, Q₁₂), a current mirror pair circuit (Q₁₃, Q₁₄), and a constant current source (Q₁₅), constituting a differential amplifier. Generally, a differential amplifier may also include an output circuit composed of two active elements. In this case, two of the seven active elements are independently controlled by the potentials of the two potential transfer regions.

The differential pair circuit (Q₁₁, Q₁₂) comprises a first main electrode region and a second main electrode region. The first n-type active element Q₁₁ controls the main current flowing between the first main electrode region and the second main electrode region based on the potential of the first input terminal. The second n-type active element Q₁₂ features a third main electrode region and a fourth main electrode region, regulating the main current flowing between the third and fourth main electrode regions according to the potential of the second input terminal. For instance, both the first n-type active element Q₁₁ and the second n-type active element Q₁₂ can be nMIS transistors, such as n-channel MOSFETs (hereinafter referred to as “nMOSFETs”). As illustrated in FIG. 24, the first main electrode region of the first n-type active element Q₁₁ and the third main electrode region of the second n-type active element Q₁₂ are connected to a common node, maintaining the same potential.

The current mirror pair circuit (Q₁₃, Q₁₄) consists of a first p-type active element Q₁₃ with a fifth main electrode region and a sixth main electrode region, and a second p-type active element Q₁₄ with a seventh main electrode region and an eighth main electrode region. The first p-type active element Q₁₃ and the second p-type active element Q₁₄ can be, for example, pMIS transistors such as p-channel MOSFETs (hereinafter referred to as “pMOSFETs”). The gate of the first p-type active element Q₁₃ and the second p-type active element Q₁₄ are both connected to the sixth main electrode region of the first p-type active element Q₁₃. The sixth main electrode region of the first p-type active element Q₁₃ is also connected to the second main electrode region of the first n-type active element Q₁₁, and the eighth main electrode region of the second p-type active element Q₁₄ is connected to the fourth main electrode region of the second n-type active element Q₁₂.

The constant current source (Q₁₅) is composed of the third n-type active element Q₁₃, which features a ninth main electrode region and a tenth main electrode region. For instance, the third n-type active element Q₁₃ can be an nMIS transistor such as an nMOSFET. The tenth main electrode region of the third n-type active element Q₁₃ is connected to the common node where the first main electrode region of the first n-type active element Q₁₁ and the third main electrode region of the second n-type active element Q₁₂ are interconnected. Additionally, the tenth main electrode region of the third n-type active element Q₁₃ is connected to the first power supply (GND), while the fifth main electrode region of the first p-type active element Q₁₃ and the seventh main electrode region of the second p-type active element Q₁₄ are connected to the second power supply V_{DD}, which has a higher potential than the first power supply.

The differential pair circuit (Q₁₁, Q₁₂) is shown in FIG. 24. It inputs the central region P₀ to the first input terminal and inputs the second peripheral region P₂ of the hexagonal ring to the first input terminal, detecting the potential difference between the two inputs. The potential difference detected by the differential pair circuit (Q₁₁, Q₁₂) is converted into a current difference. The constant current source (Q₁₅) adjusts the constant current value by applying the potential V_{b1} from the outside to the gate of the third n-type active element Q₁₃ and changing the potential V_{b1}. The constant current source (Q₁₅) always provides a constant current, enabling the output of signals without waveform and characteristic distortion over a wide voltage range. In the current mirror pair circuit (Q₁₃, Q₁₄), when the first p-type active element Q₁₃ and the second p-type active element Q₁₄ are pMOSFETs, as long as they operate in the saturation region of the pMOSFETs, the same current flows through the first p-type active element Q₁₃ and the second p-type active element Q₁₄. In the differential pair circuit (Q₁₃, Q₁₄), the potential difference between the central region P₀ input to the gate of the first n-type active element Q₁₁ (i.e., the first input terminal) and the potential of the second peripheral region P₂ input to the gate of the second n-type active element Q₁₂ (i.e., the second input terminal) is converted into a current difference.

If the potential input to the central region P₀ of the gate (i.e., the first input terminal) of the first n-type active element Q₁₁ is greater than the potential input to the second peripheral region P₂ of the gate (i.e., the second input terminal) of the second n-type active element Q₁₂, the current in the path of the first n-type active element Q₁₁ increases. The current difference generated by the differential pair circuit (Q₁₃, Q₁₄) is output as Vout. As shown in FIG. 24, by inputting the potential of the central region P₀ to the gate (i.e., the first input terminal) of the first n-type active element Q₁₁, the potential barrier height generated in the channel of the first n-type active element Q₁₁ is controlled by the potential of the central region P₀ of the voltage generation unit 1c. Furthermore, by inputting the potential of the second peripheral region P₂ to the gate (i.e., the second input terminal) of the second n-type active element Q₁₂, the potential barrier height generated in the channel of the second n-type active element Q₁₂ is controlled by the potential of the second peripheral region P₂ of the voltage generation unit 1c.

The potential barrier in the n-type channel of the first n-type active element Q₁₁ acts as a barrier to the movement of the main current (electrons) flowing between the first main electrode region and the second main electrode region of the first n-type active element Q₁₁. On the other hand, the potential barrier in the n-type channel of the second n-type active element Q₁₂ acts as a barrier to the movement of the main current (electrons) flowing between the third main electrode region and the fourth main electrode region of the second n-type active element Q₁₂. Although the specific integrated structure is omitted in the illustration, similar to the structure exemplified in the acoustic element and the like of the third embodiment, by using thin plate-shaped connection pads, second input signal wiring, and first input signal wiring, etc., direct connection to the first and second gate connection plugs can be achieved, thereby reducing floating impedance. In addition, due to the stress enhancement structure adopted in the voltage generation portion 1c, high sensitivity and broadband performance are achieved. According to the acoustic element related to the fourth embodiment, high sensitivity and broadband performance can be realized. Specifically, in the internal structure of the voltage generation portion 1c, two specific locations with higher voltage generation are selected as potential transfer regions and used as input transmission locations to the impedance conversion element 2d, thus facilitating the achievement of high sensitivity.

### The Fifth Embodiment

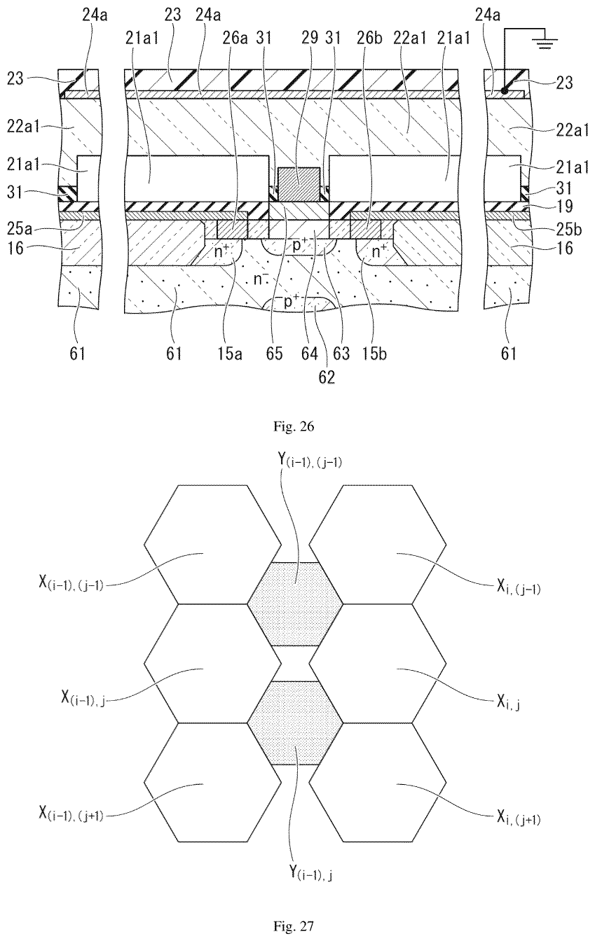

The acoustic element according to the fifth embodiment of the present disclosure, as shown in FIG. 25, includes: a voltage generating unit 1a that generates non-uniform voltage through the piezoelectric effect; and a receiving element X_{i,j} that includes an impedance transforming element 2e that operates with the potential at a specific position (local) of the voltage generating unit 1a as a control voltage. As shown in the cross-sectional view of FIG. 26, the voltage generating unit 1a has a vibrator 22a1 similar to the acoustic elements according to the first to fourth embodiments, and a fixed potential electrode 24a that contacts the receiving surface (the upper main surface in FIG. 26) of the vibrator 22a1, forming a unimorph structure. The vibrator 22a1 can be entirely composed of piezoelectric materials belonging to 20 crystal point groups as shown in FIG. 26, or only the central downward protrusion (stress concentration position) can be selectively composed of 20 piezoelectric materials, while the remaining part is composed of other 12 non-piezoelectric materials in the crystal group (omitted in the FIG.). Among the 20 crystal point groups, materials such as HfO₂, AlN, and PZT belonging to the 10 crystal point groups exhibiting pyroelectricity are suitable as materials for the central downward protrusion (stress concentration position) of the vibrator 22a1.

That is, the voltage generating unit 1a only needs to have a structure in which at least a piezoelectric layer is provided at the stress concentration position of the vibrating body 22a1. Therefore, the impedance transforming element 2e can operate with the potential of a specific local area of the piezoelectric layer provided at least at the downward protrusion (stress concentration position) as a potential transmission area, and use the potential of this potential transmission area as a control voltage. This single piezoelectric crystal type voltage generating unit 1a has a voltage distribution that generates unevenly produced voltage with higher voltage than other positions through piezoelectric effect at a specific position on the output surface (lower main surface in FIG. 26) opposite to the receiving surface of the vibrating body 22a1. The “specific position” on the output surface of the vibrating body 22a1 is, for example, the central region P₀, the first peripheral region P₁, . . . , the fourth peripheral region P₄ as shown in the schematic model in FIG. 25. The central region P₀, the first peripheral region P₁, . . . , the fourth peripheral region P₄ in the model representation of FIG. 25 are arranged in a concentric hexagonal pattern centered around the central region P₀, with the first peripheral region P₁, the second peripheral region P₂, the third peripheral region P₃, and the fourth peripheral region P₄ surrounding the central region P₀ in a concentric hexagonal pattern.

The impedance transforming element 2e is represented by an equivalent circuit of a junction transistor as an active element. The junction transistor (hereinafter referred to as the “junction active element”) constituting the impedance transforming element 2e operates with the potential at the central region P₀ of the protrusion on the output surface side of the vibrating body 22a1, as shown in the central part of FIG. 26, as a control voltage. That is, the impedance transforming element 2e of the acoustic element according to the fifth embodiment includes a junction active element that inputs the pressure of the ultrasonic wave Φ applied to the vibrating body 22a1 of the voltage generating section 1a as the potential at the central region P₀ and outputs a signal after impedance transformation. Furthermore, the acoustic element according to the fifth embodiment uses the output signal of the junction active element as the output signal of the acoustic element.

Although the illustration is omitted, the protrusion on the output surface side of the vibrator 22a1 of the voltage generating section 1a of the acoustic element according to the fifth embodiment is a regular hexagonal columnar protrusion similar to the one indicated by the two-dot chain line in FIGS. 1B and 18A. As shown in FIG. 26, around the protrusion located in the central part of the output surface side of the vibrator 22a1, a parallel annular vibration cavity 21a1 is arranged symmetrically around the protrusion. The annular structure constituting the vibration cavity 21a1 is a topological structure with a hexagonal planar pattern. In the cross-sectional view representation of FIG. 26, it appears that two vibration cavities 21a1 are located on both sides of the central protrusion, but in reality, they are an integrated structure that is continuous on both the front and back sides of the paper surface.

The junction active element of the impedance conversion element 2e of the acoustic element according to the fifth embodiment, as shown in FIG. 26, includes: a base region 61 composed of a semiconductor region of the first conductivity type (n⁻-type); a first main electrode region 15a and a second main electrode region 15b, which are spaced apart from each other on the base region 61 and are composed of semiconductor regions of the first conductivity type (n⁺-type) with a higher impurity density than the base region 61. In addition, the junction active element constituting the impedance conversion element 2e has a surface control electrode region 63 composed of semiconductor regions of the second conductivity type (p⁺-type) forming a p-n junction with the base region 61, located in the upper part of the base region 61 between the first main electrode region 15a and the second main electrode region 15b. And below the surface control electrode region 63, opposite the base region 61, an auxiliary control electrode region 62 composed of semiconductor regions of the second conductivity type (p⁺-type) defining a channel region between the first main electrode region 15a and the second main electrode region 15b is defined. Furthermore, the junction active element constituting the impedance conversion element 2e includes a control electrode 64 metallurgically connected to the potential generation position P₀, which controls the potential barrier height of carrier movement generated in the channel by the potential of the potential generation position P₀. Although the plan view is omitted, around the base region 61, the element isolation insulating film 16 is arranged in a frame shape to define the range of the active region of the junction-type active element. In the cross-sectional representation of FIG. 26, the element isolation insulating film 16 is located on both sides of the active region. However, similar to the structures of the acoustic elements according to the first and second embodiments, the element isolation insulating film 16 located on both sides of the active region is an integrated structure that is continuous on both the front and back sides of the paper. Inside the active region pattern surrounded by the element isolation insulating film 16, the region on the upper surface of the base region 61 is defined. On the upper part of the active region surrounded by the element isolation insulating film 16, the first main electrode region 15a and the second main electrode region 15b are provided.

Similar to the planar views in FIGS. 1B and 18A, where the range of the hexagonal potential transfer area is indicated by a two-dot chain line, for the hexagonal potential transfer area defined by the protrusion on the output surface side of the vibrating body 22a1, the channel of the junction active element is formed within a rectangular area sandwiched between the first main electrode region 15a and the second main electrode region 15b, and is formed between the surface control electrode region 63 and the auxiliary control electrode region 62. Within the semiconductor region serving as the active area, the potential barrier height for carrier movement generated in the channel between the first main electrode region 15a and the second main electrode region 15b, where the active element is bonded, is controlled electrostatically by the potential conducted from the potential conduction region of the vibrating body 22a1 to the control electrode 64 through this p-n junction, between the surface control electrode region 63 and the base region 61.

As shown in FIG. 26, an interlayer insulating film is provided on the first main electrode region 15a and the second main electrode region 15b. Through contact holes opened in the interlayer insulating film, the first main electrode region 15a is connected to the first main electrode wiring 25a, and the second main electrode region 15b is connected to the second main electrode wiring 25b. As shown in FIG. 26, an input signal wiring 65 composed of a conductor is provided on the control electrode 64. As shown in FIG. 26, a connection plug 29 of a multi-layer structure conductor with a soft metal surface layer is buried from the front end side of the central protrusion on the output surface side of the vibrator 22a1, so that the flat surface serves as a connection end face, and the vibrator 22a1 and the connection plug 29 are in ohmic contact. Furthermore, the lower surface (i.e., the connection end face) of the connection plug 29 is in physical contact with the upper surface of the input signal wiring 65, so that the potential of the central region P₀ of the voltage generating portion 1a is input as a control voltage for the junction active element constituting the impedance conversion element 2e.

That is, the potential of the connection plug 29 is input to the control electrode 64 through the input signal wiring 65, and the potential of the control electrode 64 controls the potential barrier height of carrier movement generated in the channel between the first main electrode region 15a and the second main electrode region 15b through the p-n junction between the surface control electrode region 63 and the base region 61. The structure shown in FIG. 26 is an example of a structure in which the connection plug 29 of the voltage generation unit side chip located on the upper side and the input signal wiring 65 of the impedance conversion element side chip located on the lower side are in physical contact with each other. Therefore, around the vibration cavity 21a1, the direct bonding insulating film 31 with a mirror surface provided on the voltage generation unit side chip and the cavity inner wall protective film 19 with a mirror surface provided on the impedance conversion element side chip are directly bonded through hydrophilic bonding (hydrogen bonding between silanol groups). In the acoustic element according to the fifth embodiment, by using a thin plate-shaped input signal wiring 65, the connection plug 29 can be connected to the control electrode 64, thereby reducing the floating impedance. In addition, since the voltage generation unit 1a adopts a stress enhancement structure, high sensitivity and broadband performance are achieved. According to the acoustic element according to the fifth embodiment, high sensitivity and broadband performance can be achieved. Specifically, by microscopic research on the internal structure of the voltage generation unit 1a, a specific position with the highest voltage generation is selected as a potential transfer region and used as an input transmission position to the impedance conversion element 2e, thus facilitating high sensitivity.

### Other Embodiments

As mentioned above, although the first to fifth embodiments have been exemplified, it should be understood that the discussion and drawings constituting a part of this disclosure are not intended to limit the disclosure. From this disclosure, those skilled in the art will be clear about various alternative embodiments, examples, and operational techniques. For instance, in the acoustic elements discussed in the first to fifth embodiments, the focus has been primarily on the receiving element. However, the technical concept of the present disclosure is not limited to the receiving element. By adding a driving electrode required for voltage driving of the piezoelectric layer through the piezoelectric effect in the structure of the acoustic elements discussed in the first to fifth embodiments, it can also function as a transceiving element.

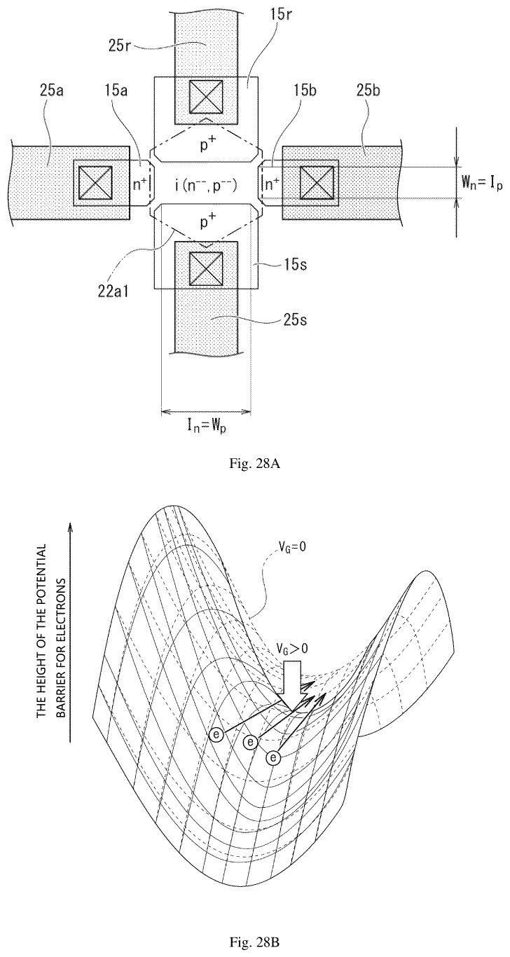

Alternatively, as shown in FIG. 27, the acoustic element integrated circuit involved in other embodiments can mix dedicated receiving unit cells with dedicated transmitting unit cells that are configured independently from the receiving unit cells, to form a two-dimensional array. In FIG. 27, between the (i−1)th column of receiving unit cells X_{(i-1), (j-1)}, X_{(i-1), j}, X_{(i-1), (j+1)}, . . . , and the i-th column of receiving unit cells X_{i, (j-1)}, X_{i, j}, X_{i, (j+1)}, . . . , there are arranged the (i−1)th column of transmitting unit cells Y_{(i-1), (j-1)}, Y_{(i-1), j}, . . . , which are displayed in gray. The receiving unit cells X_{(i-1), (j-1)}, X_{(i-1), j}, X_{(i-1), (j+1)}, . . . , can adopt any structure of acoustic elements involved in the first to fifth embodiments. The transmitting unit cells Y_{(i-1), (j-1)}, Y_{(i-1), j}, . . . , can adopt structure with driving electrodes that drive known piezoelectric layers through the piezoelectric effect.

In addition, the impedance conversion element described in the acoustic elements according to the first to fifth embodiments is merely an example and does not limit the scope of application of the present disclosure. For instance, an acoustic element may also include a semiconductor integrated circuit as the impedance conversion element 2f, as shown in FIG. 28A. Specifically, as an acoustic element according to another embodiment, it can be exemplified as a case where a voltage generation section 1a, which generates a non-uniform voltage through the piezoelectric effect, as shown in FIG. 28D, and a “positive complementary element circuit” that operates by inputting a potential that vibrates a specific position (local) of the voltage generation section 1a in both positive and negative directions as a control voltage, are included as the impedance conversion element 2f. It should be noted that the circuit configuration when including the “positive complementary element circuit” shown in FIG. 28A as the impedance conversion element 2f is merely an example and is not limited to the circuit topology shown in FIG. 28D. The positive complementary element circuit has four terminals for defining the main current. The circuit connecting the four terminals of the positive complementary element circuit is arbitrary, and can be various circuit configurations such as a circuit configuration similar to a common CMOS inverter. Although the cross-sectional view is omitted, similar to the cross-sectional view shown in FIG. 18B, the voltage generation section 1a shown in FIG. 28D has a vibrator 22a1 similar to the acoustic element according to the first embodiment and a fixed potential electrode 24a that contacts the receiving surface (the upper main surface similar to the structure shown in FIG. 18B) of the vibrator 22a1, forming a unimorph structure.

On the fixed potential electrode 24a of the voltage generation unit 1a shown in FIG. 28D, similarly to the structures of the acoustic elements according to the first to fifth embodiments, a fixed potential electrode protective film 23, such as epoxy resin, is provided. Due to the non-uniform voltage distribution of the voltage generation unit 1a with a unimorph structure, a higher voltage is generated at a specific position on the output surface (the surface opposite to the receiving surface) of the vibrating body 22a1 facing the receiving surface, through the piezoelectric effect, compared to other positions. In the model representation of FIG. 28D, the central region P₀, the first peripheral region P₁, . . . , and the fourth peripheral region P₄ are arranged in a concentric hexagonal pattern centered around the central region P₀, with the first peripheral region P₁, the second peripheral region P₂, the third peripheral region P₃, and the fourth peripheral region P₄ surrounding the central region P₀ in a concentric hexagonal pattern. The impedance conversion element 2f in other embodiments involves a complementary element circuit consisting of an n-channel insulated gate SIT as the active element Qₙ and a p-channel insulated gate SIT as the active element Qₚ. Their channels are shared, and the carrier movement direction in the channels is orthogonal, forming a channel-crossing complementary MIS integrated circuit. In the circuit configuration shown in FIG. 28D, the first main electrode region 15a of the n-channel active element Qₙ is connected to the first power supply (GND) through the output resistor Rₒᵤₜ, and the second main electrode region 15b of the n-channel active element Qₙ is connected to the second power supply V_{DD1}, which has a higher potential than the first power supply. On the other hand, the third main electrode region 15r of the p-channel active element Qₚ is connected to the first power supply through the output resistor Rₒᵤₜ, and the fourth main electrode region 15s of the p-channel active element Qₚ is connected to the third power supply V_{DD2} (=−V_{DD1}), which has a lower potential than the first power supply. The n-channel active element Qₙ and the p-channel active element Qₚ that constitute the complementary element circuit of the impedance conversion element 2f operate similarly to the cross-sectional structures shown in FIG. 18B and FIG. 18C, using the potential of the first peripheral region P₀ on the output surface side of the vibrating body 22a1 as a common control voltage. That is, the complementary element circuit of the impedance conversion element 2f includes the n-channel active element Qₙ and the p-channel active element Qₚ, which input the pressure of the ultrasonic wave Φ applied to the vibrating body 22a1 of the voltage generation unit 1a into a common cross-channel as the potential input of the first peripheral region P₀, and output the signal after impedance conversion. Furthermore, the complementary element circuit of the acoustic element in other embodiments uses the output signals of the n-channel active element Qₙ and the p-channel active element Qₚ as the output signals of the acoustic element.

The n-channel active element Qₙ comprises: a body region 14, consisting of an intrinsic semiconductor region (i-layer) or a high-resistivity semiconductor region (n⁻⁻-layer, p⁻⁻-layer) close to the intrinsic semiconductor; a first main electrode region 15a and a second main electrode region 15b, which are spaced apart from each other and located in the upper part of the body region 14, and are composed of a semiconductor region of the second conductivity type (n⁺-type). Similarly, the p-channel active element Qₚ includes a body region 14 shared with the n-channel actiVe element Qₙ, as well as a third main electrode region 15r and a fourth main electrode region 15s, which are spaced apart from each other and located in the upper part of the body region 14, and are composed of a semiconductor region of the first conductivity type (p⁺-type). As shown in FIG. 28A, the direction of carrier movement from the first main electrode region 15a to the second main electrode region 15b is orthogonal to the direction of carrier movement from the third main electrode region 15r to the fourth main electrode region 15s. For example, when the body region 14 is Si, even if the body region 14 is an n⁻-layer with an impurity density of approximately 2×1014 cm⁻³, it is possible to substantially deplete the body region 14 in a state where the depletion layers extending from the opposing third main electrode region 15r and fourth main electrode region 15s are about to pinch off each other. Similarly, even if the body region 14 is a p-layer, it is possible to substantially deplete the body region 14 in a state where the depletion layers extending from the opposing first main electrode region 15a and second main electrode region 15b are about to pinch off each other.

A common MIS interface region is formed on the upper surface of the body region 14 between the first main electrode region 15a and the second main electrode region 15b of the n-channel active element Qₙ, as well as on the upper surface of the body region 14 between the third main electrode region 15r and the fourth main electrode region 15s of the p-channel active element Qₚ. Although the cross-sectional view is omitted, each of the n-channel active element Qₙ and the p-channel active element Qₚ has a cross-sectional structure similar to that shown in FIG. 18B, including a common gate dielectric film with a wider bandgap than the body region 14, which contacts the common MIS interface region between the first main electrode region 15a and the second main electrode region 15b, as well as between the third main electrode region 15r and the fourth main electrode region 15s. Additionally, a common control electrode is provided on the common gate dielectric film. In the case of the n-channel active element Qₙ and the p-channel active element Qₚ with a common gate dielectric film, excessive gate voltage may cause insulation breakdown of the common gate dielectric film, posing a problem. Therefore, as shown in FIG. 28D, a positive voltage clamp diode Dₖₙ is connected between the common control electrode of the n-channel active element Qn and the p-channel active element Qₚ and the second power supply V_{DD1}, and a negative voltage clamp diode Dₖₚ is connected between the common control electrode and the third power supply V_{DD2}. By connecting the positive voltage clamp diode Dₖₙ and the negative voltage clamp diode Dₖₚ to the common control electrode, the configuration is designed to prevent excessive gate voltage from being applied to the common gate dielectric film. It should be noted that, similar to the structure of the acoustic element according to the first embodiment, it is also possible to bond the common MIS interface region heterogeneously to the columnar end protruding from the output surface of the vibrating body 22a1 without using a common gate dielectric film or a common control electrode.

Around the base region forming the cross-shaped channel, an element isolation insulating film is arranged in a frame-like shape to define the range of the active regions for the n-channel active element Qₙ and the p-channel active element Qₚ. Inside the active region pattern surrounded by the element isolation insulating film, the region on the upper surface of the base region is defined. Near the upper surface (surface) of the active region surrounded by the element isolation insulating film, the first main electrode region 15a, the second main electrode region 15b, the third main electrode region 15r, and the fourth main electrode region 15s are arranged to form a rectangular shape. In the center of FIG. 28A, the range of the hexagonal potential transfer region is indicated by a two-dot chain line. For the hexagonal potential transfer region defined by the protrusion on the output surface side of the vibrator 22a1, the n-type channel of the n-channel active element Qₙ is formed near the surface of the rectangular region sandwiched between the first main electrode region 15a and the second main electrode region 15b. The protrusion on the output surface side of the vibrator 22a1 is a hexagonal columnar protrusion as indicated by the two-dot chain line in FIG. 28A. Similar to the cross-sectional structure shown in FIG. 18B and others, around the protrusion provided in the central part of the output surface side of the vibrator 22a1, a parallel annular vibration cavity 21a1 is arranged in a centrally symmetric manner around the protrusion. The parallel annular structure constituting the vibration cavity 21a1 is a topological structure with a hexagonal planar pattern. For the hexagonal potential transfer region defined by the protrusion, the p-type channel of the p-channel active element Qₚ is formed near the surface of the rectangular region shared with the n-channel active element Qₙ, sandwiched between the third main electrode region 15r and the fourth main electrode region 15s.

Within the active region, the potential barrier height for electron movement in the n-type channel between the first main electrode region 15a and the second main electrode region 15b of the n-channel active element Qₙ is controlled by utilizing the electrostatic induction effect of the potential of the potential transfer region of the vibrating body 22a1, as shown in FIG. 28B. The saddle-shaped hyperbolic paraboloid (conic surface) indicated by the dashed line in FIG. 28B represents the potential distribution at the conduction band edge (bottom) when the potential V_{G} of the central region P₀ of the voltage generating section 1a is 0. The downward convex potential distribution formed by the p-i-p hook structure between the third main electrode region 15r and the fourth main electrode region 15s intersects and overlaps with the upward convex potential distribution formed by the n-i-n hook structure between the first main electrode region 15a and the second main electrode region 15b, forming a cross-curved surface. The stationary point of the conic surface of the cross-curved surface shown in FIG. 28B, namely the saddle point, is defined as the potential barrier height for electrons. The saddle point is at its maximum in the direction of the n-i-n hook structure of the n-channel active element Qₙ, but at its minimum in the direction of the p-i-p hook structure of the p-channel active element Qₚ. The saddle-shaped conic surface indicated by the solid line in FIG. 28B represents the potential distribution at the conduction band edge (bottom) when vibrating on the side where the potential V_{G} of the central region P₀ of the voltage generating section 1a is greater than 0. When vibrating on the side where V_{G} is greater than 0, the saddle point potential of the cross-curved surface of the p-i-p hook structure and n-i-n hook structure decreases due to the electrostatic induction effect. Therefore, electrons determined by Fermi-Dirac distribution with energy exceeding the potential barrier shown in FIG. 28B flow between the first main electrode region 15a and the second main electrode region 15b. As a result, current Iₙ flowing according to changes in potential barrier height dependent on V_{G}<0 vibration flows in the output resistance Rout shown in FIG. 28D.

Similarly, within the active region, the potential barrier height for the movement of holes generated in the p-type channel between the third main electrode region 15r and the fourth main electrode region 15s of the p-channel active element Qₚ is controlled by utilizing the electrostatic induction effect of the potential of the potential transfer region of the vibrator 22a1, as shown in FIG. 28C. The saddle-shaped quadric surface indicated by the dashed line in FIG. 28C represents the potential distribution at the valence band edge (top) when the potential V_{G} of the central region P₀ of the voltage generating section 1a is 0. The downward convex potential distribution formed by the p-i-p hook structure between the third main electrode region 15r and the fourth main electrode region 15s intersects with the upward convex potential distribution formed by the n-i-n hook structure between the first main electrode region 15a and the second main electrode region 15b, forming a cross-shaped curved surface. The stationary point of the quadric surface of the cross-shaped curved surface in FIG. 28C, namely the saddle point, is defined as the potential barrier height for holes. The “valley” point of the p-i-p hook structure is the highest “peak” in the direction of the ridge line of the n-i-n hook structure.

The saddle-shaped quadric surface indicated by the solid line in FIG. 28C represents the potential distribution of the valence band edge when the central region P₀ of the voltage generating unit 1a vibrates on the V_{G}<0 side. The direction of measuring the electron potential barrier height is opposite to that of measuring the hole potential barrier height. When vibrating towards the V_{G}<0 side, the hole potential barrier height defined by the saddle point of the intersecting surfaces of the p-i-p hook structure and the n-i-n hook structure decreases due to electrostatic induction effects. Therefore, holes determined by the Fermi-Dirac distribution with energy exceeding the potential barrier energy shown in FIG. 28C flow between the third main electrode region 15r and the fourth main electrode region 15s. As a result, a current Ip, which varies depending on the potential barrier height associated with V_{G}>0 vibrations, flows in the output resistance Rout shown in FIG. 28D.

As illustrated in FIG. 4C, when the fixed potential electrode 24a is connected to the ground potential (GND), the central voltage V_{P0}, the first peripheral voltage V_{P1}, the second peripheral voltage V_{P2}, the third peripheral voltage V_{P3}, and the fourth peripheral voltage V_{P4} of the voltage generation unit 1a each exhibit a vibration waveform that oscillates in both positive and negative directions centered around 0V. As shown in FIG. 28D, since the common control electrode of the n-channel active element Qₙ and the p-channel active element Qₚ is connected to the potential generation position P₀, the potential barrier height for carrier (electron) movement in the n-type channel defined between the first main electrode region 15a and the second main electrode region 15b of the n-channel active element Qₙ is controlled by the electrostatic induction effect of potentials oscillating in both positive and negative directions. Additionally, due to the common control electrode being connected to the potential generation position P₀, the potential barrier height for carrier (hole) movement in the p-type channel defined between the third main electrode region 15r and the fourth main electrode region 15s of the p-channel active element Qₚ, which is orthogonal to the n-type channel, is also controlled by the electrostatic induction effect of potentials oscillating in both positive and negative directions.

Similar to the cross-sectional structure shown in FIG. 18B and others, interlayer insulating films are provided on the first main electrode region 15a, the second main electrode region 15b, the third main electrode region 15r, and the fourth main electrode region 15s. Through contact holes opened in the interlayer insulating films, the first main electrode region 15a is connected to the first main electrode wiring 25a, and the second main electrode region 15b is connected to the second main electrode wiring 25b. Through contact holes opened in the interlayer insulating films, the third main electrode region 15r is connected to the third main electrode wiring 25r, and the fourth main electrode region 15s is connected to the fourth main electrode wiring 25s. In addition, similar to the cross-sectional structure shown in FIG. 18B and others, a common input signal wiring composed of a conductor is provided on the common control electrode, but it is omitted in FIG. 28A. Corresponding to the positive voltage clamp diode Dₖₙ in the equivalent circuit representation of FIG. 28D, a p-n junction diode composed of a p⁺-type anode region and an n-type cathode region is arranged. Similarly, corresponding to the negative voltage clamp diode Dₖₚ in FIG. 28D, a p-n junction diode composed of a p⁺-type anode region and an n-type cathode region is arranged.

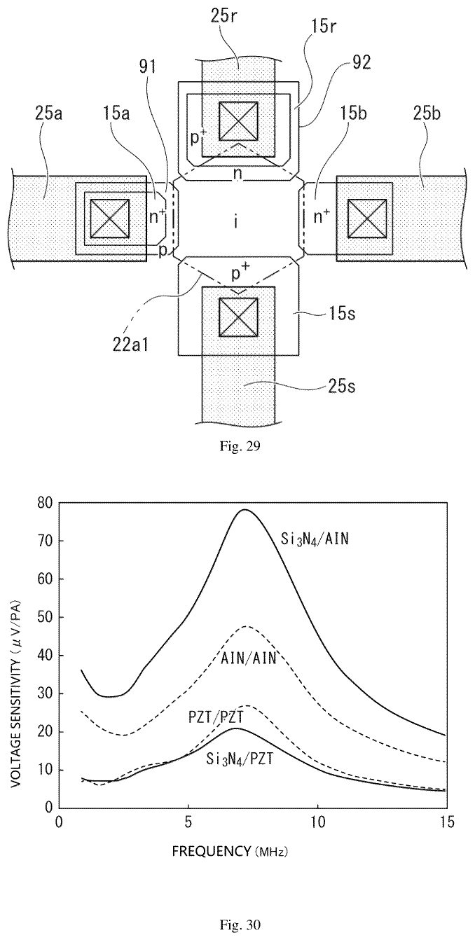

The n-channel active element Qₙ and p-channel active element Qₚ of the positive complementary element circuit shown in FIG. 29 are similar to those of the positive complementary element circuit shown in FIG. 28A in terms of using a common substrate region composed of an intrinsic semiconductor region (i-layer) or a high-resistivity semiconductor region (n⁻⁻layer, p⁻⁻layer) close to the intrinsic semiconductor. However, the positive complementary element circuit shown in FIG. 29 embeds the first base region 91 of the first conductivity type (p-type) and the second base region 92 of the second conductivity type (n-type) spaced apart from the first base region 91 into the upper part of the common substrate region, respectively. Additionally, the first main electrode region 15a of the n-channel active element Qₙ of the positive complementary element circuit shown in FIG. 29 is embedded in the upper part of the first base region 91. Similarly, the third main electrode region 15r of the p-channel active element Qₚ of the positive complementary element circuit shown in FIG. 29 is embedded in the upper part of the second base region 92. Moreover, in the upper part of the base region, a second main electrode region 15b of the second conductivity type (n⁺-type) is spaced apart from the first main electrode region 15a, and a fourth main electrode region 15s of the first conductivity type (p⁺-type) is spaced apart from the third main electrode region 15r. In the planar layout shown in FIG. 29, the direction of carrier movement from the first main electrode region 15a to the second main electrode region 15b via the first base region 91 is orthogonal to the direction of carrier movement from the third main electrode region 15r to the fourth main electrode region 15s via the second base region 92.

In the positive complementary element circuit shown in FIG. 29, an electric potential barrier for electron movement is generated in the first base region 91, which is immediately adjacent to the first main electrode region 15a, between the first main electrode region 15a and the second main electrode region 15b of the n-channel active element Qₙ. By establishing the first base region 91 to form an n-p-i-n hook structure, the electric potential barrier for electron movement is made higher than that in the structure shown in FIG. 28A, thereby enhancing the withstand voltage between the first main electrode region 15a and the second main electrode region 15b. Similarly, an electric potential barrier for hole movement is generated in the second base region 92, which is immediately adjacent to the third main electrode region 15r, between the third main electrode region 15r and the fourth main electrode region 15s of the p-channel active element Qₚ. By establishing the second base region 92 to form a p-n-i-p hook structure, the electric potential barrier for hole movement is made higher than that in the structure shown in FIG. 28A, thereby enhancing the withstand voltage between the third main electrode region 15r and the fourth main electrode region 15s.

The upper surface of the body region between the first main electrode region 15a and the second main electrode region 15b of the n-channel active element Qₙ, and the upper surface of the body region between the third main electrode region 15r and the fourth main electrode region 15s of the p-channel active element Qₚ form a common MIS interface region. Although the illustration of the cross-sectional view is omitted, each of the n-channel active element Qₙ and the p-channel active element Qₚ has a cross-sectional structure similar to that shown in FIG. 18B, including a common gate dielectric film with a wider bandgap width than the body region, which contacts the common MIS interface region between the first main electrode region 15a and the second main electrode region 15b, and between the third main electrode region 15r and the fourth main electrode region 15s, and a common control electrode disposed on the common gate dielectric film. In the center of FIG. 29, a hexagonal potential transfer region defined by protrusions on the output surface side of the vibrating body is indicated by a two-dot chain line, but the pattern of the common control electrode does not coincide with the two-dot chain line region. The common control electrode is formed in a planar pattern that covers at least the first base region 91 and the second base region 92 above which a potential barrier is formed.

Moreover, the potential barrier height for electron movement generated in the first base region 91 adjacent to the first main electrode region 15a is controlled by the electrostatic induction effect of the potential of the common control electrode electrically connected to the potential transfer region. Similarly, the potential barrier height for hole movement generated in the second base region 92 adjacent to the third main electrode region 15r is controlled by the electrostatic induction effect of the potential of the common control electrode. Similar to the quadric surfaces shown in FIGS. 28B and 28C, the downward convex potential distribution of the p-n-i-p hook structure formed between the third main electrode region 15r and the fourth main electrode region 15s intersects and overlaps with the upward convex potential distribution of the n-p-i-n hook structure formed between the first main electrode region 15a and the second main electrode region 15b, forming a saddle-shaped intersection surface.

That is, the stationary points of the quadric surfaces, which are similar to the shapes shown in FIGS. 28B and 28C, and are known as saddle points, are defined as the potential barrier heights for electrons and holes in the positive complementary element circuit depicted in FIG. 29. In the layout shown in FIG. 29, the position of the saddle points differs from the shapes depicted in FIGS. 28B and 28C, exhibiting asymmetric positions. The saddle point is the maximum point near the first base region 91 in the direction of the n-p-i-n hook structure of the n-channel active element Qₙ, but it is the minimum point near the second base region 92 in the direction of the p-n-i-p hook structure of the p-channel active element Qₚ. When vibrating towards the V_{G}>0 side, the saddle point potentials of the intersecting surfaces of the p-n-i-p hook structure and the n-p-i-n hook structure decrease due to electrostatic induction effects. Therefore, electrons determined by Fermi-Dirac distribution with energy exceeding the potential barrier flow from the first main electrode region 15a to the second main electrode region 15b through the first base region 91, and current flows according to changes in potential barrier height dependent on V_{G}<0 vibration.

The direction of measuring the electron potential barrier height is opposite to that of measuring the hole potential barrier height. When vibrating towards the V_{G}<0 side, the hole potential barrier height defined by the saddle point of the intersection surface of the p-n-i-p hook structure and the n-p-i-n hook structure decreases due to electrostatic induction effects. Therefore, holes determined by Fermi-Dirac distribution with energy exceeding the potential barrier flow from the third main electrode region 15r to the fourth main electrode region 15s through the second base region 92, and current flows according to the change in potential barrier height dependent on V_{G}>0 vibration.

As mentioned earlier, the voltage generating unit can be any structure that constitutes a continuous vibrator capable of generating a stress field with stress concentration points, and that includes at least a piezoelectric body at the stress concentration points of the vibrator used as the potential transfer area. In the descriptions of the acoustic elements according to the first to fifth embodiments mentioned above, examples were given of cases where the entire vibrator is composed of piezoelectric bodies. However, it is also possible to have only the central protrusion, which serves as the stress concentration point, composed of piezoelectric bodies, while the remaining flat plate-shaped parts are composed of non-piezoelectric bodies. Alternatively, it is also possible to have only the central protrusion, which serves as the stress concentration point, composed of ferroelectric bodies, while the remaining flat plate-shaped parts are composed of thermoelectric bodies (polar crystals), ferroelectric bodies, or ordinary piezoelectric bodies that are not thermoelectric or non-piezoelectric bodies. In addition, it is also possible to have only the central protrusion, which serves as the stress concentration point, composed of thermoelectric bodies (polar crystals), while the remaining flat plate-shaped parts are composed of piezoelectric bodies with weaker polarity or non-piezoelectric bodies. It should be noted that since the stress concentration points depend on the stress distribution enhancement structure, it is important to note that the central protrusion is not the only stress concentration point. Furthermore, when there are multiple stress concentration points and multiple positions are used as potential transfer areas, it is sufficient to arrange at least a structure with piezoelectric bodies at positions corresponding to multiple potential transfer areas.

The upper dashed line in FIG. 30 represents the sensitivity curve of the central voltage V_{P0} in the case where the parallel ring structure of the vibrating body is entirely made of the thermoelectric material AlN. The lower dashed line represents the sensitivity curve of the central voltage V_{P0} in the case where the parallel ring structure of the vibrating body is entirely made of the ferroelectric material PZT. Both curves depict the aspect ratio H/D=1, where H is the height of the central protrusion and D is the diameter. Specifically, the upper dashed line illustrates the frequency dependence of voltage sensitivity in the case of a uniform AlN/AlN structure with a central column (protrusion) diameter D=1.2 μm and a flat film portion thickness t₂₂ₐ₁=1.2 μm. In this uniform AlN/AlN structure, the peak frequency of the sensitivity curve is 7.1 MHz, and the maximum voltage sensitivity of the central voltage V_{P0} is approximately 47.54 μV/Pa. On the other hand, the upper solid line in FIG. 30 represents the frequency dependence of voltage sensitivity in the case of a Si₃N₄/AlN composite structure where the central column (protrusion) is solely made of thermoelectric AlN with a diameter D=1.2 μm, and the flat film portion is made of a Si₃N₄ film with a thickness t₂₂ₐ₁=1.2 μm. The aspect ratio H/D of the Si₃N₄/AlN composite structure is also 1.

Due to the α phase of the Si₃N₄ film being of the trigonal system and the β phase being of the hexagonal system, based on the properties of crystal groups, it is considered a dielectric film with piezoelectricity. However, the piezoelectricity of the Si₃N₄ film depends on the film formation method. For instance, it exhibits piezoelectricity in the case of laser-induced CVD (LICVD) method, but in many cases, the piezoelectricity of the Si₃N₄ film is relatively small. The piezoelectricity of the Si₃N₄ film was ignored in the simulation shown in FIG. 30. In the case of the Si₃N₄/AlN composite structure, the peak frequency of the sensitivity curve is 7.1 MHz. In the case of the Si₃N₄/AlN composite structure, the maximum voltage sensitivity of the central voltage V_{P0} is approximately 77.5 μV/Pa, and the voltage sensitivity increases by approximately 1.6 times. It can be considered that the lateral piezoelectric effect of the Si₃N₄ film is added to the longitudinal piezoelectric effect of AlN.

The lower dashed line in FIG. 30 represents the frequency dependence of voltage sensitivity in the case of a PZT/PZT uniform structure with a diameter D=2.4 μm for the central pillar (convex part) and a thickness t₂₂ₐ₁=2.4 μm for the flat plate-shaped membrane part outside the central convex part. Compared to the AlN/AlN uniform structure shown by the upper dashed line, the lower dashed line exhibits a lower maximum voltage sensitivity of approximately 26.6 μV/Pa due to the larger diameter D of the central pillar (convex part), which is lower than that of the AlN/AlN uniform structure. Additionally, since the vertical axis in FIG. 30 represents voltage sensitivity, the difference in relative permittivity between AlN and PZT is believed to affect the reduction in maximum voltage sensitivity. The peak frequency in the case of the PZT/PZT uniform structure is 7.1 MHz, which is basically the same as that of the AlN/AlN uniform structure. On the other hand, the lower solid line represents the frequency dependence of voltage sensitivity in the case of a Si₃N₄/PZT composite structure with a diameter D=1.8 μm for the central pillar (convex part) and a thickness t₂₂ₐ₁=1.2 μm for the flat plate-shaped membrane part made of Si₃N₄. The aspect ratio H/D of the Si₃N₄/PZT composite structure is also 1. In the case of the Si₃N₄/PZT composite structure, even though the diameter D of the central pillar (convex part) is smaller than that of the PZT/PZT uniform structure, the maximum voltage sensitivity of the central voltage V_{P0} is approximately 20.5 μV/Pa, which is reduced by approximately 0.77 times. In the case of the Si₃N₄/PZT composite structure, the peak frequency shifts slightly to the lower frequency side at 6.8 MHz. In the case of the Si₃N₄/PZT composite structure, it is believed that the lateral piezoelectric effect of the Si₃N₄ film acts in the direction of reducing the longitudinal piezoelectric effect of PZT, but it can be seen that even with a composite structure made of a flat Si₃N₄ film, it is still possible to constitute a vibrator.

Even when the entire vibrator is composed of PZT, it is still possible to enhance the piezoelectric effect at stress concentration points by adjusting the composition of lead zirconate (PbZrO3) in mixed-crystal PZT, thereby distributing the piezoelectric constant of PZT according to the vibrator's structural location. This allows for the construction of a vibrator exhibiting non-uniform piezoelectric effects. Alternatively, materials such as PZT-4, PZT-5, PZT-5A, PZT-5H, and PZT-8 can be used selectively based on location, with PZT-5H being employed at stress concentration points, for instance. By modifying the flow rates of raw material gases during the CVD process, it is possible to alter the composition of lead zirconate in PZT along the thickness direction.

In addition, in the acoustic element structure according to the modified example of the second embodiment shown in FIG. 18C, when the central protrusion is composed of AlN, the capacitance on the central protrusion side is smaller compared to the case where the central protrusion is composed of PZT. As can be seen from the equivalent circuit shown in FIG. 3A, the gate voltage of the driving MIS transistor depends on the capacitance ratio between the capacitance C_{d} on the central protrusion side and the gate capacitance of the MIS transistor shown in the lower part of FIG. 3A. Therefore, combined with the effect of the sensitivity curve shown in FIG. 30, in the acoustic element and other structures according to the modified example of the second embodiment, the case where the central protrusion is composed of AlN is more advantageous than the case where the central protrusion is composed of PZT.

As mentioned in the previous section, as examples of other embodiments, the present disclosure is not limited to the descriptions of the first to fifth embodiments. Various modifications can be made, and these modifications are also included within the technical scope of the present disclosure. Therefore, the technical scope of the present disclosure is determined solely by the specific matters of the disclosure covered by the reasonable scope of patent claims in the above description.

### EXPLANATION OF REFERENCE DESIGNATIONS

1a, 1b, 1c . . . Voltage generation section; 2b, 2c, 2d, 2e, 2f . . . Impedance transformation element; 11ₛₐ₁, 11ₛₐ₂ . . . Silicon substrate; 13 . . . Gate dielectric film; 13h . . . Buffer layer; 13n . . . First gate dielectric film; 13p . . . Second gate dielectric film; 14, 51, 61 . . . Base region; 15a . . . First main electrode region; 15b . . . Second main electrode region; 15c . . . Fourth main electrode region; 15d . . . Third main electrode region; 16 . . . Element isolation insulating film; 17 . . . Interlayer insulating film (first interlayer insulating film); 17c . . . Channel protection insulating film; 17p . . . First insulating film; 19, 19c . . . Hole inner wall protective film; 1a, 1b, 1c . . . Voltage generation section; 21a1, 21a2, 21e, 21f . . . Vibration cavity; 22a1, 22a2, 22d, 22e, 22e2, 22f . . . Vibration body (at least a part of which is a piezoelectric layer); 23 . . . Fixed potential electrode protective film; 24, 24a, 24e . . . Fixed potential electrode; 25a . . . First main electrode wiring; 25b . . . Second main electrode wiring; 25c . . . Output signal wiring; 25d . . . Third main electrode wiring; 27 . . . Sacrificial layer; 27p . . . Material layer for sacrificial layer; 28 . . . Liquid introduction hole; 29, 29ₚᵢₗ . . . Connection plug; 31 . . . Direct bonding insulating film; 31p . . . Second insulating film; 35 . . . Second power supply side diode wiring; 36 . . . First power supply side diode wiring; 37, 64 . . . Control electrode; 37n . . . First control electrode; 37p . . . Second control electrode; 38, 65 . . . Input signal wiring; 38n . . . First gate connection plug; 38p . . . Second gate connection plug; 38p . . . Second conductor film; 39, 46 . . . First input signal wiring; 41, 43 . . . Cathode region; 41a . . . First contact plug; 41b . . . second contact plug; 41c . . . third contact plug; 42, 44 . . . anode region; 45, 47 . . . second input signal wiring; 48 . . . connection pad; 52 . . . well region; 53 . . . second interlayer insulating film; 62 . . . auxiliary control electrode region; 63 . . . surface control electrode region; 81 . . . amplifier; 91 . . . first base region; 92 . . . second base region

1. An acoustic element, comprises:
a voltage generation part, having a vibrating body and a fixed potential electrode in contact with the receiving surface of the vibrating body, and at least a piezoelectric layer is provided at a stress concentration position, which is a part of the vibrating body, on the output surface side of the vibrating body opposite to the receiving surface;
an impedance transformation element, which uses a specific local area corresponding to the stress concentration position of the piezoelectric layer as a potential transmission area, and operates with the potential of the potential transmission area as a control voltage; and
the pressure of ultrasonic waves applied to the vibrating body is used as the output signal of the impedance transformation element.

2. The acoustic element according to claim 1, wherein the impedance conversion element comprises:
a base region, consisting of a semiconductor region of the first conductivity type;
first and second main electrode regions, consisting of semiconductor regions of the second conductivity type arranged above the base region and spaced apart from each other; and
a potential transfer region bonded to the upper surface of the base region located between the first main electrode region and the second main electrode region, so that the potential of the potential transfer region controls the height of the potential barrier generated in the channel between the first main electrode region and the second main electrode region.

3. The acoustic element according to claim 1, wherein the impedance transformation element comprises:
a base region composed of a semiconductor region of a first conductivity type;
first and second main electrode regions composed of semiconductor regions of a second conductivity type arranged above the base region and spaced apart from each other;
a gate dielectric film in contact with the upper surface of the base region located between the first main electrode region and the second main electrode region, and having a wider bandgap than the base region; and
a control electrode arranged on the gate dielectric film and connected to the potential transfer region, so that the potential of the potential transfer region controls the height of the potential barrier generated in the channel between the first main electrode region and the second main electrode region.

4. The acoustic element according to claim 1, wherein the impedance transformation element comprises:
a base region, composed of a semiconductor region of the first conductivity type;
first and second main electrode regions, composed of semiconductor regions of the first conductivity type arranged in the base region and spaced apart from each other, with a higher impurity density than the base region;
a surface control electrode region, composed of a semiconductor region of the second conductivity type arranged above the base region between the first main electrode region and the second main electrode region, forming a p-n junction with the base region;
an auxiliary control electrode region, composed of a semiconductor region of the second conductivity type arranged below the surface control electrode region opposite the base region, defining a channel region between the first main electrode region and the second main electrode region sandwiched therebetween; and
a control electrode, metallurgically connected to the surface control electrode region and connected to the potential transfer region, so that the potential barrier height generated in the channel is controlled by the potential of the potential transfer region.

5. The acoustic element according to claim 1, wherein the impedance transformation element is a CMOS inverter, and the input electrode of the CMOS inverter is connected to the potential transfer region, whereby the potential barrier height generated in the respective channels of the p-type active element and n-type active element of the CMOS inverter is controlled by the potential of the potential transfer region.

6. The acoustic element according to claim 1, wherein the impedance transformation element is a semiconductor integrated circuit, and the potentials of a specific plurality of the potential transfer regions of the voltage generation section are independently transmitted as independent control voltages for a plurality of active elements included in the semiconductor integrated circuit, and the plurality of active elements are individually controlled.
